(19) United States
(12) Patent Application Publication
(10) Pub. No.: US 2002/0040304 A1
(43) Pub. Date: Apr. 4, 2002

(54) Methods and systems for creating and managing capital asset business exchanges

(76) Inventors: Subrao Shenoy, San Jose, CA (US); Seema Shenoy, San Jose, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/968,736

(22) Filed: Oct. 1, 2001

Related U.S. Application Data
(60) Provisional application No. 60/237,282, filed on Oct. 2, 2000.
(60) Provisional application No. 60/272,078, filed on Feb. 28, 2001.

(51) Int. Cl. G06F 17/60

(52) U.S. Cl. 705/1

(57) ABSTRACT

A method of creating and managing a capital asset transaction utilizing a field programmable transaction system, using a network based system including a server system coupled to a centralized database and at least one client system, is disclosed. The method comprises identifying business objectives, defining a type of the capital asset involved in the capital asset transaction, creating a business entity and related sub-entities, defining business rules and logic specific to the business entity and the associated sub-entities to govern the transaction, and managing the transaction dynamically on an on-going basis to close the transaction successfully.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to methods and systems for creating and managing capital asset business exchanges and more particularly to automating any capital asset procurement process to reduce human intervention in completing a capital asset transaction.

The transactions relating to capital asset business exchanges, also referred to as fixed asset business exchanges, often involve multiple parties. Once having reached a meeting of minds, these parties enter into a transaction via a business contract. The business contract memorializes the agreement between the parties which defines the obligations of each party to the transaction. Each of these obligations must be completed by the responsible party to successfully close the capital asset business exchange. The terms, capital asset business exchange, fixed asset investments exchange and capital asset business transactions, are used interchangeably. Each party is also responsible for ensuring fulfilling their side of the obligation in a timely manner. An independent or a neutral party may monitor the progress of the transaction, which is generally a manual process. Managing and tracking the transaction is a complex and a challenging matter in that it involves hundreds of terms and conditions, including constraints, regulatory guidelines, buyers' and sellers' preferences, parameters, transaction contingencies, limitations, schedules, time lines and deadlines. The transaction process is further complicated by the local business practices used by various entities involved in the transaction. Additionally, efficiency as well as accuracy is often compromised. Human resources, that are involved in managing these types of transactions, are also specialized and often hard to find. These resources, if interrupted or lost during the transaction, further create a dependency that impacts the closing of the transaction.

In view of the above, it would be desirable to have systems and methods that streamline the process for creating and managing capital asset business exchanges, reduce human intervention and help improve business efficiency and profitability.

### BRIEF SUMMARY OF THE INVENTION

In an exemplary embodiment, the invention is an integrated network based Field Programmable Transaction System (FPTS), that adapts to a new geography or a new business for conducting any Capital Asset Procurement/Sale/Exchange process. The FPTS helps create a highly secure, scalable transaction exchange for businesses such as residential and commercial real estate, timeshares, machinery, equipment and other capital asset exchanges that can adapt to any geography/business practices by changing or altering the business rules. The input to FPTS is the business rules file, created by the Analyst Module and the user input through the actual contract for the transaction, and the output of the FPTS is the optimized transaction workflow for all entities involved in the transaction.

The FPTS is a fully integrated on-line web-based system and enterprise-wide communication platform created to drive business accountability and performance, and to improve closing of transactions in a timely manner. It enhances lines of communication between the parties at various locations and the business entity to close the transaction. The FPTS utilizes the Internet to enhance communication. The FPTS not only makes the transaction managing process more accessible but it also makes the process faster, more reliable, efficient and profitable. The FPTS is secure, exclusive and protected.

The FPTS is designed to facilitate participation of the parties responsible for the transaction and to improve the efficiency in closing the transaction. The FPTS also helps the business entity comply with local, state and federal rules and regulations.

A Dynamic Transaction Logic Module (DTLM), also referred to as a Dynamic Transaction Flow Module of the FPTS, enables changing the transaction flow automatically or manually based on direct user inputs and/or transaction variables referenced and exchanged via the Internet.

The DTLM takes the compiled business rules and the information in the online contract document and creates an automated workflow that navigates itself. The DTLM navigates and maneuvers the transaction by understanding user controls and/or XML-based real time transaction variables communicated and exchanged via the Internet. In an exemplary embodiment, the DTLM selects different alternatives to complete the transaction depending on whether a given service provider request was fulfilled or not fulfilled (e.g. mortgage, inspection, appraisal etc.).

The FPTS recognizes dependent transactions on its own servers or information received via XML from other third party transaction servers/exchanges. For example, Transaction A may be contingent upon Transaction B closing on its own server or on a third party server/exchange which, in turn, may be dependent on Transaction C somewhere else. In each case, via user input or through completion or non-completion of tasks/milestones either on the same server or through external servers, the DTLM provides the state diagram for the next course of action. The base of the logic is compiled via the analyst module which develops the time wheel based on the actual contract or built-in default timetables that are stored in the business rules.

An Optimization Module (OM), part of the FPTS, stores all given characteristics of service providers in the library of components (real time calendar, availability, geographical coverage, the price list, user ratings etc.). The Optimization Module manages a constrained-based optimization whereby the constraints and objectives are provided by the user to develop an Optimized Transaction Workflow for all entities involved in the transaction.

In an exemplary embodiment, the FPTS incorporates an Automatic File Storage and Retrieval module (AFSRM) that manages contextual file naming, storing, and retrieving key documents including, but not limited to, forms, reports, and disclosures used in and related to the transaction. These documents are faxed, scanned, emailed or sent through XML interfaces or created on the servers. The FPTS creates a specific and an efficient way of naming files that are easy for the FPTS to select, display, print and store during the execution of the transaction.

In an exemplary embodiment, the invention provides a method of creating and managing a capital asset transaction utilizing a field programmable transaction system. The method includes identifying business objectives including a type of the capital asset involved in the capital asset transaction, creating a business entity and related sub-entities, defining business rules and logic specific to the business entity and the associated sub-entities to govern the transaction, and managing the transaction on an on-going basis for the business entity.

In yet another exemplary embodiment, the FPTS adopts a Privilege Scheme to provide an elaborate field and user customizable privilege scheme to execute tasks and to view or edit documents on the FPTS server that guarantees transaction integrity and privacy.

In another exemplary embodiment, the invention provides a system to implement the process for managing business transactions in compliance with state and federal regulations. The system includes a computer and at least one server connected via a network to the computer. The system is configured to set up business entities and sub-entities, including business rules and parameters relating thereto, create rules of proxy, rules of interaction and delegation, analyze transaction details based on an executed contract, execute an automated workflow that incorporates all the tasks for the business entities and associated sub-entities, and auto-navigate the transaction based on a desired outcome and transaction variables exchanged via the network to complete the transaction.

In yet another exemplary embodiment, the invention provides a computer to facilitate online processing and closure of capital assets transactions. The computer is coupled to a centralized database and programmed to set up business entities and receive transaction information into the centralized database against related business entities, store the transaction information into various subsections of the centralized database, and cross reference the transaction information against the business entities. The computer is further programmed to develop transaction milestones based on the parties' desired outcome, receive documentary evidence against transaction milestones, update the centralized database dynamically to reflect the current status of the transaction at any given time, and finally close the transaction to achieve the desired outcome.

In yet further exemplary embodiment, a computer program, embodied on a computer readable medium for managing transactions in various different types of industries, is provided. The types of industries covered by the computer program includes, but are not limited to, the residential real estate industry, commercial real estate industry, timeshare industry, ship industry, automobile industry, aircraft industry, and import/export industry, based on pre-defined business rules guidelines. The computer program comprises an analyst code segment, a rules file creation code segment, a dynamic transaction logic code segment, a privilege scheme code segment, an optimization code segment, a semantic questionnaire code segment, and an automatic file storage and retrieval code segment to execute and close transactions based on the parties' contractual understandings.

### BRIEF DESCRIPTION OF THE DRAWINGS

FIG. 1 is an exemplary embodiment of a flow chart of a Capital Asset Transaction Process managed by utilizing a Field Programmable Transaction System (FPTS);

FIG. 2 is a block diagram of the FPTS that includes a server system and a plurality of customer devices connected to the server;

FIG. 3 is an exemplary embodiment of a hardware architecture diagram of a general purpose computer suitable for use as a server host;

FIG. 4 is yet another exemplary embodiment of a block diagram of the FPTS;

FIG. 5 is an exemplary embodiment of a diagram depicting the functionality and features of an integrated network based FPTS;

FIG. 6 is an exemplary embodiment of a basic flow diagram describing the analyst module;

FIG. 7 is an exemplary embodiment of hierarchical layers of programming with an override scheme that is implemented by the FPTS utilizing the analyst module;

FIG. 8 is an exemplary embodiment of hierarchical layers implemented by the FPTS utilizing the analyst module;

FIG. 9 is an exemplary embodiment of a flow chart depicting the functionality of an Optimization Module that is being implemented for service providers;

FIG. 9(A) is an exemplary embodiment of a flow chart depicting feasibility analysis scenarios developed by the Optimization Module;

FIG. 10 is an exemplary embodiment of a flow chart depicting the functionality of the AFSRM;

FIG. 11 is an exemplary embodiment of a user interface for identifying the folder;

FIG. 12 is an exemplary embodiment of a user interface for selecting and naming the document;

FIG. 12(A) is an exemplary embodiment of a user interface for setting the privileges;

FIG. 13 is an exemplary embodiment of a flow chart 334 depicting functionality of the SQM;

FIG. 14 is an exemplary embodiment of a flow chart of the analyst module;

FIG. 15 is a continuation of an exemplary embodiment of the flowchart depicted in FIG. 14;

FIG. 16 is an exemplary embodiment of an analyst's home page user interface;

FIG. 17 is an exemplary embodiment of a continuation user interface of analyst's home page user interface;

FIG. 18 is an exemplary embodiment of a Create/View Entity user interface;

FIG. 19 is an exemplary embodiment of a Create/Modify E-Mail Templates user interface;

FIG. 20 is an exemplary embodiment of a continuation user interface displaying the bottom part of the user interface 470.

FIG. 21 is an exemplary embodiment of a Create/Modify Forms user interface;

FIG. 22 is an exemplary embodiment of a continuation user interface displaying the bottom part of the user interface;

FIG. 23 is an exemplary embodiment of a Create/Modify Net Sheet/Closing Costs user interface;

FIG. 24 is an exemplary embodiment of a Create/Modify Document List user interface;

FIG. 25 is an exemplary embodiment of a Create/Modify/View Task user interface;

FIG. 26 is an exemplary embodiment of a continuation user interface displaying the middle portion of the user interface;

FIG. 27 is an exemplary embodiment of a continuation user interface displaying the bottom part of the user interface;

FIG. 28 is an exemplary embodiment of a Define Entity/Task Relationship user interface;

FIG. 29 is an exemplary embodiment of a Define Master Rules Module user interface;

FIG. 30 is an exemplary embodiment of a continuation user interface displaying the bottom part of the user interface;

FIG. 31 is an exemplary embodiment of a Master Rules Module Library user interface;

FIG. 32 is an exemplary embodiment of a Define Module Name and Territory user interface;

FIG. 33 is an exemplary embodiment of a Select Entities user interface;

FIG. 34 is an exemplary embodiment of a Select Tasks user interface;

FIG. 35 is an exemplary embodiment of a Define Task Attributes user interface;

FIG. 36 is an exemplary embodiment of a continuation user interface displaying the bottom part of the user interface;

FIG. 37 is an exemplary embodiment of a Select Documents/Reports user interface;

FIG. 38 is an exemplary embodiment of a Select Attributes of Documents user interface;

FIG. 39 is an exemplary embodiment of a Define/Modify Proxy user interface;

FIG. 40 is an exemplary embodiment of a Set Default Values user interface;

FIG. 41 is an exemplary embodiment of a Define Transaction Flow user interface;

FIG. 42 is an exemplary embodiment of a Notes on Master Rules Module user interface;

FIG. 43 is an exemplary embodiment of a flow chart identifying the process of creating the dynamic transaction flow;

FIG. 44 is an exemplary embodiment of a flow chart identifying the process steps relating to the user experience pertaining to a real estate transaction;

FIG. 45 is an exemplary embodiment of a Home page user interface specifically adopted to the user utilizing the FPTS in the real estate environment;

FIG. 46 is an exemplary embodiment of a continuation user interface displaying the middle portion of the home page user interface;

FIG. 47 is an exemplary embodiment of a continuation user interface displaying the bottom portion of the home page user interface;

FIG. 48 is an exemplary embodiment of an Account user interface specifically adopted to the user utilizing the FPTS in the real estate environment;

FIG. 49 is an exemplary embodiment of an Add Team Members user interface;

FIG. 50 is an exemplary embodiment of an Account/Support Staff user interface;

FIG. 51 is an exemplary embodiment of a Delegate user interface;

FIG. 52 through 54 are exemplary embodiments of task delegation user interfaces;

FIG. 55 is an exemplary embodiment of a Transaction Delegation user interface;

FIG. 56 is an exemplary embodiment of a Commissions user interface;

FIG. 57 is an exemplary embodiment of a Commissions Set Up user interface;

FIG. 58 is an exemplary embodiment of a Commissions Summary user interface;

FIG. 59 is an exemplary embodiment of an Individual Category user interface;

FIG. 60 is an exemplary embodiment of a Transaction Questionnaire user interface downloaded and displayed by the server system when the user has initiated the process to register a new transaction;

FIG. 61 is an exemplary embodiment of a flow chart depicting the elements/contents of an Electronic Transaction Folder;

FIG. 62 is an exemplary embodiment of a flow chart describing the process receiving the listing feedback to the user from the brokers and or visitors visiting the property;

FIG. 63 is an exemplary embodiment of a flow chart describing the process of displaying the offer highlights to the user;

FIG. 64 is an exemplary embodiment of a flow chart depicting the process of tracking milestones on Buyer's Property and displaying the same on the related property's Electronic Transaction Folder 982 (shown in FIG. 61);

FIG. 65 is an exemplary embodiment of a top part of an Electronic Transaction Folder user interface;

FIG. 66 is an exemplary embodiment of a continuation user interface displaying a first middle portion of the Electronic Transaction Folder user interface;

FIG. 67 is an exemplary embodiment of a continuation user interface displaying a second middle portion of the Electronic Transaction Folder user interface;

FIG. 68 is an exemplary embodiment of a continuation user interface displaying a third middle portion of the Electronic Transaction Folder user interface;

FIG. 69 is an exemplary embodiment of a continuation user interface displaying the bottom portion of the Electronic Transaction Folder user interface;

FIG. 70 is an exemplary embodiment of a Transaction Paperwork user interface;

FIG. 71 is an exemplary embodiment of a Transaction Review user interface;

FIG. 72 is an exemplary embodiment of a Listing Feedback user interface;

FIG. 73 is an exemplary embodiment of a Get Feedback on Listing user interface;

FIG. 74 is an exemplary embodiment of a Listing Feedback Form user interface;

FIG. 75 is an exemplary embodiment of an Offer Highlights user interface;

FIG. 76 is an exemplary embodiment of a Create Offer Highlights user interface;

FIG. 77 is an exemplary embodiment of a continuation user interface of the Create Offer Highlights user interface;

FIG. 78 is an exemplary embodiment of an Add Tasks user interface;

FIG. 79 is an exemplary embodiment of a Transaction Milestones on Buyer's Property user interface;

FIG. 80 is an exemplary embodiment of a user interface that allows the user to update milestones on the buyer's transaction; and

FIG. 81 is an exemplary embodiment of a business process flow relating to Import-Export of Autos, Machinery and other forms of capital asset transactions between two business entities in two different countries.

### DETAILED DESCRIPTION OF THE INVENTION

Exemplary embodiments of systems and processes that facilitate integrated network-based automation of any capital asset procurement are described below in detail. The systems and processes facilitate, for example, setting up a business entity and associated sub-entities, capturing the business rules, and defining privileges in relation to business entity's objectives using a client system, automated extraction of information, and web-based processing, tracking and management of the business transaction.

The systems and processes are not limited to the specific embodiments described herein. In addition, components of each system and each process can be practiced independent and separate from other components and processes described herein. Each component and process also can be used in combination with other components and processes to achieve business objectives of various different business entities.

In an exemplary embodiment, the application is implemented as a Centralized Database utilizing a Structured Query Language (SQL) with a client user interface front-end for administration and a web interface for standard user input and reports. The application is web enabled. In a further exemplary embodiment, the application is fully accessed by individuals having authorized access outside the firewall of the business entity through the Internet. In another exemplary embodiment, the application is run in a Windows NT environment or simply on a stand alone computer system. In yet another exemplary embodiment, the application is practiced through manual process steps. The application is flexible and designed to run in various different environments without compromising the major functionality.

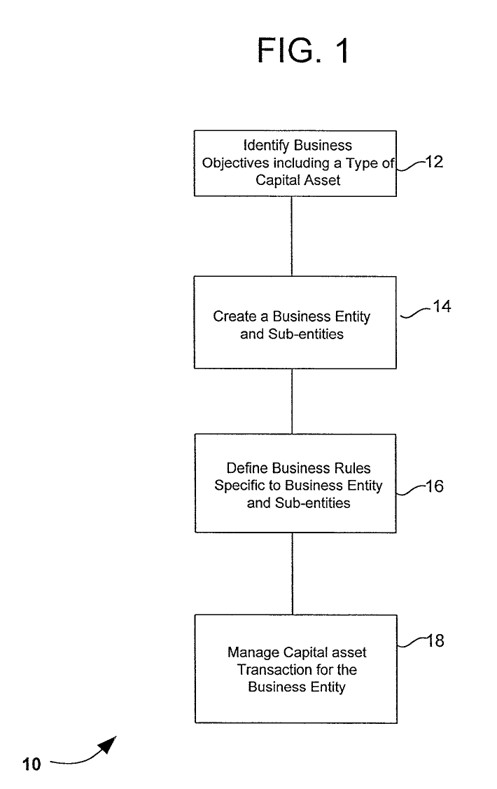

FIG. 1 is an exemplary embodiment of a flow chart of a Capital Asset Transaction Process 10 managed by utilizing a Field Programmable Transaction System (FPTS). In one embodiment, the capital asset transactions include, but are not limited to, primary and secondary markets for new or used machinery, ships, boats, automobiles, planes, factory equipment and other broader classes of capital assets. Such class of trade can happen in a B2B, I2I or B2C2B, B2C and using other market/trading dynamics, including auctions.

In an exemplary embodiment, the capital asset transaction process is adapted for creating robust workflow in the title, escrow, mortgage and other industries that have a complex workflow and heuristics from order entry to fulfillment. In addition, the local and geographic practices involved in procurements of capital assets are very diverse and must comply with rules/regulations and customer preferences. The completion of such capital asset procurement transaction requires interaction of several entities including service providers, who fulfill one or multiple functions in the process.

In yet another exemplary embodiment, the capital asset transaction process for creating and managing transactions utilizes a network-based system, a centralized database and a client system. In another embodiment, the capital asset transaction process is practiced utilizing a computer program embodied on a computer readable medium installed on a stand-alone computer. The computer program instructions implementing various steps to create, implement and manage various transactions are stored on the disk storage device until the microprocessor retrieves the computer program instructions and stores them in the main memory. The microprocessor then executes the computer program instructions stored in the main memory to create and manage the transactions. The computer program provides flexibility to the business entity to adopt specific rules and criteria unique to the business entity, without compromising any major functionality.

Capital asset transaction process 10 includes identifying 12 business objectives including defining a type of the capital asset involved in the transaction. In one embodiment, the transactions include, but are not limited to, real estate, ships, timeshares, boats, automobiles, planes, factory equipment and other broader classes of capital assets. The process further includes creating 14 a business entity and related sub-entities. In an exemplary embodiment where the transaction is a real estate transaction, creating 14 may include creating new entities such as a Buyer, a Seller, a Escrow, a Lender and so on. Creating 14 may further include creating forms, documents and tasks. Once the business entity and related sub-entities are created and appropriate relationships are established through proper linkages, process 10 includes defining 16 business rules specific to the business entity and the associated sub-entities. These business rules define how the transaction are conducted by the end user and processed by the system. Once the business rules, also known as business logic, are known, process 10 then includes managing 18 the capital asset procurement transactions on an on-going basis until the transaction is closed successfully.

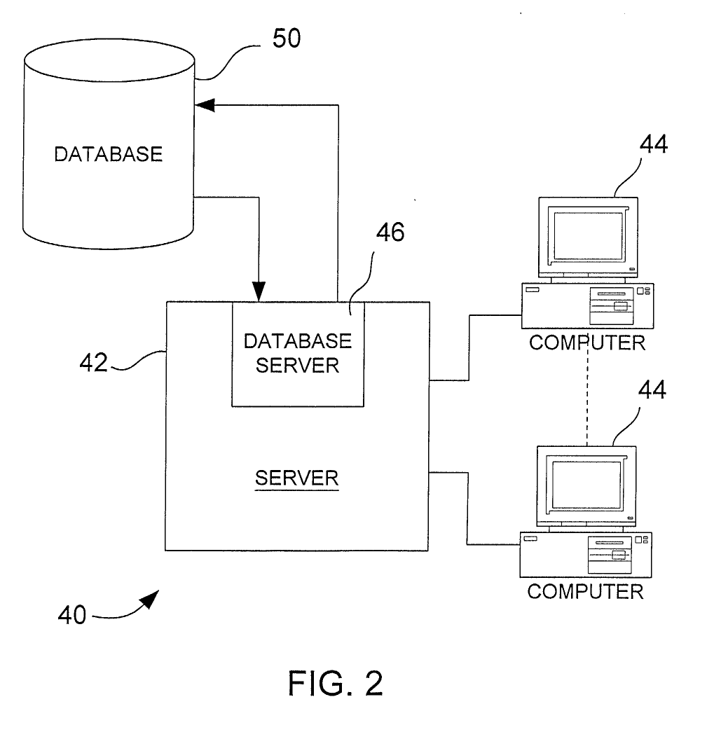

FIG. 2 is a block diagram of a FPTS 40 that includes a server system 42, sometimes referred to herein as server 42, and a plurality of customer devices 46 connected to server 42.

FPTS 40, a fully integrated on-line web-based system, is an enterprise-wide communication tool. FPTS 40 is a centralized and integrated business tool created to drive business accountability and performance, and to improve closing of the transactions in a timely manner. It enhances lines of communication between the parties at various locations and the business entity to close the transaction. FPTS 40 utilizes the Internet to enhance communication. FPTS 40 not only makes the transaction managing process more accessible, but it also makes the process faster, more reliable, efficient and profitable. FPTS 40 is secure, exclusive and protected.

FPTS 40 is implemented for creating and managing capital asset business exchanges. The examples of capital asset transactions include, but are not limited to, residential and commercial real estate, timeshares primary and secondary markets for new or used machinery, ships, boats, automobiles, planes, factory equipment and other broader classes of capital assets. FPTS 40 is designed to facilitate participation of the parties responsible for the transaction and to improve the efficiency in closing the transaction. FPTS 40 also helps the business entity comply with federal, state, and local rules and regulations.

Unlike instant buying, as characterized in the procurement of consumer goods, the capital asset buying, selling, leasing or auction processes are characterized by longer sales cycles and elaborate post sales activities involving multiple functions performed by multiple entities. The multiple functions involved, for example, are appraisals, inspections, financing and recording of the deeds as seen in residential as well as commercial real estate. The completion of capital asset procurement involves interaction among multiple entities, including service providers, who perform one or multiple functions to complete the transaction. FPTS 40 helps create a customizable transaction environment for fulfilling the business processes to complete the capital asset business exchanges/transactions.

FPTS 40 utilizes several pre-defined business rules/guidelines/criteria and checklists in closing transactions or asset business exchanges. The decision criteria, forms, documents and checklists, and various other business tools and processes, as described below in more detail, are stored on server system 42 and can be accessed by the business entity at any one of customer devices 46.

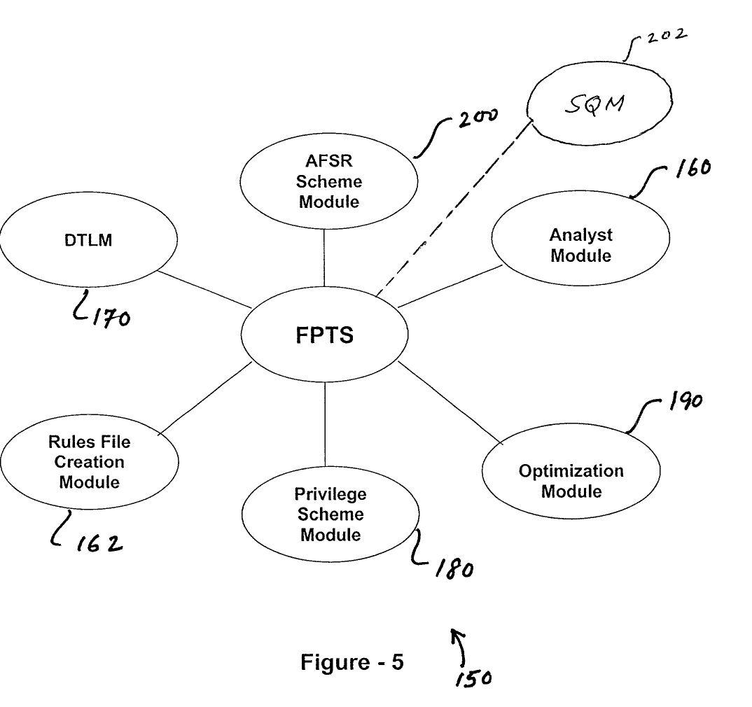

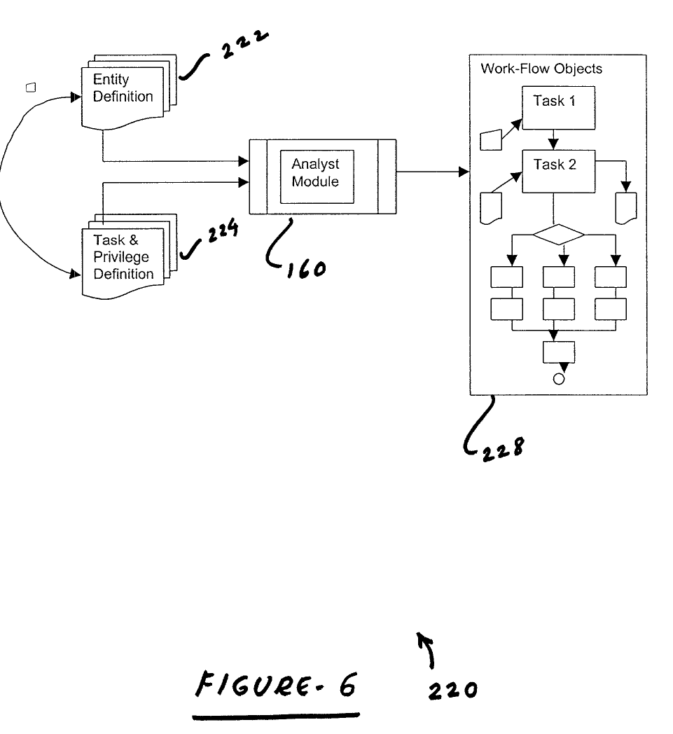

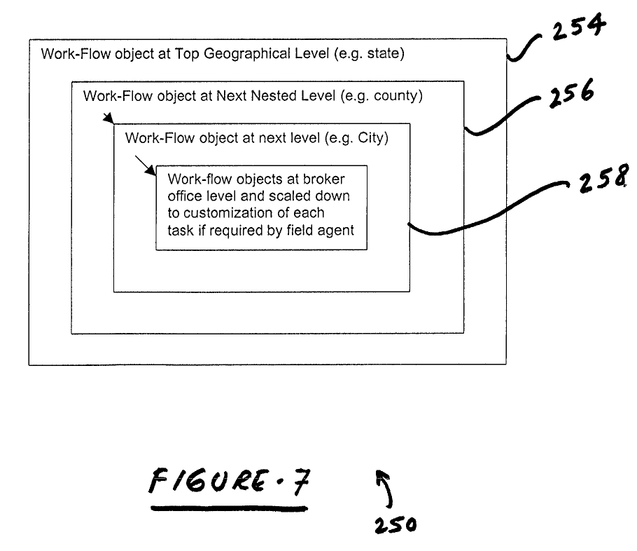

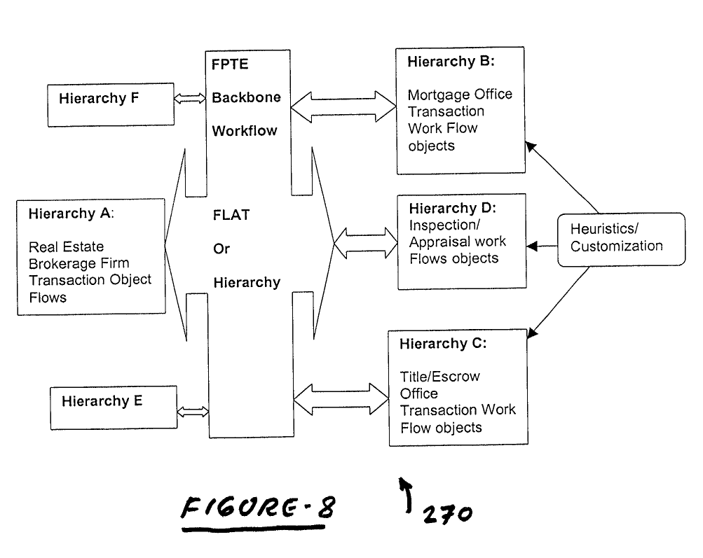

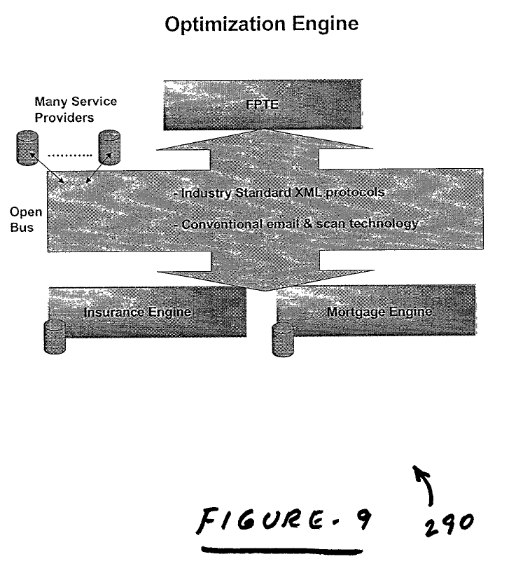

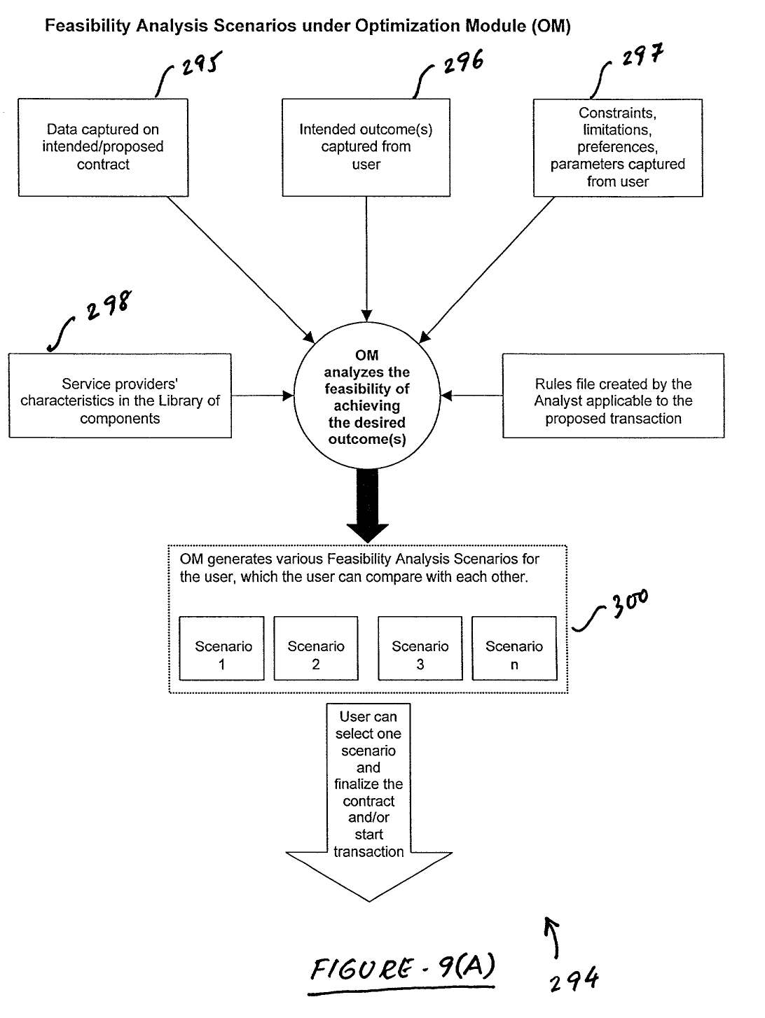

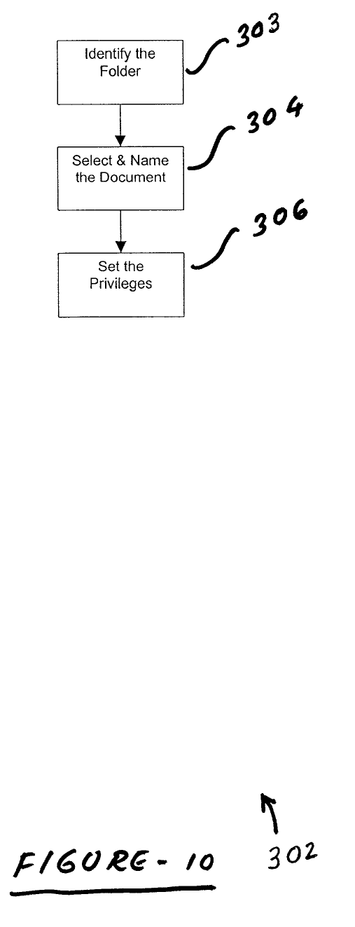

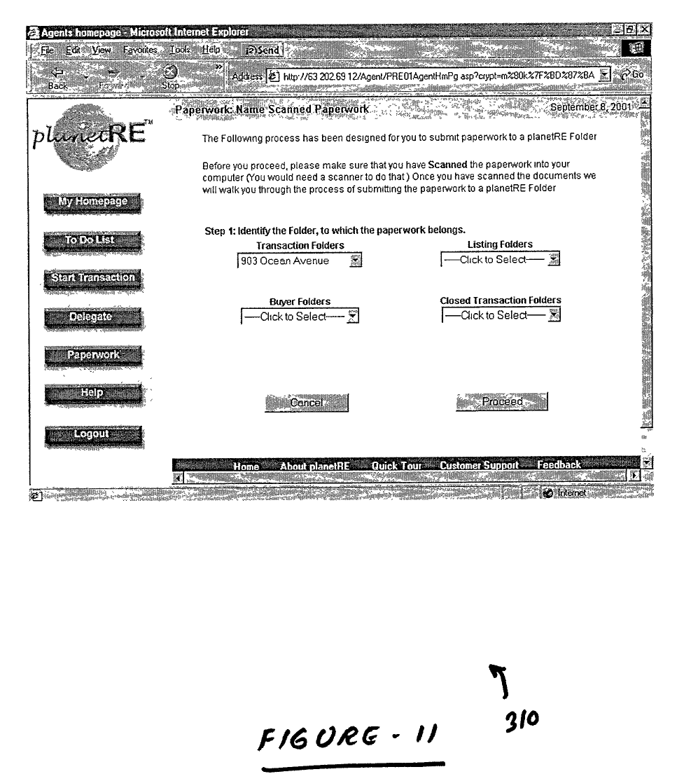

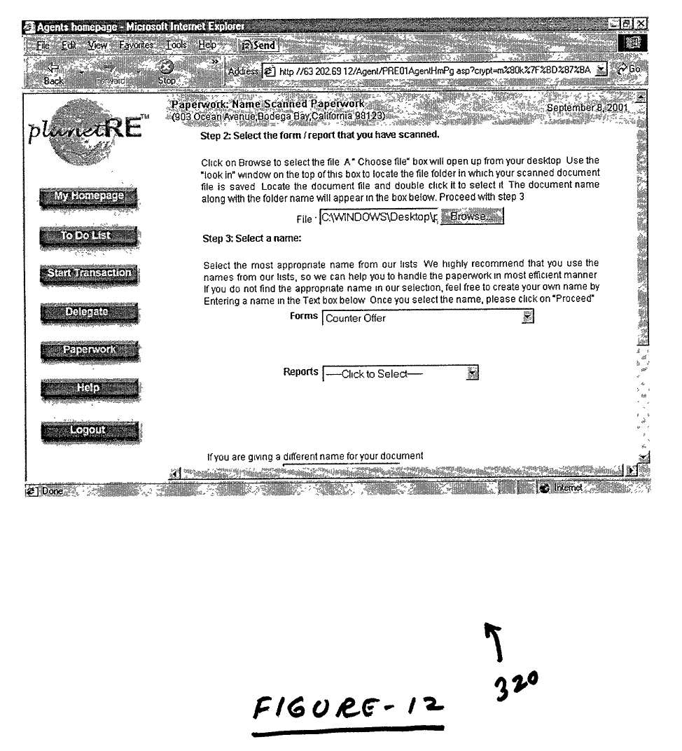

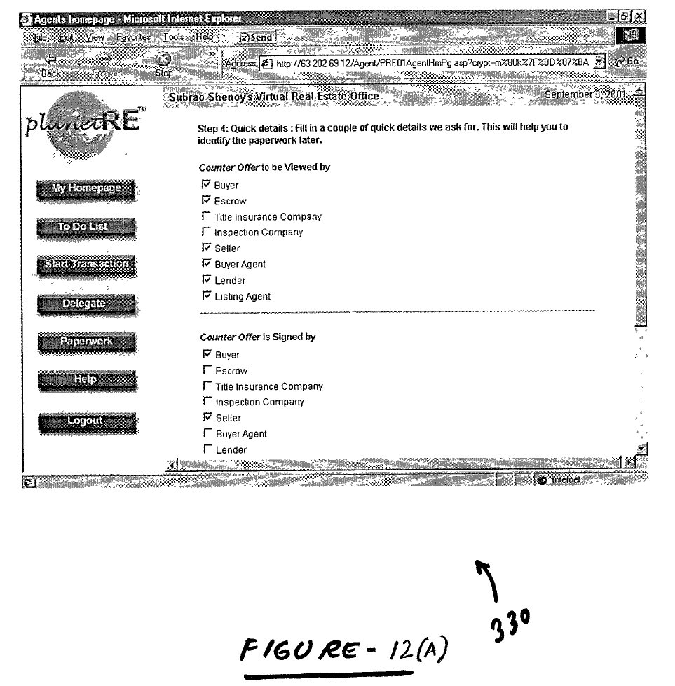

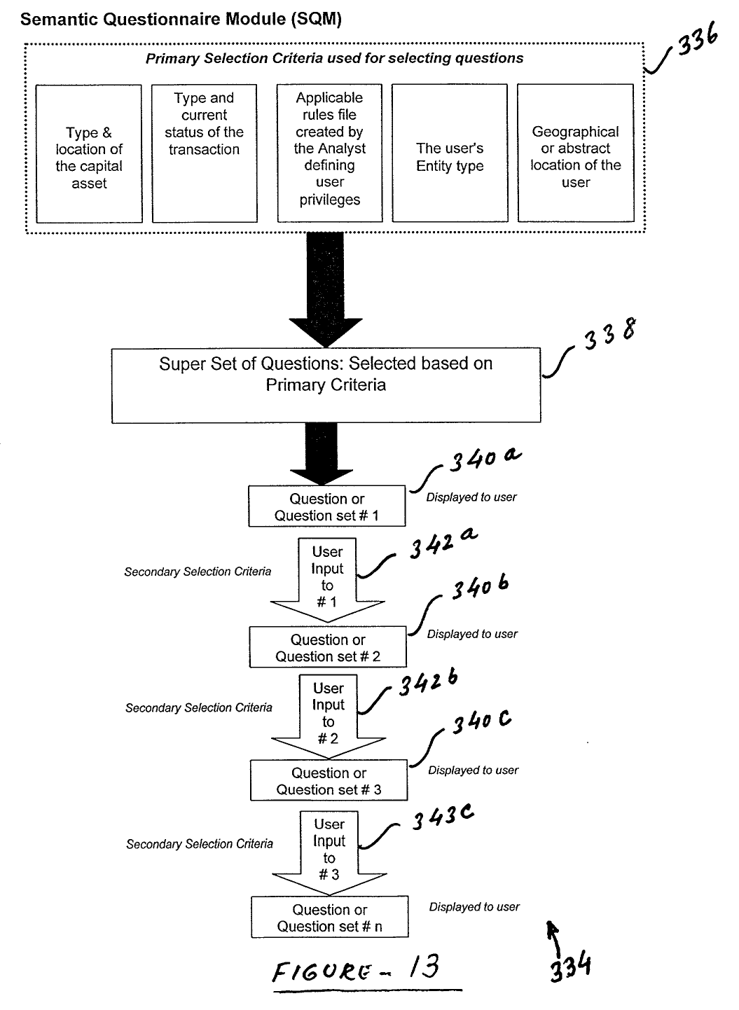

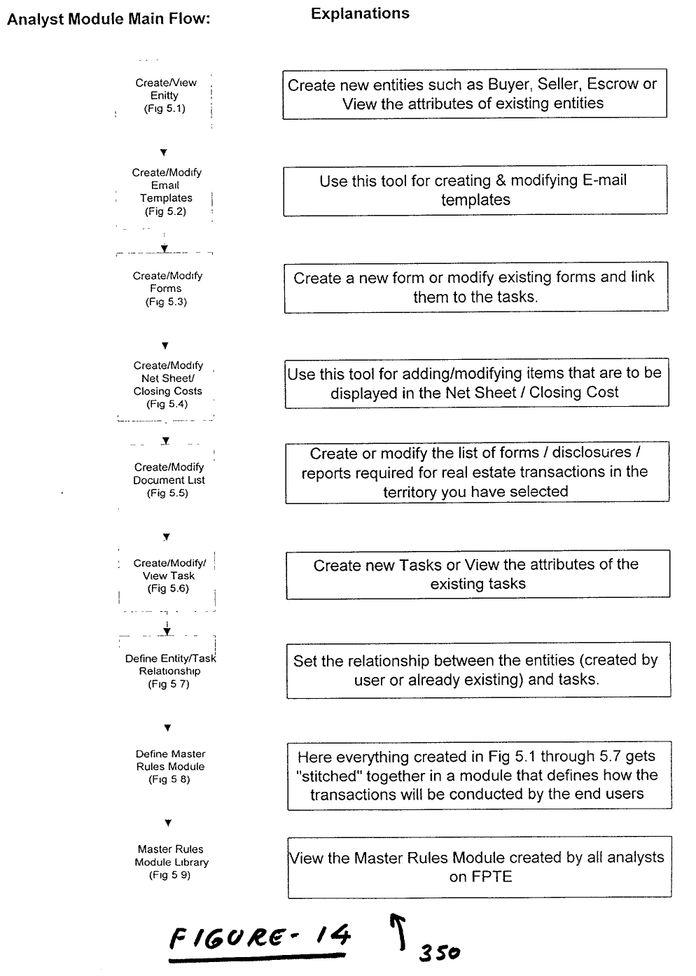

In one embodiment, devices 44 are general purpose computers including a web browser, and server 42, which is accessible to devices 44 via a network such as an intranet or a wide area network such as the Internet. FIG. 5 below describes the general purpose computer 44 in detail. In an alternative embodiment, devices 44 are servers for a network of customer devices. Customer device 44 could also be any client system capable of interconnecting to the Internet including a web-based digital assistant, a web-based phone or other web-based connectable equipment. In another embodiment, server 42 is configured to accept information over a telephone, for example, at least one of a voice responsive system where a user enters spoken data, or by a menu system where a user enters a data request using the touch keys of a telephone, as prompted by server 42.

Devices 44 are interconnected to the network, such as a local area network (LAN) or a wide area network (WAN), through many interfaces including dial-in-connections, cable modems and high-speed lines. Server 42 includes a database server 46 connected to a centralized database 50. In one embodiment, centralized database 50 is stored on database server 46 and is accessed by potential customers at one of customer devices 44 by logging on to server system 42. In an alternative embodiment, centralized database 50 is stored remotely from server 42.

In yet another embodiment, FPTS 40 manages multiple databases to exchange information for various users in a distributed environment. FPTS 40 is implemented utilizing distributed exchange in a distributed environment wherein each centralized database of each distributed exchange is capable of exchanging data across the Internet.

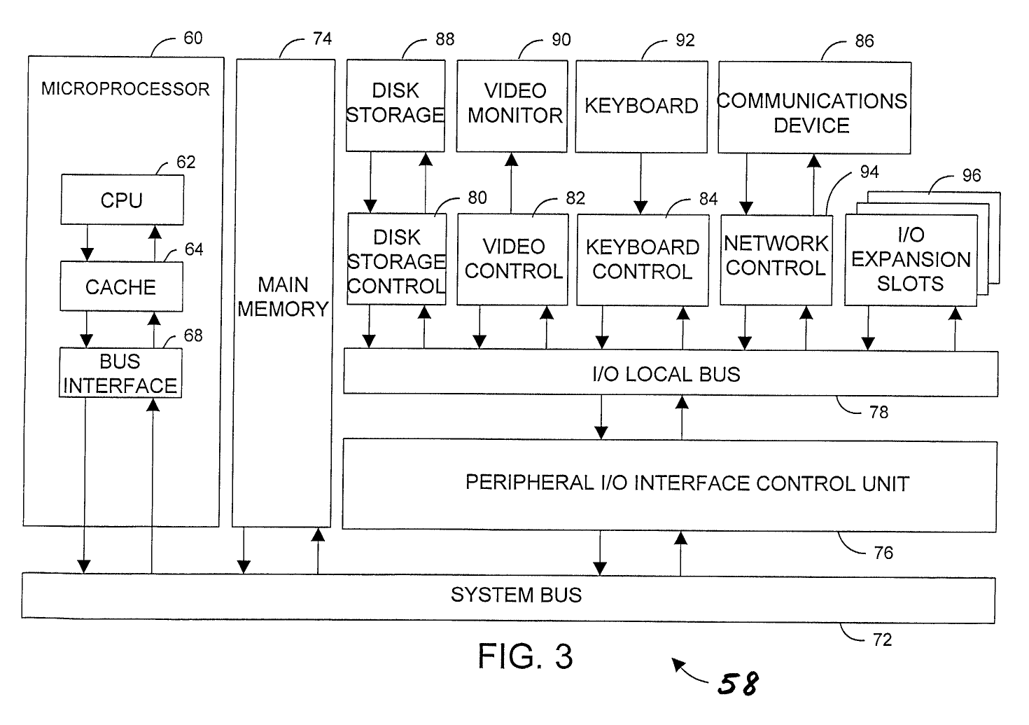

FIG. 3 is an exemplary embodiment of a hardware architecture 58 diagram of a general purpose computer suitable for use as a server host. A microprocessor 60, comprised of a Central Processing Unit (CPU) 62, a memory cache 64, and a bus interface 68, are operatively coupled via a system bus 72 to a main memory 74 and an I/O control unit 76. I/O interface control unit 76 is operatively coupled via an I/O local bus 78 to a disk storage controller 80, a video controller 82, a keyboard controller 84, and a communications device 86. Communications device 86 is adapted to allow software objects hosted by the general purpose computer to communicate via a network with other software objects. Disk storage controller 80 is operatively coupled to a disk storage device 88. Video controller 82 is operatively coupled to a video monitor 90. Keyboard controller 84 is operatively coupled to a keyboard 92. A network controller 94 is operatively coupled to communications device 86. The system has I/O expansion slots 96 to accommodate future upgrades.

Computer program instructions for creating, tracking, and managing capital asset business exchanges are stored on the disk storage device until the microprocessor retrieves the computer program instructions and stores them in the main memory. The microprocessor then executes the computer program instructions stored in the main memory to implement the network based FPTS.

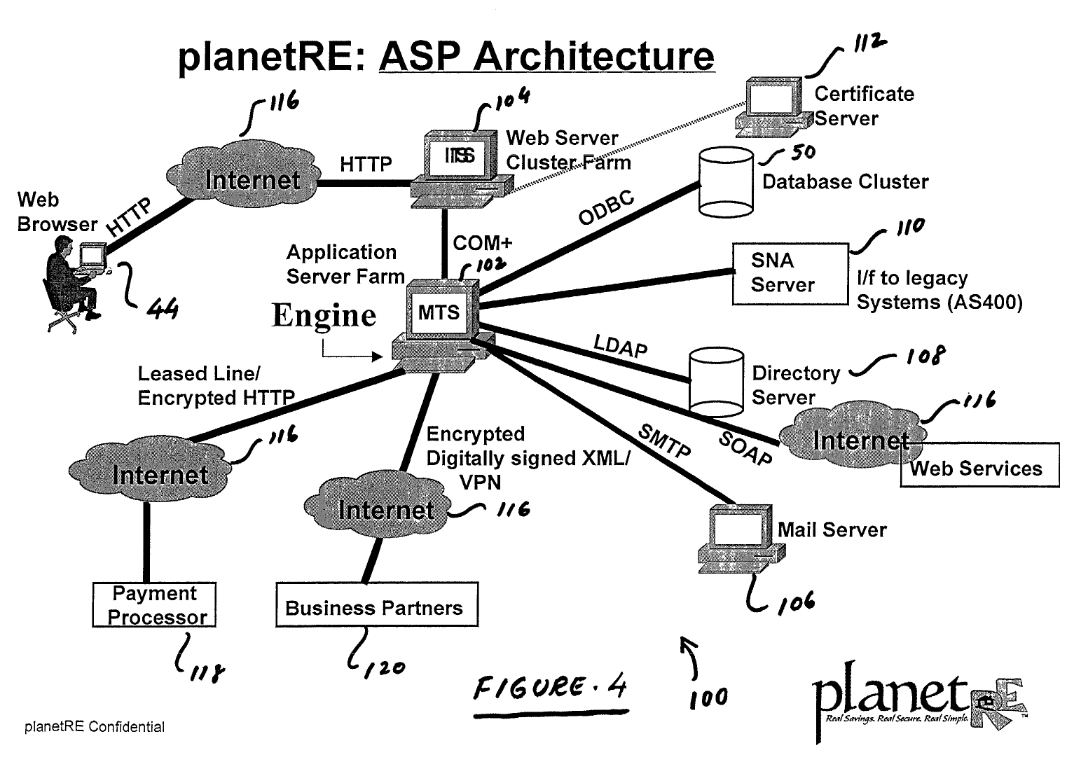

FIG. 4 is yet another exemplary embodiment of a block diagram of a FPTS 100. Components in FPTS 100, identical to components of FPTS 40 (shown in FIG. 2), are identified in FIG. 4 using the same reference numerals used in FIG. 2. FPTS 100 is implemented on top of a scalable and secure architecture that is cost effective and provides robust functionality and performance with growth in a number of transactions. FPTS 100 architecture is flexible to accommodate Virtual Private Network (VPN) solution at server level to ensure that only authorized users can access the network and that the data cannot be intercepted.

FPTS 100 includes customer device 44 connected to server system 42 that performs a wide variety of complex tasks. In this embodiment, server system 42 includes, but is not limited to, an application server 102, a web server 104, a mail server 106, a directory server 108, a SNA server 110 (if needed), and a certificate server 112. Some other servers, such as a database server and a fax server, are also utilized by FPTS 100.

Servers are often dedicated, meaning that they perform no other tasks besides their server tasks. For example, application server 102 serves various applications and modules associated with the computer program applications to users and also acts as a traffic officer in a database intensive application such as this. Web server 104 hosts the web site of the business entity using one of the multi-platform servers. Mail server 106 sets up a messaging system that allows the users to exchange e-mails over LANs and/or the Internet. Directory server 108 manages various directories and sub-directories to organize information. Database 50, or database clusters, are utilized to store information. In an exemplary embodiment, database 50 is linked to application server 102. Application server 102 is further connected via the Internet 116 to a payment processor 118 and various other business partners 120.

Certificate server 112 manages digital certificates for various users. The digital certificate is an attachment to an electronic message used for security purposes. The most common use of a digital certificate is to verify that a user sending a message is who he or she claims to be, and to provide the receiver with the means to encode a reply. An individual wishing to send an encrypted message applies for a digital certificate from a Certificate Authority (CA). The CA issues an encrypted digital certificate containing the applicant's public key and a variety of other identification information. The CA makes its own public key readily available through print publicity or on the Internet. The recipient of an encrypted message uses the CA's public key to decode the digital certificate attached to the message, verifies it as issued by the CA, and then obtains the sender's public key and identification information held within the certificate. With this information, the recipient can send an encrypted reply.

The fax server sends and receives faxes with the Internet server. In yet another embodiment, there are other servers including, but not limited to, Audio/Video server to deliver streaming multi-media content, a List server to create and serve individualized mailing lists, e-mail response system for users, customer, or affiliates, and Chat servers are utilized. A disk storage unit (not shown) is coupled to database server 46 and directory server 108. Various different servers listed above are coupled in a local area network (LAN). Additionally, workstations, also referred to as customer devices or client systems, are coupled to the LAN via an Internet link or are connected through an intranet.

Server system 42 is configured to be communicatively coupled to various individuals or employees and to third parties via an ISP Internet connection 116. The communication in the exemplary embodiment is illustrated as being performed via the Internet, however, any other wide area network (WAN) type communication can be utilized in other embodiments, i.e., the systems and processes are not limited to being practiced via the Internet. In addition, the local area network could be used in place of the WAN.

In an exemplary embodiment, web server 104 and application server 102 are linked using Component Object Model (COM) or COM+ technology. The COM is a model for the binary code developed by Microsoft Corporation. The COM enables programmers to develop objects that can be accessed by any COM-compliant application The COM provides a means for software components to communicate with each other. The COM allows any two components to communicate regardless of what machine they are running on (as long as the machines are connected), what operating systems the machines are running (as long as it supports COM), and what language the components are written in. The COM further provides location transparency.

The systems described in FIGS. 2, 3 and 4 are configured to implement a methodology to create and manage capital asset transactions based on pre-determined criteria and business rules established by the business entity. The architecture of system 40 and 100 as well as various components of system 40 and 100 are exemplary only. Other architectures are possible and can be utilized in connection with practicing the processes described below.

FIG. 5 is an exemplary embodiment of a diagram 150 depicting the functionality and features of an integrated network based Field Programmable Transaction System (FPTS) 40.

FPTS 40 executes a computer code embodied on a computer readable medium and incorporated herein on a CD-ROM under Appendix—A. In an exemplary embodiment, the computer code is divided into various different modules. These modules provide various different functionalities and are capable of interchanging efficiently to create, manage and track various transactions. In an exemplary embodiment, these modules are: an Analyst Module (AM) 160, a Rules File Creation Module (RFCM) 162, a Dynamic Transaction Logic Module (DTLM) 170, a Privilege Scheme Module (PSM), also referred to as a Privilege Function Module (PFM) 180, an Optimization Module (OM) 190, and an Automatic File Storage and Retrieval module (AFSRM) 200. In yet another exemplary embodiment, the computer code also includes a Semantic Questionnaire Module (SQM) 202 in addition to analyst module 160, Rules File Creation Module 162, Dynamic Transaction Logic Module 170, Privilege Scheme Module 180, Optimization Module 190, and Automatic File Storage and Retrieval module 200. Although features described below relate to each specific module, one skilled in the art would recognize that there are other possible combinations to arrange these features under many different modules and sub-modules. The physical structure or architecture implementing the FPTS is described above in FIGS. 2 and 4. The software modules that drive the FPTS are described below in more detail.

FIG. 6 is an exemplary embodiment of a basic flow diagram 220 describing analyst module 160. Easy and rapid programming of FPTS 40 by analyst module 160 provides the ability to capture the fundamental business rules. While creating such rules, the basic and related business entities and sub-entities are created 222 by the analyst. The analyst further creates definitions 224 of all privileges, scope of each entity and their responsible tasks, documents/forms that need to be automatically invoked during transaction execution, and logic of their business interaction in the transaction process. Entities, tasks, and privileges are interrelated. Work flow objects 228 define the nature of intricate tasks, which further include documents, forms and other objects invoked by FPTS 40.

Analyst module 160 allows the FPTS to handle any new geographic rules by easily creating such rules file that gets compiled as objects and tables. In one embodiment, FPTS 40 is modified to create a residential real estate transaction engine for buying, selling, or auctioning of real estate in Iowa with the same ease as in California, Japan or the United Kingdom. In yet another embodiment, FPTS 40 is modified utilizing analyst module 160 to create commercial real estate procurement in Montana or buying and/or selling ships in Greece. In each instance, the analyst with the privilege scheme (described below) creates a robust manifestation of FPTS based on business processes, local regulations and business practices.

FIG. 7 is an exemplary embodiment of hierarchical layers 250 of programming with an override scheme that is implemented by FPTS 40 utilizing analyst module 160. There are six different levels.

Level 1: Country

Level 2: State 254

Level 3: County 256

Level 4: City 258

Level 5: Client Company/Office

Level 6: Individual user of the system

Hierarchical layers 250 of programming with an override scheme allow one layer to override the other. For example, level 2 overrides the rules written at level 1, and levels 5 and 6 override all the above rules. Under level 6, the user creates his/her own style of conducting business. The FPTS also provides features for the user in level 6 to add, delete, or modify the user's own tasks and sub-tasks, document names, privileges and delegation schemes.

In an exemplary embodiment, when the user starts the transaction the appropriate master rules are accessed based on geographic location of the capital asset being procured and/or the geographic or abstract location of the user, and based on that the relevant entities, sub-entities, workflow, documents, and privileges are implemented for conducting the transaction.

FIG. 8 is an exemplary embodiment of hierarchical layers implemented by FPTS 40 utilizing analyst module 160. Analyst module 160 allows robust creation of the entire transaction backbone by creating virtual offices and workflows for all participants. For example, in a real estate transaction, analyst module 160 creates virtual offices and their dynamic work flow definitions for the real estate office, the mortgage office, and the inspection office. Under each of these hierarchies, grouping and umbrella, a variety of entities, sub-entities and their connected tasks are also created. Once the virtual offices are created, analyst module 160 creates the grouping of a class of related entities and sub-entities in a cohesive environment for each virtual office. For example, the creation of the virtual real estate office includes setting up agents, brokers, assistants, managers, transaction coordinators, office administrators and others that operate in a typical broker office environment. The grouping function of tasks/entities under one virtual office allows the analyst to define any number of tasks and sub-tasks under these groups. This further allows for the transaction viewer in FPTS 40 to display any levels of tasks monitoring at levels of hierarchy, including a flat hierarchy. This option permits optimization across all tasks, if necessary. The entire backbone workflow of a capital asset procurement transaction (FIG. 8) that spans multiple industries (e.g. title, mortgage, real estate, inspection companies as in residential real estate) can be connected by mixing and matching hierarchies. In connecting such a major and detailed workflow; the hierarchy of a major box (like mortgage) can be left intact by interfacing and communicating only via the outer boundary level OR the hierarchy can be collapsed to see all tasks, sub-tasks, entities, privileges, and communications underneath. After analyst module 160 is defined and compiled, FPTS 40 creates specific entity related homepages for these entities/sub-entities with the privilege scheme and their own working environment. Analyst module 160 further allows the analyst to create rules of proxy and delegation to define privileges.

Rules File Creation Module (RFCM) 162 (shown in FIG. 5) creates a Basic Rules Definition File (BRDF). The BRDF contains “layer” definition of each entity and how each layer interacts or does not interact based on the layer's logical relationship in a business situation. The logical relationship is entered by a system analyst in the BRDF that is captured using a simple and intuitive Graphical User Interface (GUI). FPTS 40 is capable of adapting a new hierarchical language to create entities, describe rules and inter-relationships, and provide an industry standard that can be adopted for a variety of users and business transactions.

The BRDF contains entity definitions for all entities in the transaction. For example in the residential real estate market, entities are: mortgage, escrow, title, inspection, buyer, seller, and buyer agent, listing agent and other individuals. The BRDF may involve even abstract entities that may be remotely needed in the transaction processing. This functionality offers an option to the analyst to add new entities in the transaction, as needed. Additionally, the BRDF helps define the basic skeleton of the entities, their functions/tasks and their logical relationship. For example, the escrow company involved in the real estate transaction does not order inspection for the transaction. However, the inspection company can send the invoice for inspection services to the escrow company.

In an exemplary embodiment, FPTS 40 analyzes compiled analyst module 160 to understand the entities, relationships and their rules of interaction. FPTS 40 also analyzes the source contract that describes all the details of the contracts, terms and conditions, dates, contingencies etc. The information on the source contract is captured through filling of contract forms on the exchange or filling of a questionnaire on the exchange or transferring the relevant data via XML interface from the contract source outside the exchange. From this composite information, FPTS 40 creates and executes a dynamic automated workflow using Dynamic Transaction Logic Module (DTLM) 170 that incorporates all the tasks for the defined entities and auto navigates based on outcomes and transaction variables exchanged via the Internet.

DTLM 170 (shown in FIG. 5) of the FPTS enables changing the transaction flow automatically or manually based on direct user inputs and/or transaction variables referenced and exchanged via the Internet.

As stated above, DTLM 170 accepts the compiled business rules and the information in the online contract document and creates an automated workflow that navigates itself. DTLM 170 navigates the transaction by understanding user controls and/or XML based real time transaction variables communicated and exchanged via the Internet. In an exemplary embodiment, DTLM 170 selects a different alternative to completion based on a course of action taken by a given service provider and the level of success achieved by the service provider in completing the task.

FPTS 40 recognizes dependent transactions on its own servers or information received via XML from third party transaction servers/exchanges. For example, Transaction A may be contingent upon Transaction B closing on its own server or on a third party server/exchange which, in turn, may be dependent on Transaction C somewhere else. In each case, via user input or through completion or non-completion of tasks/milestones either on the same server or through external servers, DTLM 170 provides the state diagram for the next course of action. The base of the logic is compiled via analyst module 160. The timeline is derived from the actual contract or built-in default timetables stored in the business rules.

In yet another exemplary embodiment, FPTS 40 adopts a Privilege Scheme to provide an elaborate, field and user customizable privilege scheme to execute tasks, and to create/upload/view/edit/sign documents on the FPTS server that guarantees transaction integrity and privacy. Privilege Scheme Module (PSM), also referred to as a Privilege Function Module (PFM) 180, implements the Privilege Scheme.

PSM 180 helps create a secure privilege function that guarantees that work areas of different entities and their responsibilities remain secure and discrete with the help of analyst module 160. PSM 180 relates to the privilege of executing a task and marking it complete or not complete, as applicable viewing and editing of documents, and viewing of other information such as listing feedback, offer highlights, etc.

With the help of PSM 180, the analyst creates “Entity Proxy” function. Entity Proxy means that if a task X is to be done by Entity A and if Entity A is missing (temporary or permanent), then FPTS 40 can assign the task to Entity B. If Entity B is unavailable, the task can be assigned to Entity C, and so on. The Entity Proxy function can cross the grouping/office boundary. For example, if the escrow officer is not participating in the transaction on the exchange, then the listing agent takes the responsibility of marking the escrow officer's tasks as complete or not applicable, provided the analyst has designated such privileges during setting up the Master Rule Module for that territory. In this example, the proxy function is transferred from the escrow office to the real estate office.

With the help of PSM 180, the analyst creates the “Entity Delegation” function. The Entity Delegation is meant for intra-office function and relates to tasks only. For example, if agent A is on vacation or has left the company, then the broker can assign Agent A's transactions to agent B, either temporarily or permanently. Also, the agents themselves can delegate tasks or transactions to various entities in the office.

FIG. 9 is an exemplary embodiment of a flow chart depicting the functionality of Optimization Module (OM) 190 that is being implemented for service providers. OM 190 stores all given characteristics of service providers in the library of components (real time calendar, availability, geographical coverage, the price list, user ratings, etc.). OM 190 manages a constrained-based optimization whereby the constraints and objectives are provided by the user to develop an Optimized Transaction Workflow for any or all entities involved in the transaction.

Optimized Transaction Workflow relates to an inter-connection of the entity instances (at run time) driven by a time wheel. The time wheel (scheduling) is derived from the dates for various terms and conditions in the actual contract. Time and contingencies, as in the contract, also connect these entities. All the entity definitions are compiled in a cell library. FPTS 40 provides flexibility to add more cells. In an exemplary embodiment, these cells are compiled into mega cells when their inter-relationships are fairly constant in a given geography. When more service providers sign up, the optimization of the workflow can utilize these mega-cells whenever each grouping of tasks is always connected. Based on the user's repeated use of the FPTS by the user (called user adaptation), the program gives appropriate input to OM 190.

With the user adaptation and creation of mega cells, OM 190 can be run in a constrained based optimization role. The user can specify that the transaction must close within 10 days with the total transaction cost (fee) not to exceed $1,000. The FPTS then runs and provides such optimal workflow understanding the objective and the constraint(s). OM 190 also enforces the privilege function as programmed by the analyst. The optimization can be run at any level of hierarchy, kept intact, or partially collapsed or completely collapsed, and executed at flat level. This means that the tasks belonging to all the office groups supporting the transaction backbone are visible to OM 190 and the transaction viewer (as shown in FIG. 8).

FIG. 9(A) is an exemplary embodiment of a flow chart 294 depicting feasibility analysis scenarios developed by Optimization Module (OM) 190, shown in FIG. 5. OM 190 allows the user to create feasibility analysis scenarios before filling out contract forms and/or accepting an offer and/or entering into contract for the procurement of the capital asset.

First the OM 190 captures data 295 on the proposed or intended terms, conditions, timelines, deadlines, financial data, etc. through the direct user input on the servers or through transferring relevant data from the source document on or outside the Exchange. Then OM 190 captures the desired outcome(s) 296 from the user, along with any constraints, limitations, preferences, and parameters 297.

OM 190 analyzes the feasibility of achieving the desired outcome(s) 296 based on the combined impact of the data captured 295 on the proposed/intended contract, data captured 297 from the user on constraints, limitations, etc, the service provider's characteristics in the library of components 298, and the rules file created by the analyst 299 that is applicable to the proposed transaction and creates various feasibility analysis scenarios 300 for the user. The various scenarios inform the user if the desired outcome(s) can or can not be achieved or different/better outcome(s) that can be achieved. OM 190 points out which factors have what impact on achieving the desired or better than desired outcome(s), all the inconsistencies and suggests alternatives.

The user has complete flexibility to select and implement any/all/none of the alternatives suggested by the OM and/or change any of the factors that may or may not have impact on achieving desired outcome(s). The user can continue to change factors to create any number of feasibility analysis scenarios and compare them to each other. The user can select any one of these scenarios to proceed and/or to finalize the contract and start the transaction.

In an exemplary embodiment, the FPTS incorporates an Automatic File Storage and Retrieval module (AFSRM) 200 that manages contextual file naming, giving privileges to view/sign, storing, and retrieving key documents including, but not limited to, forms, reports, and disclosures used in and related to the transaction. These documents are faxed/scanned/emailed or sent through XML interfaces or created on the servers. The FPTS creates a specific and an efficient way of naming files that are easy for the system to select, display, print and store during the execution of the transaction.

AFSRM 200 utilizes a built-in fax/scan or an XML based document exchange infrastructure to feed important forms, documents, reports on FPTS 40 and MAP to a specific transaction folder. This provides a reliable mechanism to store, retrieve and send documents/reports, in/out from a variety of sources to the relevant transaction folders on the system. Using a combination of transaction identifications generated by the system and analyst created options on types of services and naming conventions for files, the user is provided online collating function for the pages that were fed into the system and stored under file names using identifiers as defined by the analyst. This nomenclature is used to map incoming documents with the Transaction Folders before being stored on the system servers. This technique is used for transactions, listings, closed transactions and buyers' folders on the system.

FIGS. 10 through 12(A) are exemplary embodiments of a flowchart and associated screen displays depicting AFSRM 200 functionality. Screen displays identify various steps utilized in managing file storage and retrieval.

FIG. 10 is an exemplary embodiment of a flow chart 302 depicting the functionality of AFSRM 200. The automatic File Storage & Retrieval includes identifying 303 the folder to which the paperwork belongs, selecting and naming 304 the document, and setting 306 the privileges. FIG. 11 is an exemplary embodiment of a user interface 310 for identifying the folder. FIG. 12 is an exemplary embodiment of a user interface 320 for selecting and naming 304 the document. FIG. 12(A) is an exemplary embodiment of a user interface 330 for setting the privileges. These various embodiments describe one specific way of practicing the invention, inputting or displaying data or printing reports.

FIG. 13 is an exemplary embodiment of a flow chart 334 depicting functionality of SQM 202 (shown in FIG. 5). SQM 202 is utilized for capturing the data on the business contract from the user and/or for filling out forms related to the offer/contract/transaction. SQM 202 is also utilized in conjunction with the creating of Feasibility Analysis scenarios under the Optimization Module. SQM 202 improves efficiency and reduces the time and efforts required to fill the questionnaire in order to capture the necessary data.

SQM 202 selects and displays to the user only the relevant questions from the library of questions. Based on the primary selection criteria 336 a super set of questions 338 is selected by SQM 202. Primary selection criteria includes, but are not limited to, the type of the capital asset being procured, the location of the capital asset being procured, the type of the transaction, the current status of the transaction, the applicable rules file created by the Analyst containing the defining the privileges of the user, the user's entity type, and the geographical or abstract location of the user. For example, based on the primary criteria, the super set of questions selected for a buyer's agent on a purchase transaction of a single family home in Chicago, will be totally different than the same for a listing agent on a lease transaction of a commercial property in London.

The secondary selection criteria are the incoming data inputs 342a, 342b, and 342c from the user to a set of questions 340a, 340b, and 340c of the questionnaire itself. SQM 202 continuously takes and analyzes the user input to the questionnaire and continues to display only those questions that are applicable under the circumstances. For example, in a residential real estate purchase, if the user input indicates that the “contingency of sale of buyer's property” is not applicable, no questions in regards to this contingency will be displayed on the remainder of the questionnaire. But if the user input indicates that this contingency is applicable, more questions in regards to this contingency will be displayed.

The architecture of system 40 as well as various components and modules of system 40 are exemplary only. Other architectures are possible and can be utilized in connection with practicing the processes described below.

### I. Overview of the Field Programmable Transaction System (FPTS)

In an exemplary embodiment, an integrated network based Field Programmable Transaction System (FPTS) 40, that adapts to a new geography or a new business for conducting any Capital Asset Procurement/Sale/Leasing/Exchange process, is disclosed. FPTS 40 helps create a highly secure, scalable transaction exchange for businesses such as residential and commercial real estate, timeshares, machinery, equipment and other capital asset exchanges that can adapt to any geography/business practices by changing or altering the business rules. The input to FPTS 40 is the business rules file, created by Analyst Module 160 and the user input through the actual contract for the transaction. The output of FPTS 40 is the transaction workflow for all entities involved in the transaction.

Dynamic Transaction Logic Module (DTLM) 170 enables changing the transaction flow automatically or manually based on direct user inputs and/or transaction variables referenced and exchanged via the Internet. DTLM 170 takes the compiled business rules and the information in the online contract document and creates an automated workflow that navigates itself. FPTS 40 recognizes dependent transactions on its own servers or information received via XML from other third party transaction servers/exchanges. Optimization Module (OM) 190, which is part of FPTS 40, stores all given characteristics of service providers in the library of components. Optimization Module 190 manages a constrained-based optimization whereby the constraints and objectives are provided by the user to develop an Optimized Transaction Workflow for any or all entities involved in the transaction. In an exemplary embodiment, FPTS 40 incorporates an Automatic File Storage and Retrieval module (AFSRM) 200 that manages contextual file naming, storing, and retrieving key documents including, but not limited to, forms, reports, and disclosures used in and related to the transaction. These documents are faxed/scanned/emailed or sent through XML interfaces or created on the servers. FPTS 40 creates a specific and an efficient way of naming files such that the engine can easily select, display, print and store files during the execution of the transaction. In yet another exemplary embodiment, FPTS 40 adopts a privilege scheme to provide an elaborate, field and user customizable privilege scheme to execute tasks, view/edit documents on the FPTS server that guarantees transaction integrity and privacy.

### II. Flow Diagram and User Interfaces Depicting Analyst Module

FIGS. 14 and 15 are exemplary embodiments of flow charts depicting the functionality of analyst module 160 (shown in FIG. 5). These flow charts identify the various steps that may be utilized by the analyst in configuring analyst module 160. The flow charts also depict the overall relationship among various steps involved in configuring the system.

FIG. 14 is an exemplary embodiment of a flow chart 350 of analyst module 160. Flow chart 350 relates to creating a new entity, creating and modifying e-mail templates, forms, net sheets, document lists, tasks, tasks relationships, and several other related functionalities.

FIG. 15 is a continuation of an exemplary embodiment of flowchart 370 depicted in FIG. 14. Flow chart 370 relates to defining module name and a territory, selecting entities, defining task attributes, selecting documents/reports, defining or modifying proxy, and setting default values. Detail functionality pertaining to analyst module 160 is elaborated through various user interfaces as well as the computer code attached herewith as part of the patent application.

FIGS. 16 through 42 are exemplary embodiments of screen displays depicting the functionality of analyst module 160. These various embodiments describe one specific way of practicing the invention, configuring the needs of the business entity, displaying data or organizing data. However, one skilled in the art would recognize that there are multiple possible combinations of organizing the data, displaying the data on the screen as well as printing the data in various reporting formats, which still express the same essential matter and process steps.

FIG. 16 is an exemplary embodiment of an analyst's home page user interface 400. Home page user interface 400 is downloaded and displayed by server system 42 (shown in FIG. 2). Through user interface 400, the analyst first creates or modifies the individual components of the Master Rules Module, such as entities and email templates. Once all the individual components have been defined, the analyst uses the “Define Master Rules Module” to integrate the various components for creating the Master Rules Module for a particular territory.

FIG. 17 is an exemplary embodiment of a continuation user interface 450 of analyst's home page user interface 400. Home page user 400 interface displays various hypertext links including, but not limited to, Create/View Entity, Create/Modify Forms, Create/Modify Document List, Create/Modify E-Mail Templates, Create/Modify Net Sheet/Closing Costs, Create/Modify/View Task, Define Entity-Task Relationship, Define Master Rules Module, Master Rules Modules Library, and Account.

FIG. 18 is an exemplary embodiment of a Create/View Entity user interface 460. User interface 460 is downloaded and displayed by server system 42 (shown in FIG. 2) when the analyst selects an appropriate hypertext link displayed on the home page user interface. Through user interface 460, the analyst creates and defines the various entities that participate in the transactions. The analyst has an option to also view the details on the existing entities.

FIG. 19 is an exemplary embodiment of a Create/Modify E-Mail Templates user interface 470. User interface 470 is downloaded and displayed by server system 42 (shown in FIG. 2) when the analyst selects an appropriate hypertext link displayed on the home page user interface. Through user interface 470, the analyst creates email templates that are used during the transactions. From user interface 470, the analyst selects the details belonging to each of the entities to populate the email template. For example, the analyst selects the first name and the last name belonging to the agent. In addition, the analyst can select the property details (example: property address), Task Details (example: escrow number captured through “Enter Escrow Number” task), Other Details (example: Today's Date) and any hyperlinks (example: www.planetRE.com ) that are to be populated on the email template. After making the selection under each sub-section, the analyst clicks select arrow, shown in FIG. 20, to move the selected details to the box on the right, where the email template gets created.

In addition to creating new email templates through user interface 470, the analyst can view or edit an existing email template. The analyst can also edit an existing template and save it as a completely new template.

FIG. 20 is an exemplary embodiment of a continuation user interface 480 displaying the bottom part of user interface 470.

FIG. 21 is an exemplary embodiment of a Create/Modify Forms user interface 490. Through user interface 490, the analyst creates form templates that are used in the transactions. From user interface 490, the analyst selects various items that will be populated on the form template. Additionally, with the help of “Controls,” the analyst can create textboxes to be filled by the end user while filling out the form. The items selected under each sub-section on the left are transferred onto the Form template on the right with the help of a Select arrow 492. User interface 490 further allows the analyst to select the entities that have the privilege to view this form.

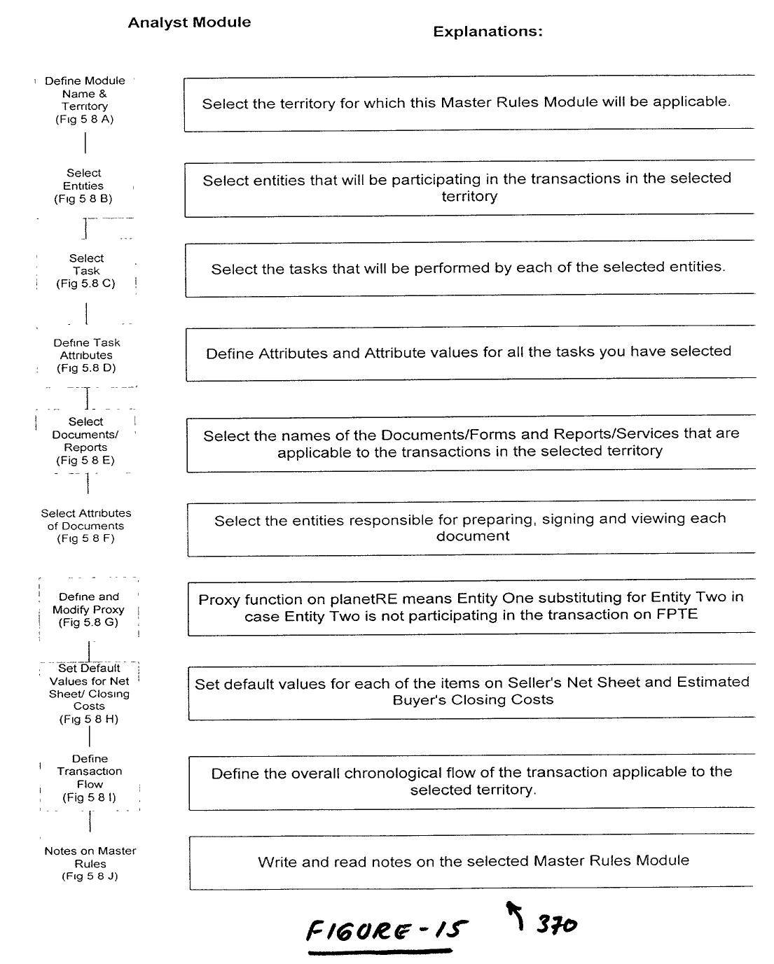

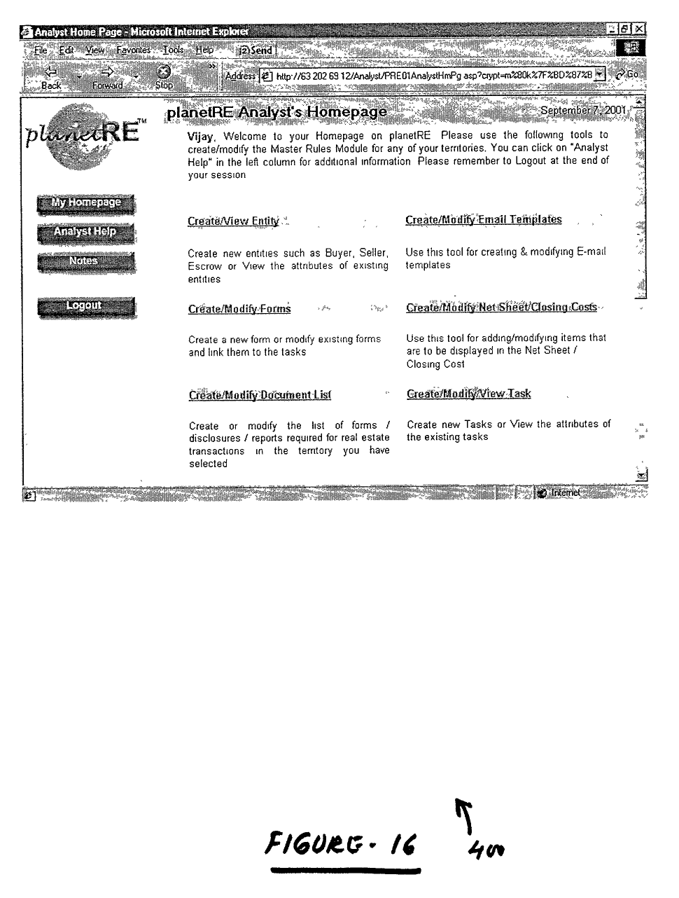

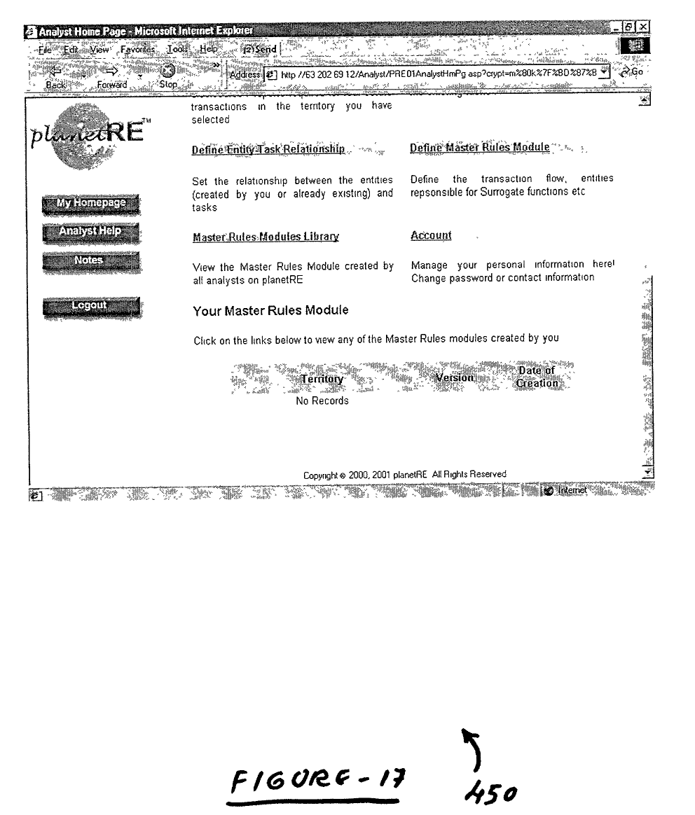

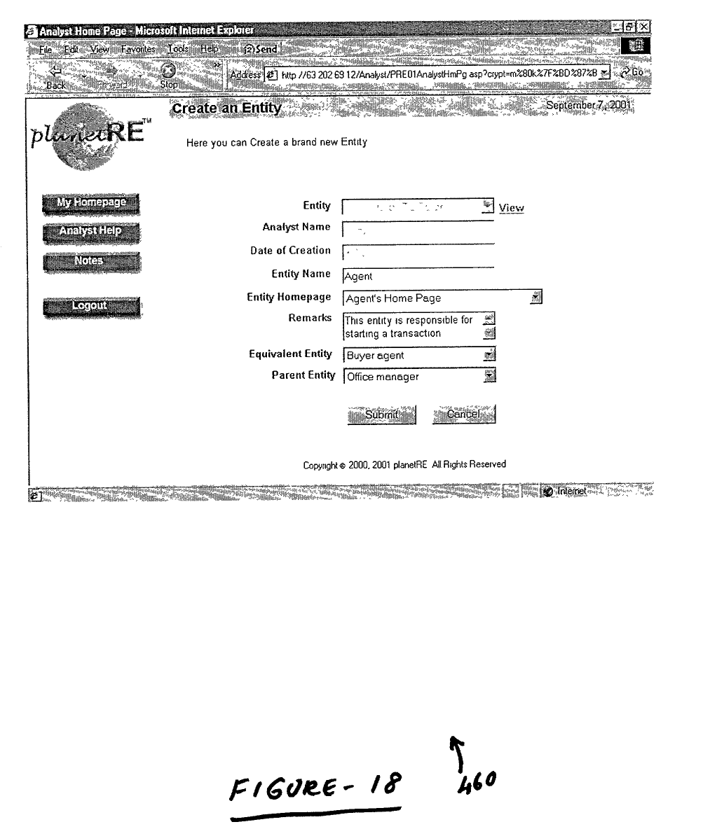

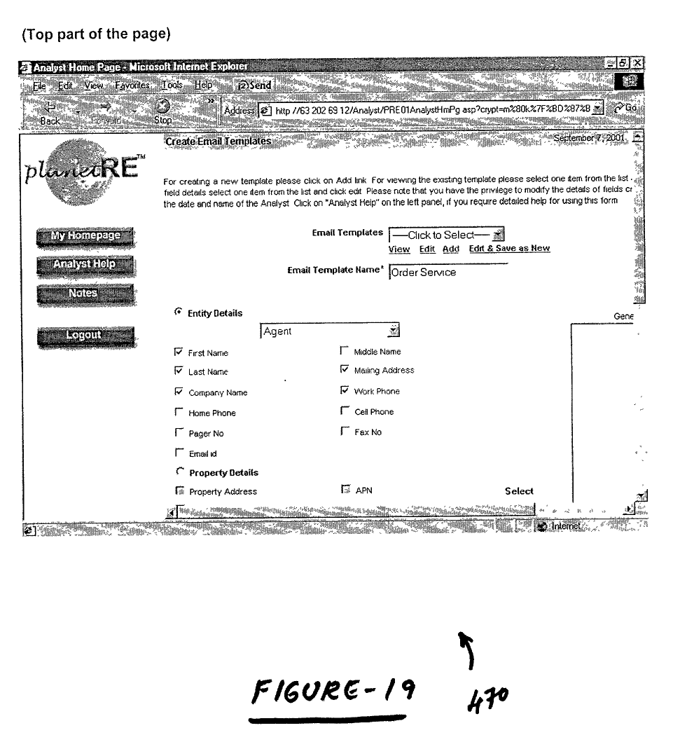

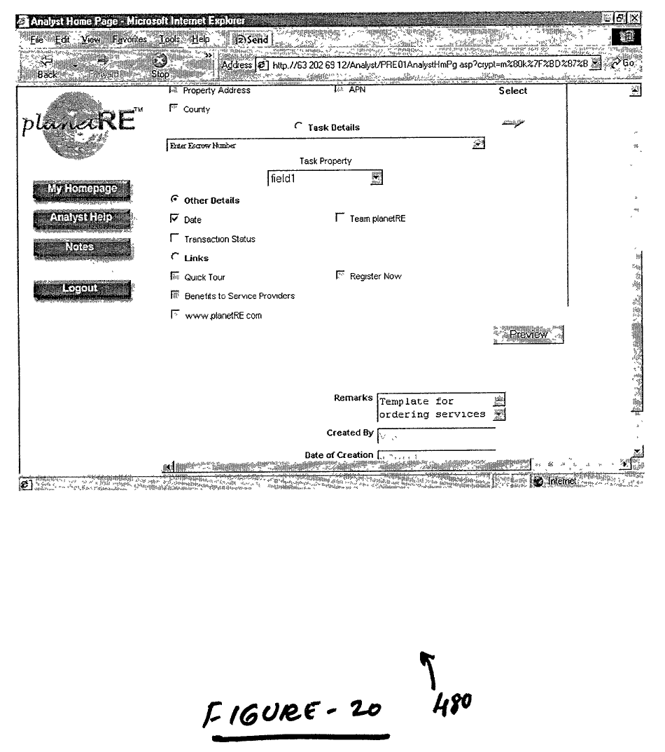

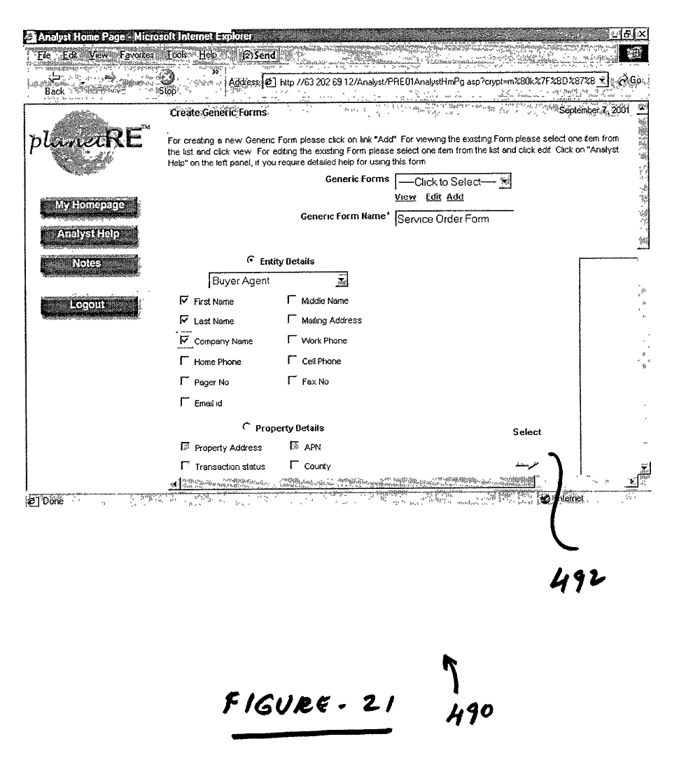

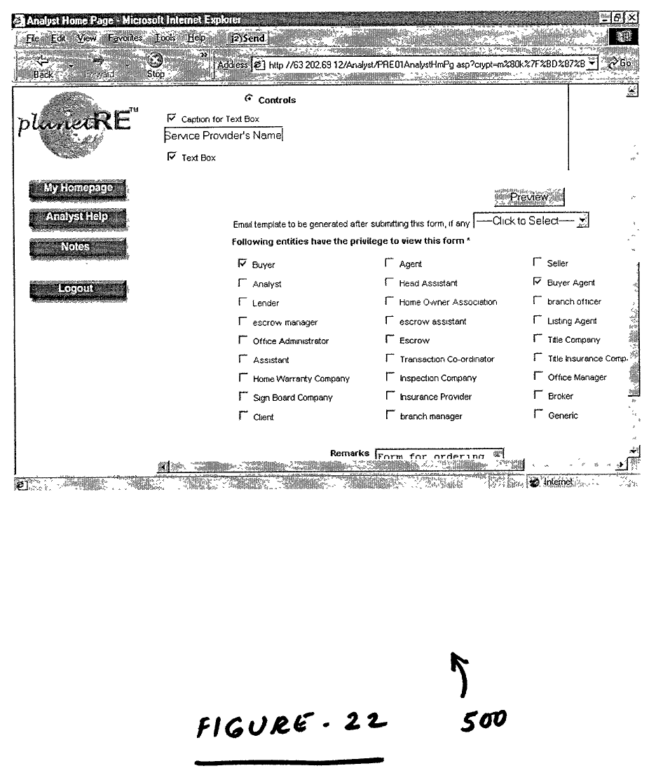

FIG. 22 is an exemplary embodiment of a continuation user interface 500 displaying the bottom part of user interface 490.

FIG. 23 is an exemplary embodiment of a Create/Modify Net Sheet/Closing Costs user interface 510. Through user interface 510, the analyst creates the items that comprise the closing costs estimates. The closing costs estimates are prepared for buyers and sellers in the transaction. Each item is designated as an expense or a credit, based on which, the system calculates the closing costs. Text entered in the “Customer Help Text” 512 is seen by the end user by clicking on the item's hyperlink.

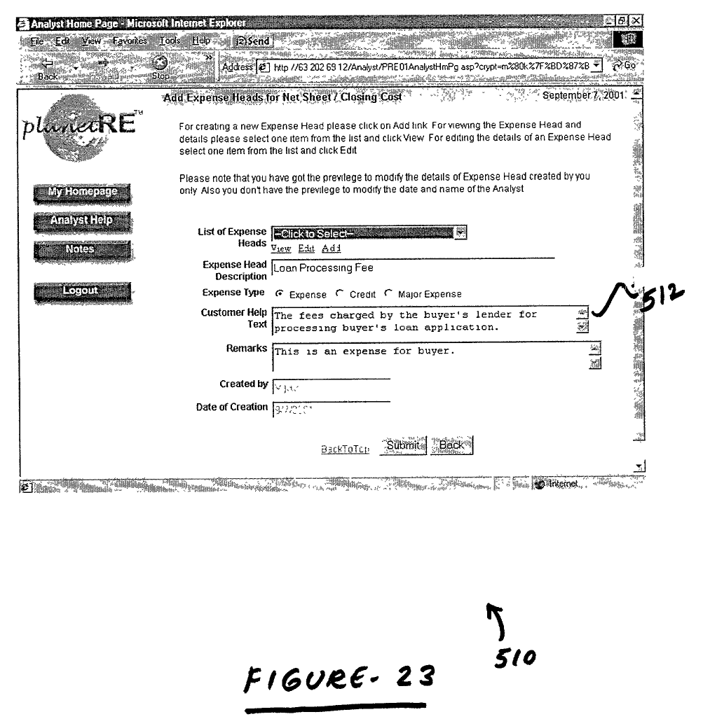

FIG. 24 is an exemplary embodiment of a Create/Modify Document List user interface 520. Through user interface 520, the analyst creates various names of documents that are being used in the transactions. The analyst further designates if the document is a “Form” or a “Report.” Based on the designation of the document, the document is managed differently for the end user. User interface 520 further allows the analyst to view or edit the existing document names.

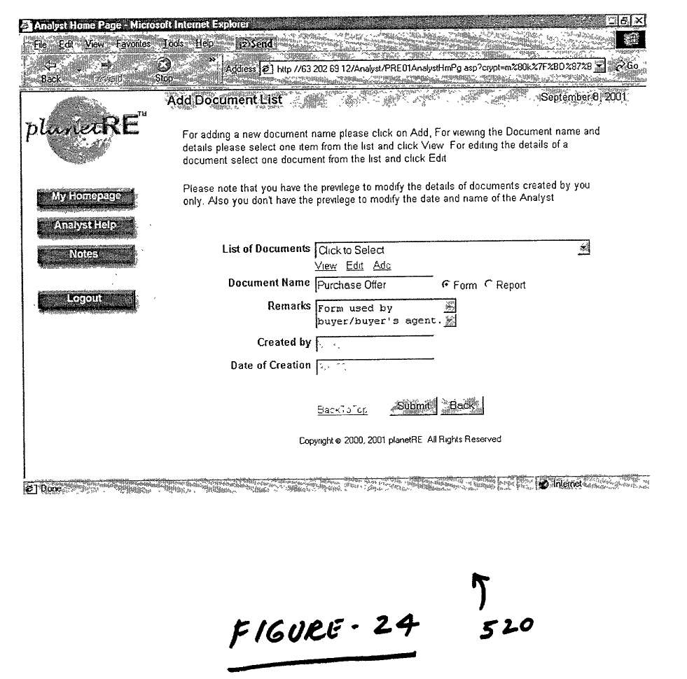

FIG. 25 is an exemplary embodiment of a Create/Modify/View Task user interface 530. Through user interface 530, the analyst defines various attributes of each task. The attributes, in turn, determine the task behavior or user experience with the task. For example, depending on what is selected under the attributes Email, Recipient and carbon copies for distribution, an email is generated upon completion of the task. Depending upon what is selected/entered in the attributes Parent Task, Post Parent Task and Hours After Parent Task, “when” this task is to be scheduled is defined.

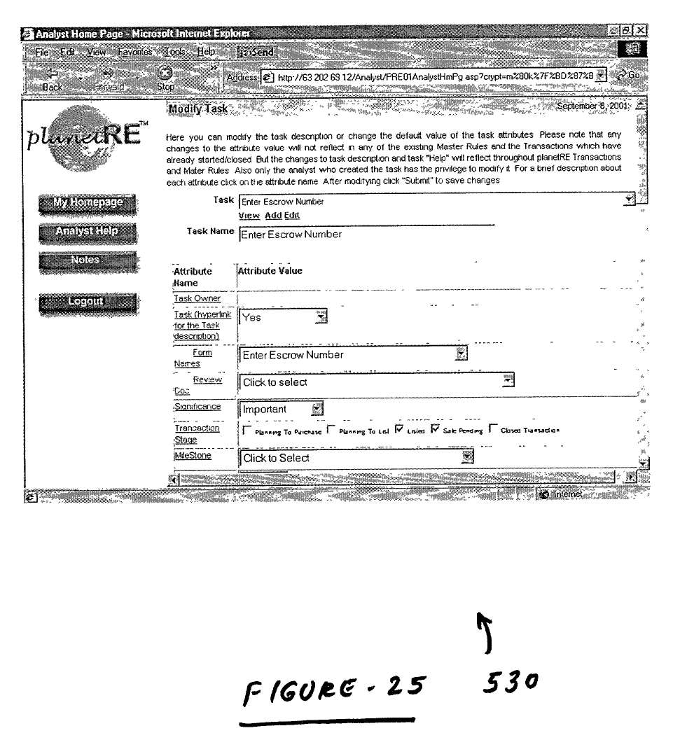

FIG. 26 is an exemplary embodiment of a continuation user interface 540 displaying the middle portion of user interface 530.

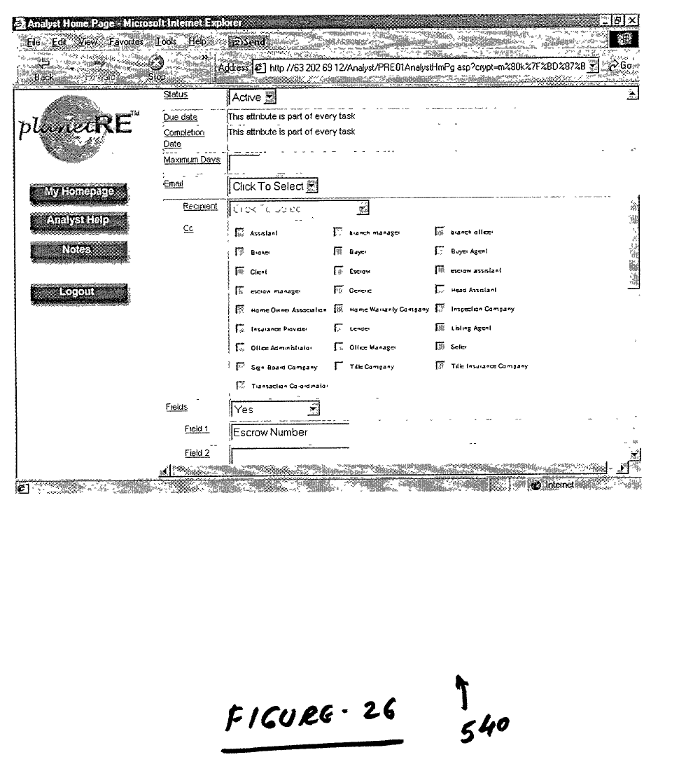

FIG. 27 is an exemplary embodiment of a continuation user interface 550 displaying the bottom part of user interface 530.

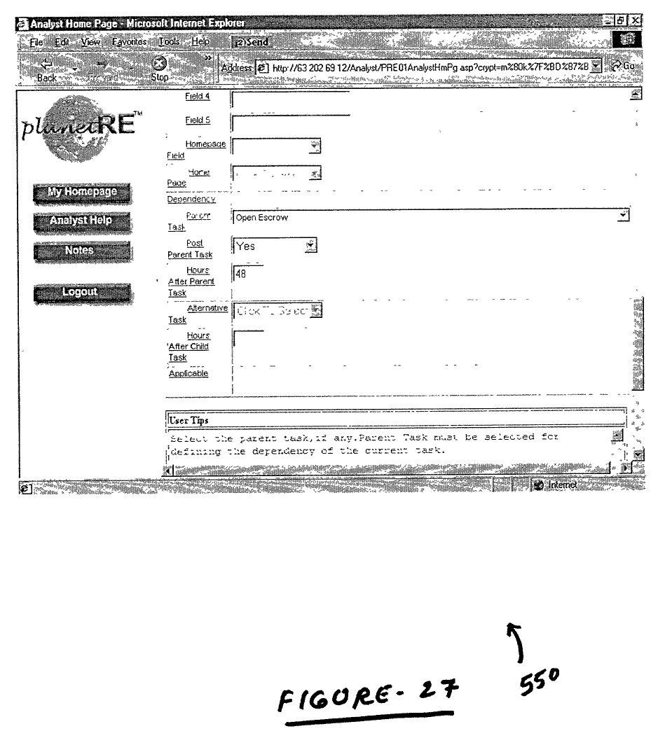

FIG. 28 is an exemplary embodiment of a Define Entity/Task Relationship user interface 560. Through user interface 560, the analyst establishes a relationship between tasks and entities by selecting the tasks to be performed by each entity.

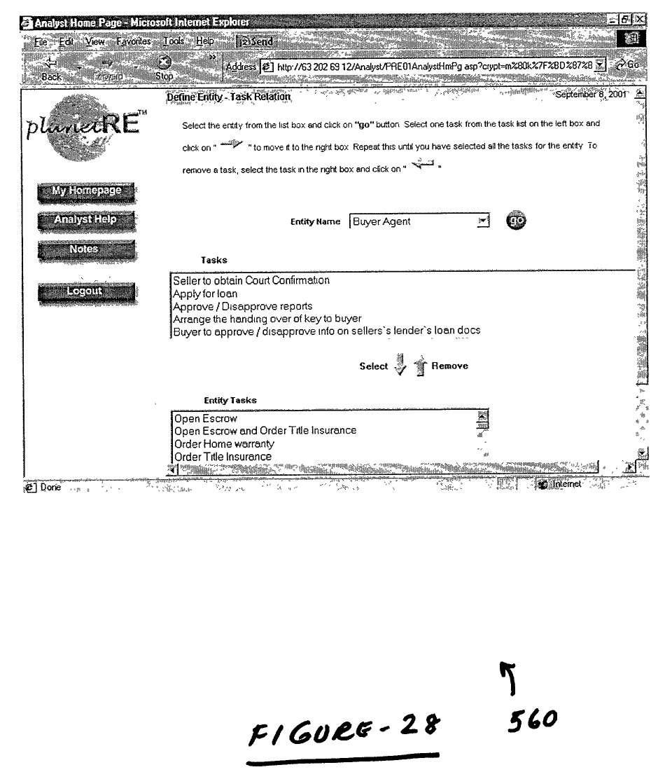

FIG. 29 is an exemplary embodiment of a Define Master Rules Module user interface 570. The attributes that are created or defined through user interfaces, displayed in FIGS. 18 through 28, are integrated together in a module that defines how the transactions will be conducted by the end users. User interface 570 helps identify the parameters and guidelines in conducting the transaction by defining the Master Rules Module. User interface 570 displays various hypertext links including, but not limited to, Define Module Name & Territory, Select Entity, Select Task, Define Task Attributes, Select Document Reports, Set Attributes Documents, Define & Modify Proxy, Define Value Net Sheet/Closing Costs, and Define Transaction Flow.

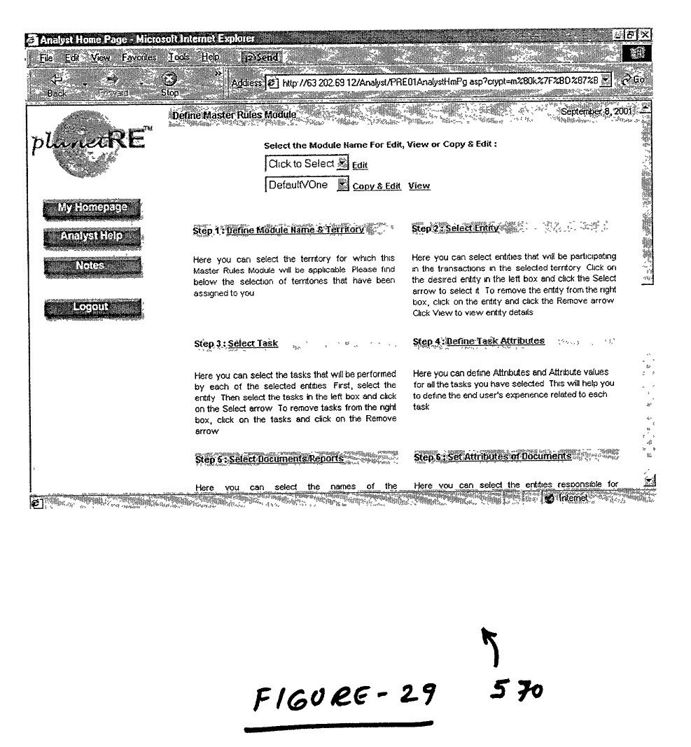

FIG. 30 is an exemplary embodiment of a continuation user interface 580 displaying the bottom part of user interface 570.

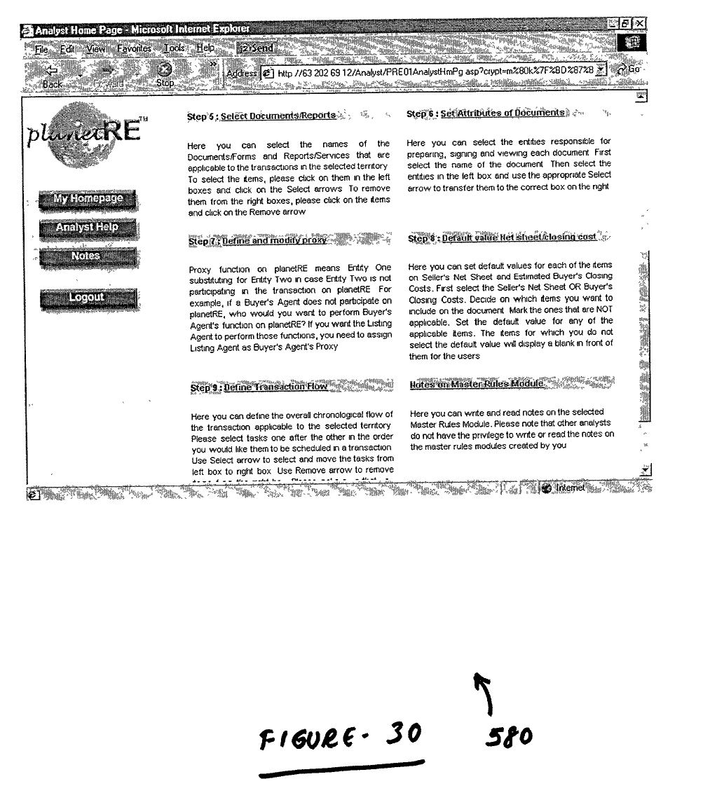

FIG. 31 is an exemplary embodiment of a Master Rules Module Library user interface 590. Through user interface 590, the analysts can access and view Master Rules Modules created by all the analysts on FPTS 40.

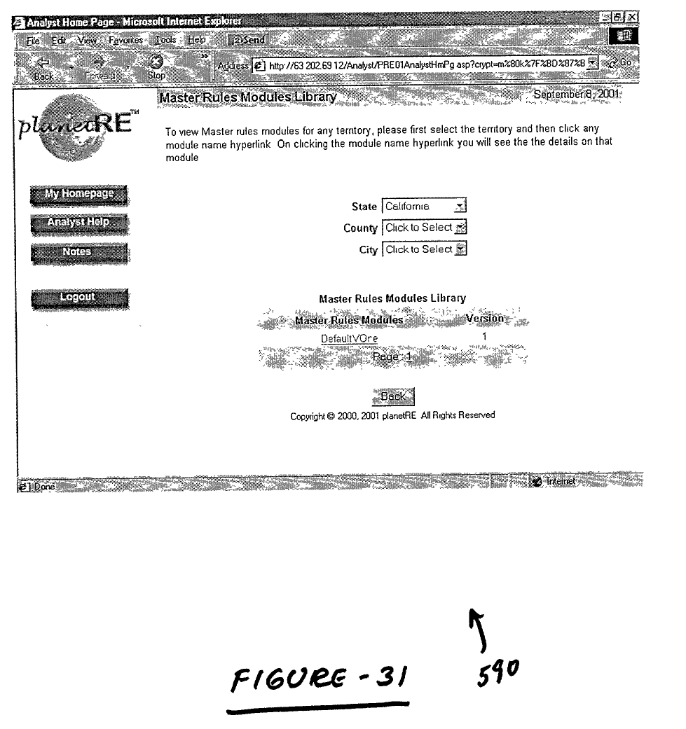

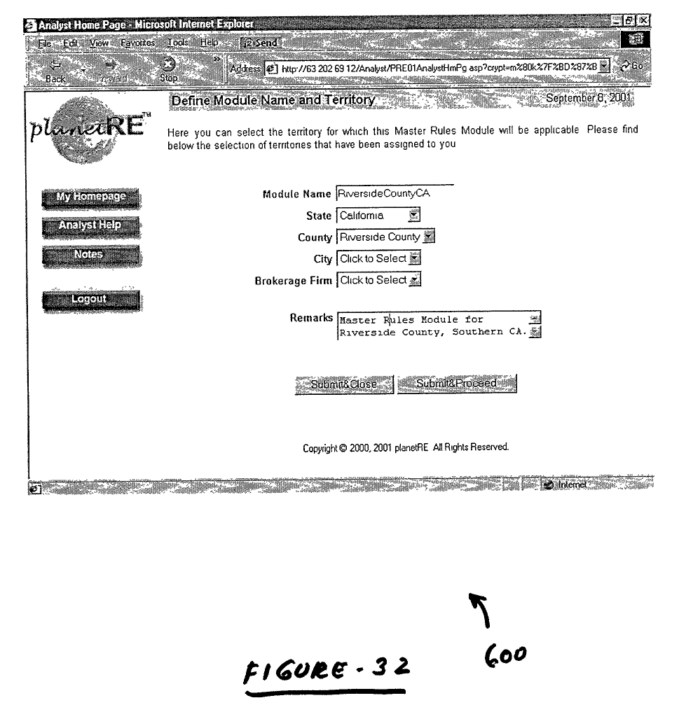

FIG. 32 is an exemplary embodiment of a Define Module Name and Territory user interface 600. Through user interface 600, the analyst identifies the territory for which this particular Master Rules Module is applicable. For example, in the real estate industry the territory can be defined as country, state/province, county, city, zip code or by the brokerage firm. Based on the selected territory, the module defined here is applicable to the transactions conducted in that territory.

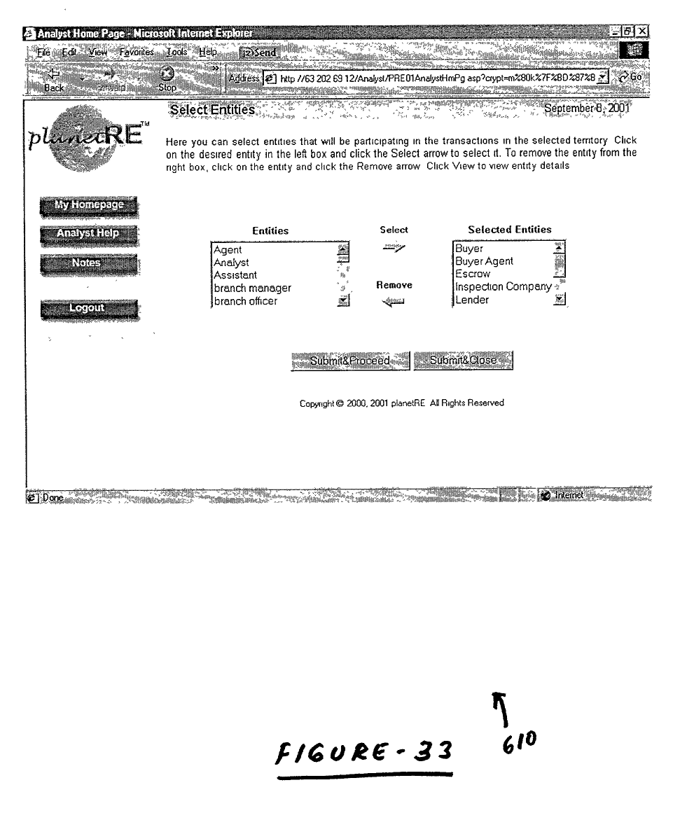

FIG. 33 is an exemplary embodiment of a Select Entities user interface 610. Through user interface 610, the analyst selects the entities participating in the transactions in the selected territory.

FIG. 34 is an exemplary embodiment of a Select Tasks user interface 620. Through user interface 620, the analyst selects entities, one by one, and designates the tasks to be performed by that entity in the transactions in the selected territory. Out of all the designated tasks, which tasks actually get assigned to an entity is dynamically determined by FPTS 40 based on contract input, user input, entity interaction and events happening during the transaction.

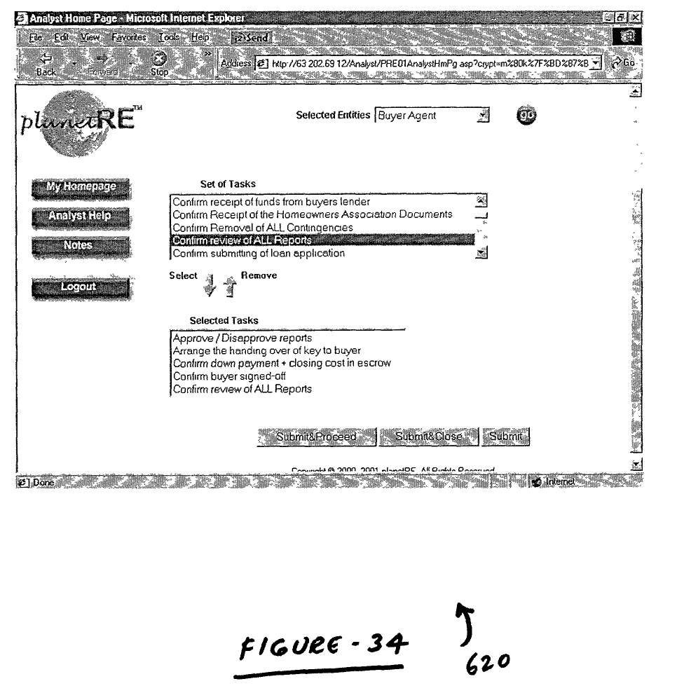

FIG. 35 is an exemplary embodiment of a Define Task Attributes user interface 630. Through user interface 630, the analyst further defines the attributes of each selected task to determine the precise task behavior or user experience with the task for the selected Territory.

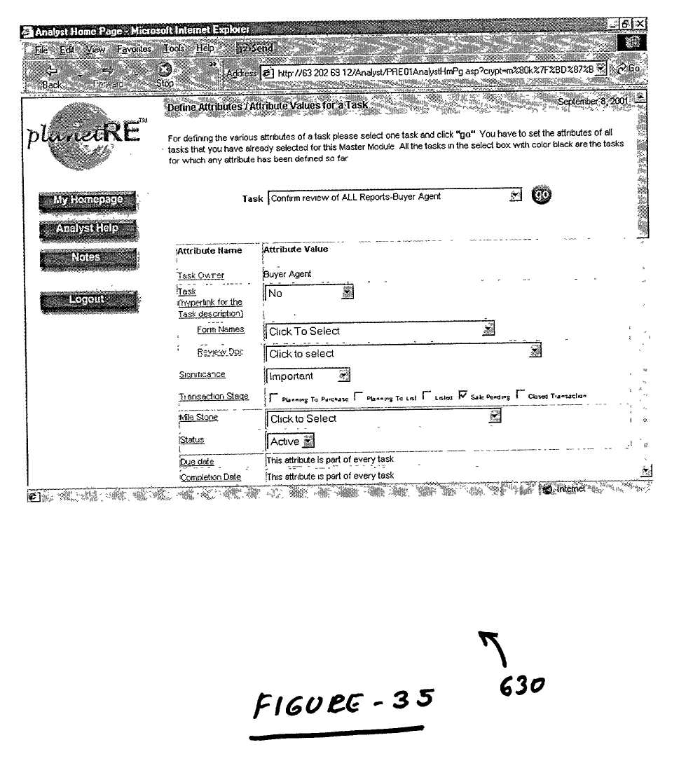

FIG. 36 is an exemplary embodiment of a continuation user interface 640 displaying the bottom part of user interface 630.

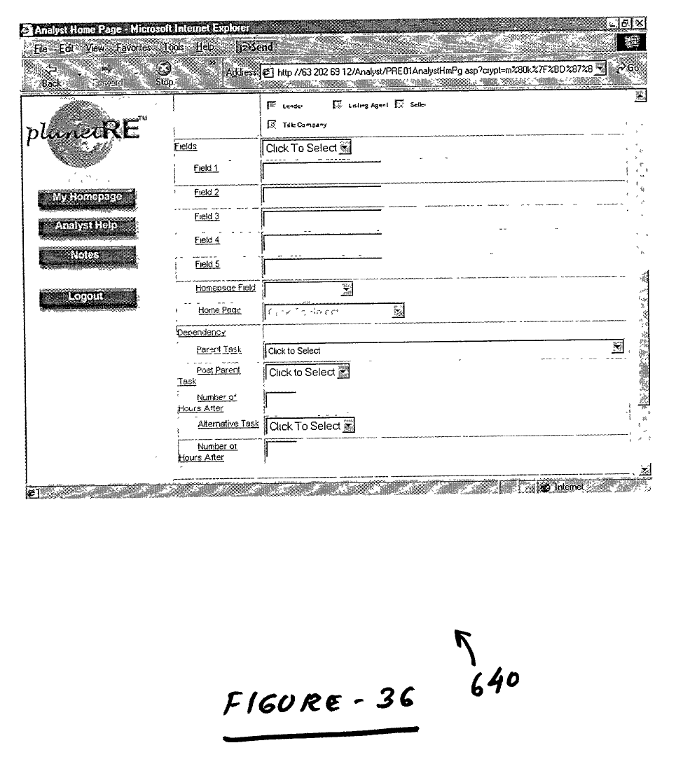

FIG. 37 is an exemplary embodiment of a Select Documents/Reports user interface 650. Through user interface 650, the analyst selects the documents that are used in the transactions in the selected territory. The user can modify the document list by deleting documents or adding documents.

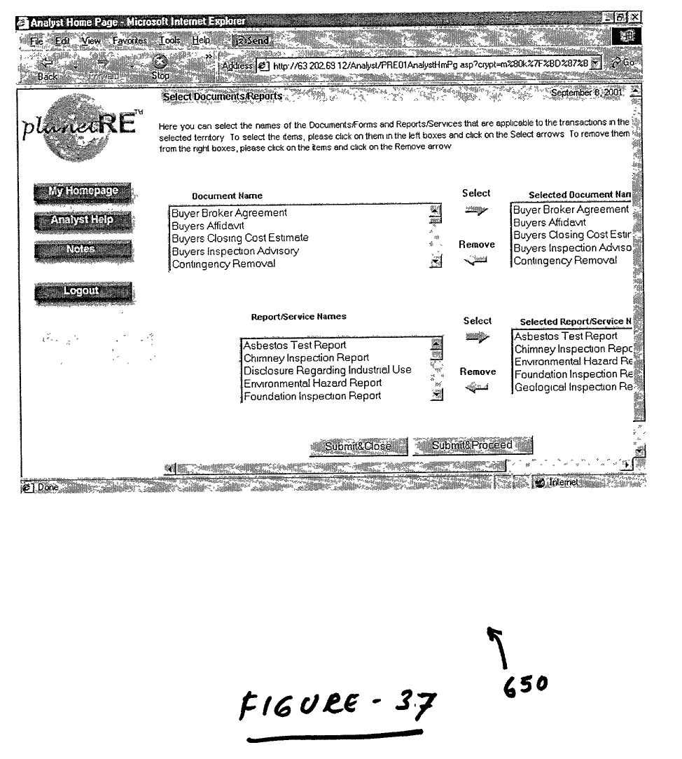

FIG. 38 is an exemplary embodiment of a Select Attributes of Documents user interface 660. Through user interface 660, the analyst sets attributes of selected documents. The analyst selects the entities that are responsible for preparing the document, signing the document and viewing the document during the transactions in the selected territory.

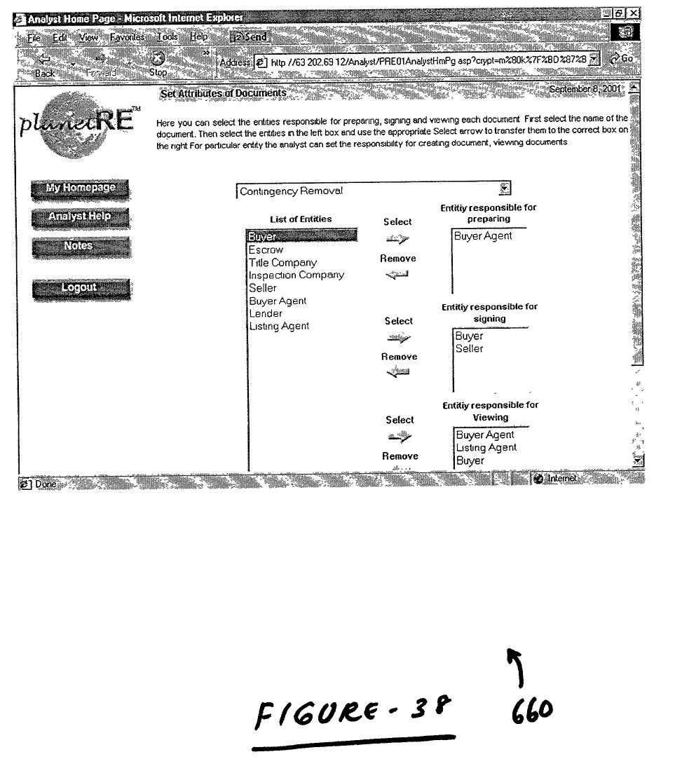

FIG. 39 is an exemplary embodiment of a Define/Modify Proxy user interface 670. User interface 670 permits the analyst to define and/or modify the proxy function. Proxy function means substituting entity 1 for entity 2, in case entity 2 is not participating in the transaction on the system. When entity 1 is the proxy for entity 2, entity 1 cannot actually perform entity 2's tasks, but can only mark them done.

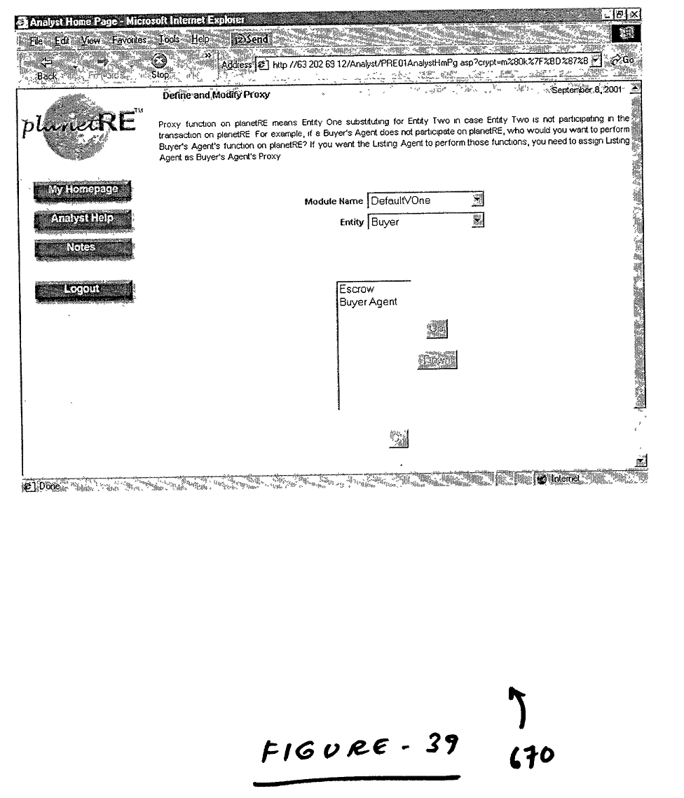

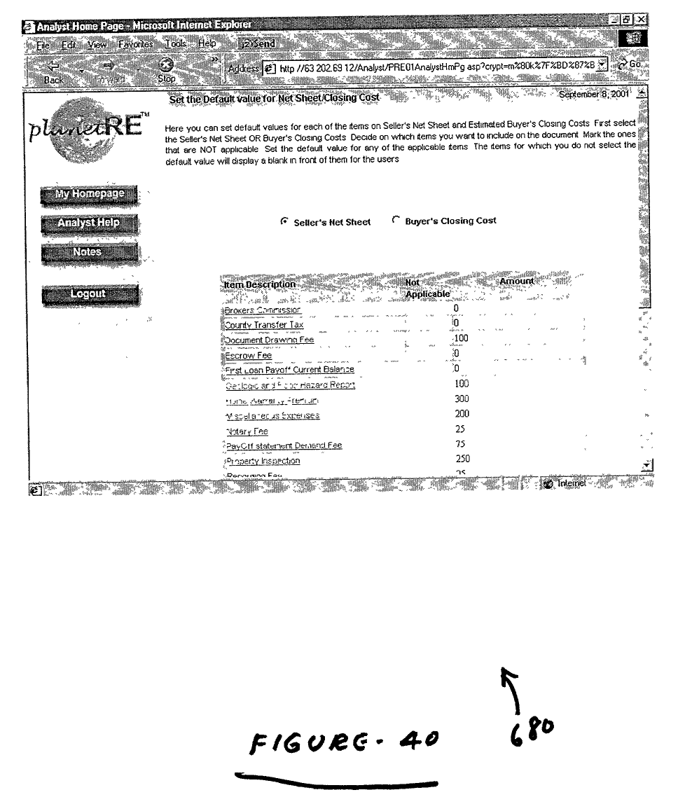

FIG. 40 is an exemplary embodiment of a Set Default Values user interface 680. Through user interface 680, the analyst selects the items that are applicable to the closing costs estimates prepared for sellers and buyers in the transactions for the selected territory. For each item, the analyst assigns a default value that is populated for the end user. The end user can change the value before calculating the closing costs.

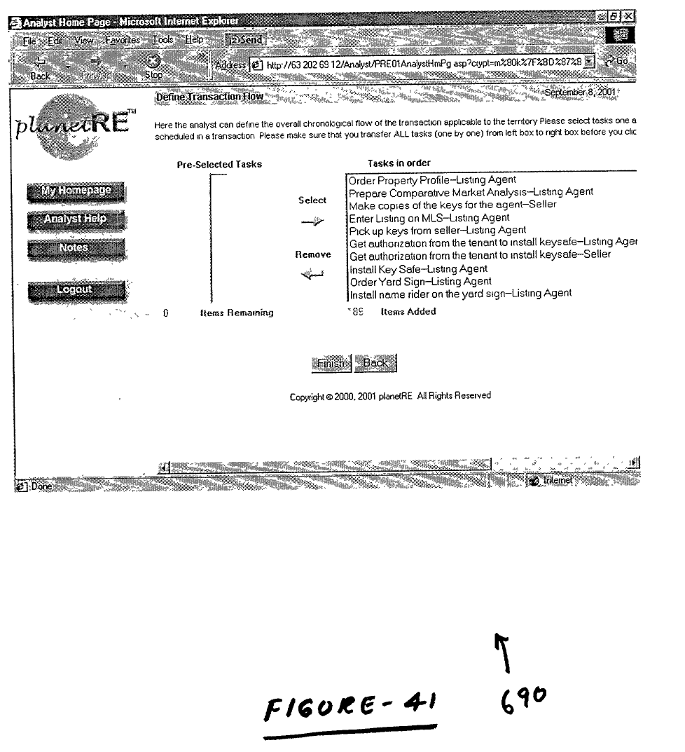

FIG. 41 is an exemplary embodiment of a Define Transaction Flow user interface 690. Through user interface 690, the analyst defines the overall flow of the tasks in the transactions in the selected territory. However, the actual sequencing of the tasks in a particular transaction is ultimately determined by the chronology (due dates) of the tasks determined dynamically by the system based on the contract input, user input, entity interaction and events taking place during the transaction.

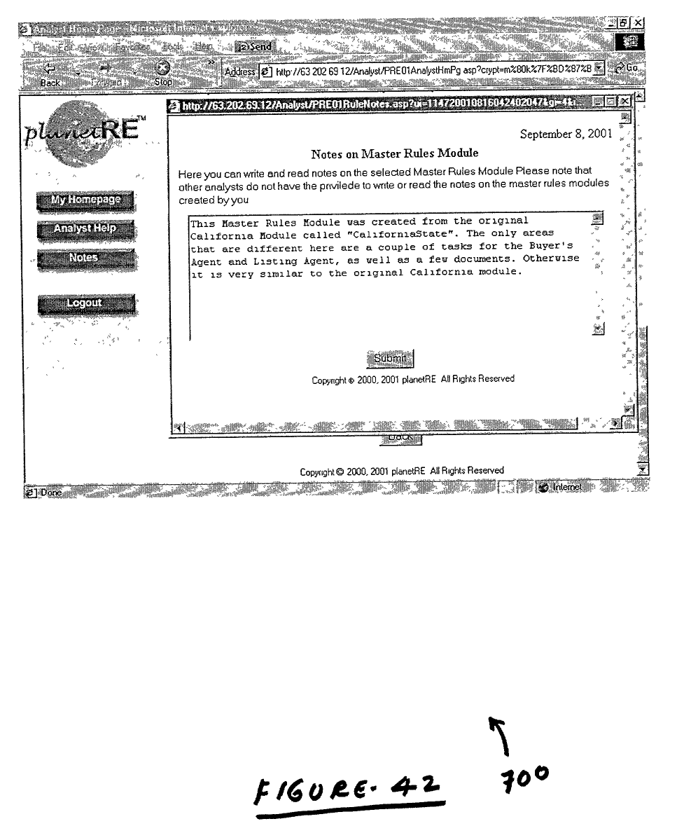

FIG. 42 is an exemplary embodiment of a Notes on Master Rules Module user interface 700. Through user interface 700, the analyst maintains notes on the specific Master Rules Module for his/her own reference, as well as for the reference of other analysts.

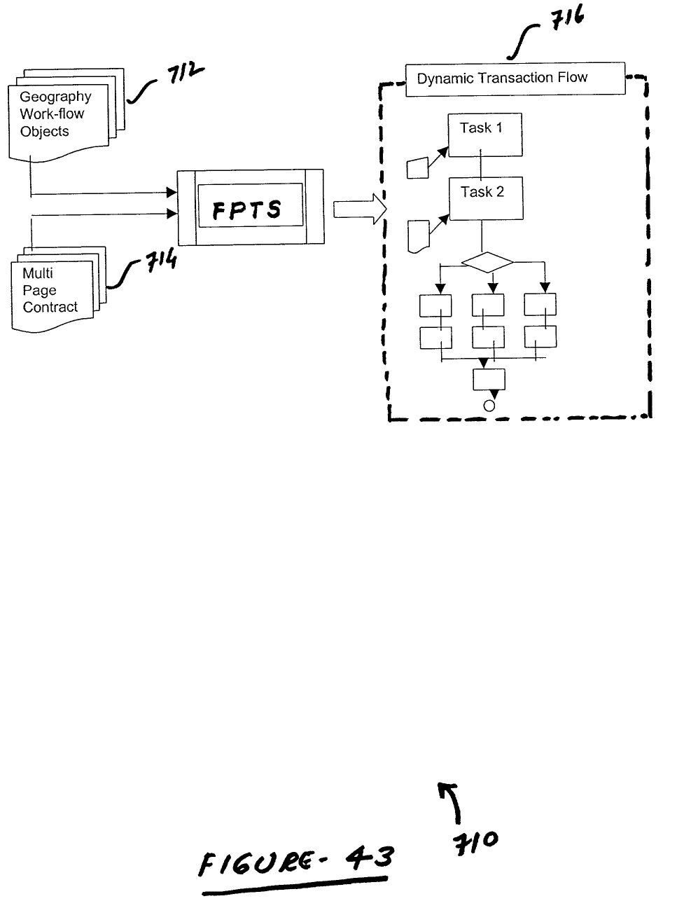

FIG. 43 is an exemplary embodiment of a flow chart 710 identifying the process of creating the dynamic transaction flow. Based on the geography of work flow objects 712 and the terms and conditions established by the contracts 714, the FPTS determines transaction flow 716 dynamically. FPTS 40 also determines individual sub-tasks and sequence of events, and assigns projected completion dates based on other related events.

### III. User Interfaces Depicting User Experience in Real Estate Field

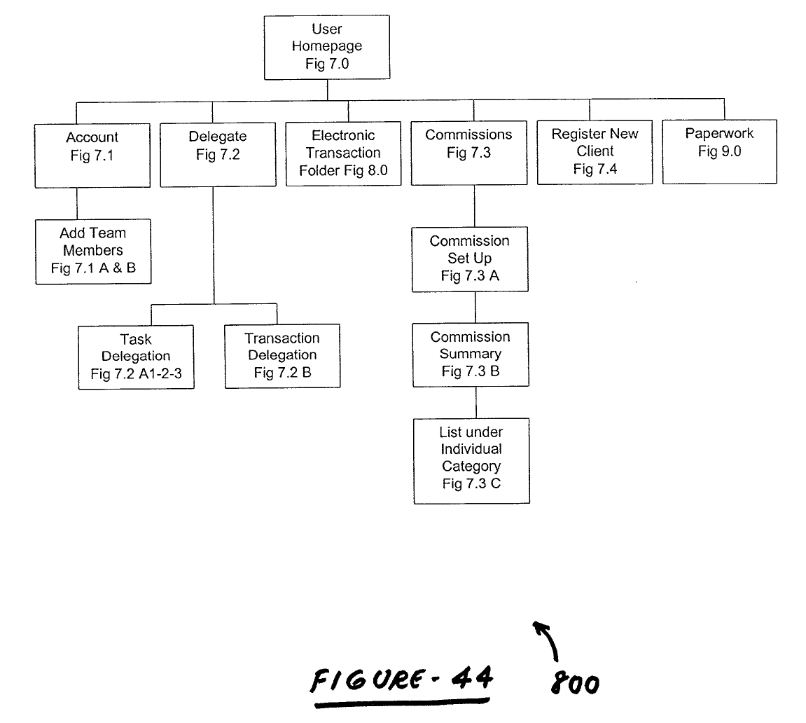

FIGS. 44 through 78 are exemplary embodiments of screen displays pertaining to real estate judiciary created by FPTS 40. These various embodiments describe one specific way of practicing the invention, configuring the needs of the business entity specializing in the real estate industry, displaying data or printing reports. However, one skilled in the art would recognize that there are multiple possible combinations of organizing the data, displaying the data on the screen as well as printing the data in various reporting formats, which still express the same essential matter and process steps.

FIG. 44 is an exemplary embodiment of a flow chart 800 identifying the process steps relating to user experience pertaining to a real estate transaction involving real estate brokers and agents. In an exemplary embodiment, FPTS 40 allows the buyer and the seller or the lessee and the lessor to conduct the entire real estate transaction without the involvement of any real estate broker and agent. In yet another exemplary embodiment, such a real estate transaction is conducted with the aid of an experienced broker or the agent.

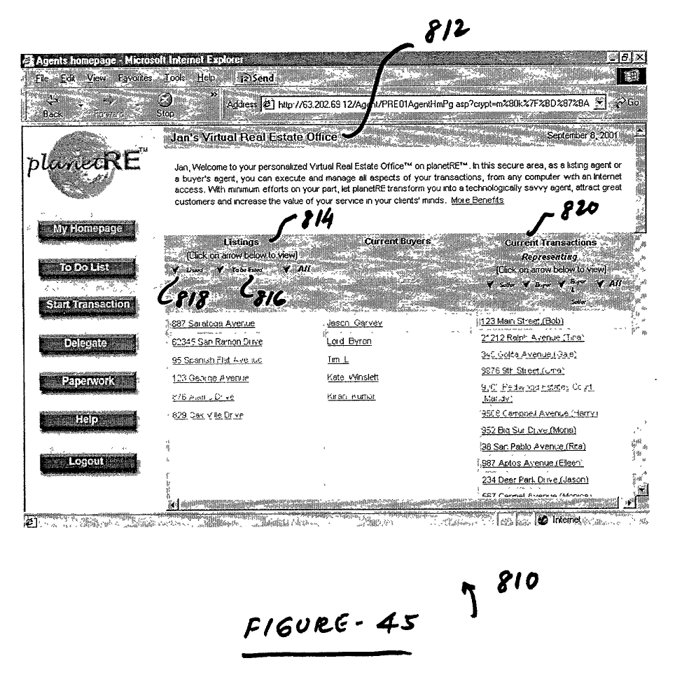

FIG. 45 is an exemplary embodiment of a Home page user interface 810 specifically adopted to the user utilizing FPTS 40 in the real estate environment. User interface 810 is downloaded and displayed by server system 42 when the user has registered to use the system. User interface 810 is customized for a specific user 812 to meet the user's specific needs. User interface 810 displays all of the transactions registered by the user. Each hypertext link opens up the Electronic Transaction Folder for a specific transaction. The transactions are categorized mainly based on the status of transaction. For example, a “Listings” category 814 shows the properties on which the user plans to take a listing 816 and those on which the user has already taken a listing 818. The transactions can be further sorted by the user by using the sorting arrows to view transactions under each sub-category. For example, the user can select on “Listed” under “Listings” to view the list of properties on which the user has already taken a listing. When the status of the transactions is changed by the user, the transaction hyperlinks are automatically moved to the new category by FPTS 40. For example, when the user changes status of a “Listed” property to “Sale Pending,” the hyperlink for that transaction folder is moved from “Listings” 814 to “Current Transactions” 820.

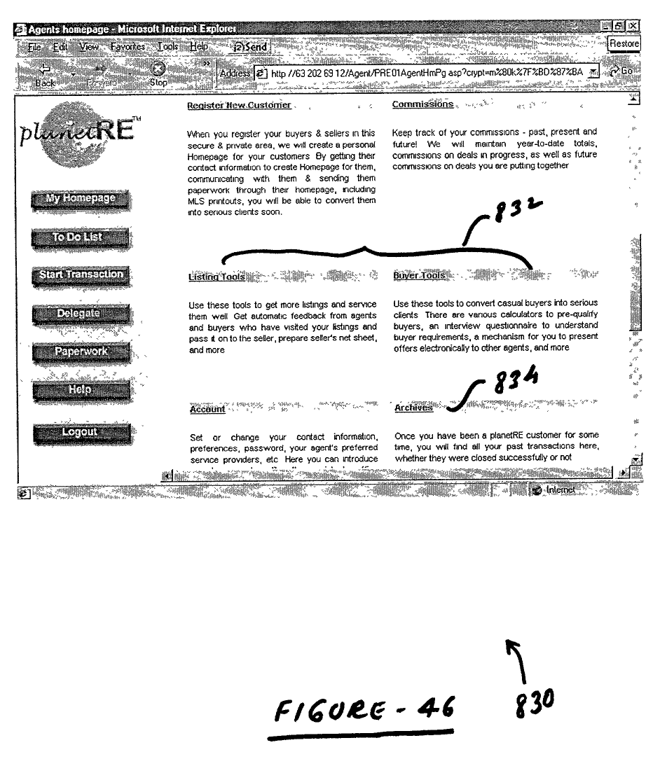

FIG. 46 is an exemplary embodiment of a continuation user interface 830 displaying the middle portion of home page user interface 810. User interface 830 displays various tools 832 available to the user. The old registered transactions are stored under archives 834.

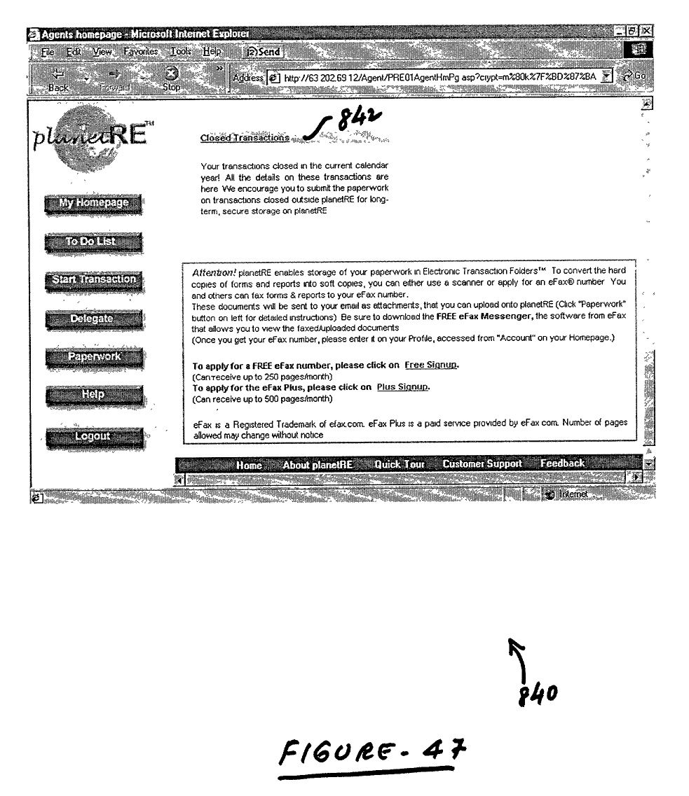

FIG. 47 is an exemplary embodiment of a continuation user interface 840 displaying the bottom portion of home page user interface 810. User interface 840 displays closed transactions under a Close Transactions hypertext link 842. In an exemplary embodiment, the closed transactions folder stores the user's transactions that successfully closed during the current calendar year.

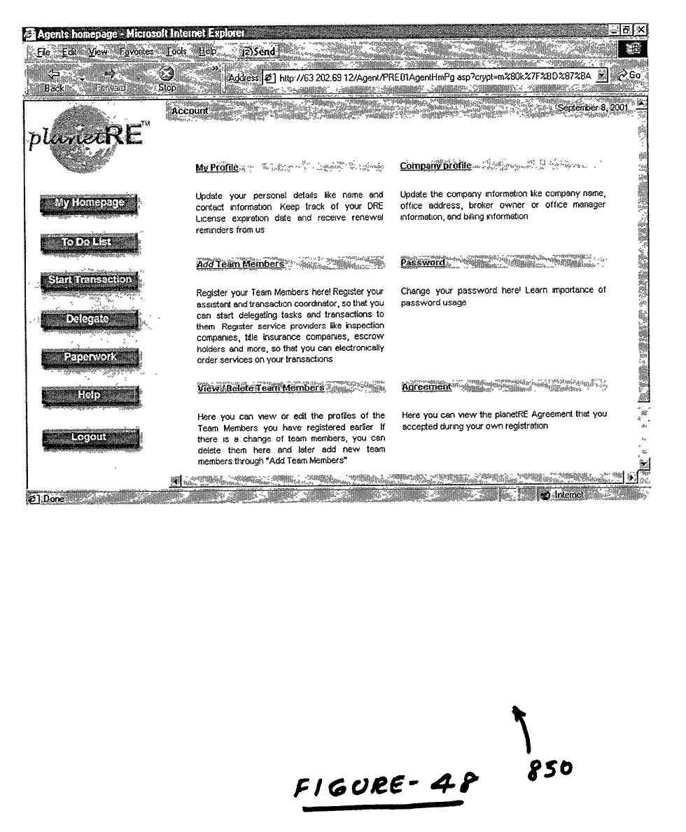

FIG. 48 is an exemplary embodiment of an Account user interface 850 specifically adopted to the user utilizing FPTS 40 in the real estate environment. User interface 850 enables the user to view/edit profiles, change password, add team members, as well as view/delete existing team members.

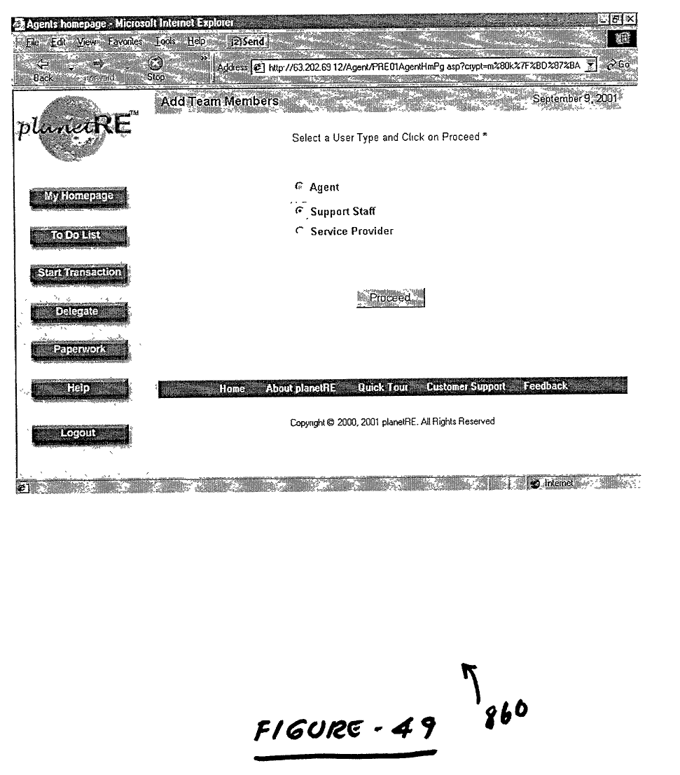

FIG. 49 is an exemplary embodiment of an Add Team Members user interface 860. User interface 860 permits the user, based on the user's privileges, to add other users as team members. In an exemplary embodiment, the agent can add support staff and service provider, but cannot add another agent. The agent can be added only by the broker.

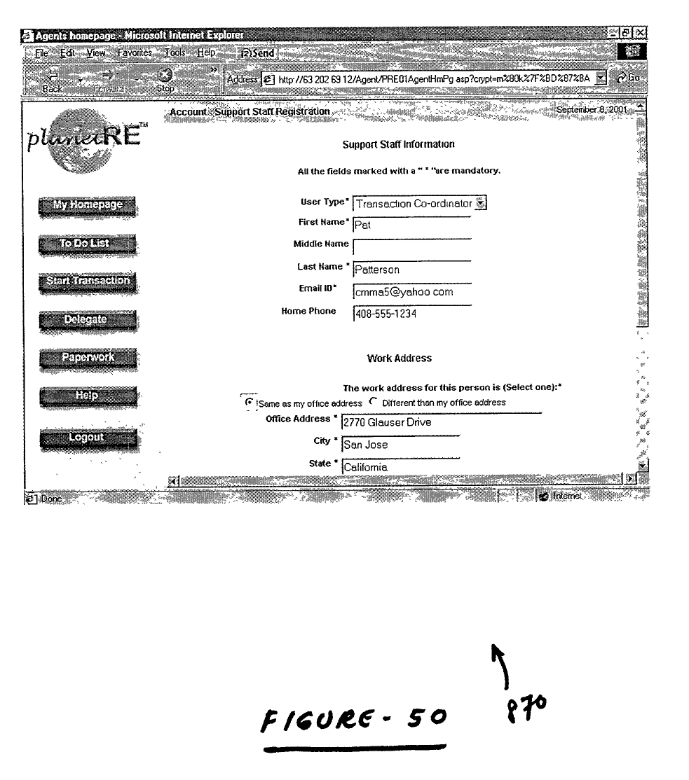

FIG. 50 is an exemplary embodiment of an Account/Support Staff user interface 870. User interface 870 allows the user to fill out basic information pertaining to the team member. An email is generated and sent to the team members with a login ID and a Password to access his/her own Homepage.

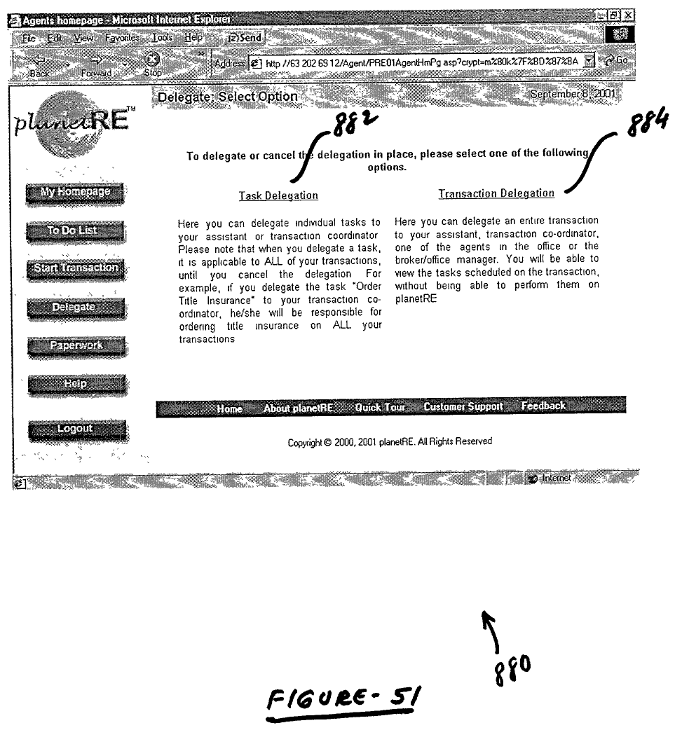

FIG. 51 is an exemplary embodiment of a Delegate user interface 880. Through user interface 880, the agent delegates a few tasks through a task delegation hypertext link 882 or whole transaction(s) through a transactions delegation hypertext link 884 to any of the support staff.

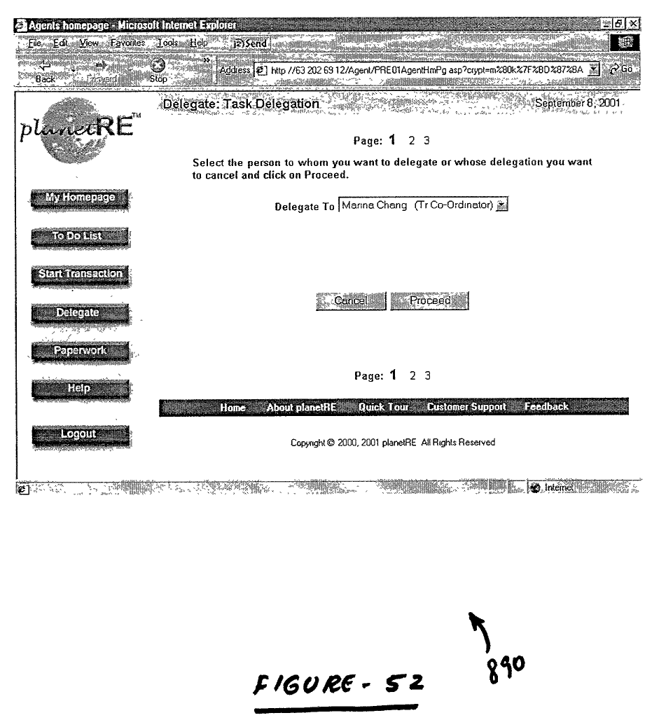

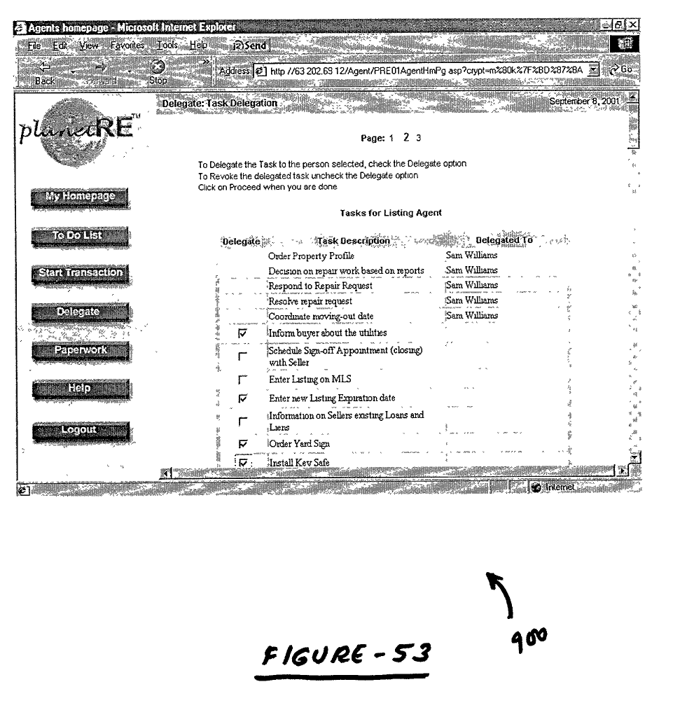

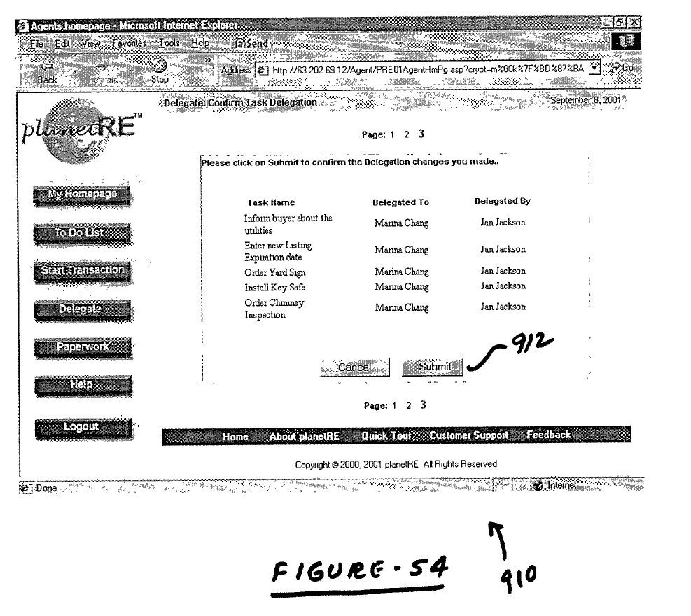

FIGS. 52 through 54 are exemplary embodiments of task delegation user interfaces. Through a first page 890 (shown in FIG. 52) of the task delegation user interface, the user first selects the person to whom the task(s) are to be delegated or whose existing delegation needs to be revoked. Then, through a second page 900 (shown in FIG. 53) of the task delegation user interface, the user selects the tasks to be delegated or the tasks that are to be done by the selected person. Delegation of any tasks previously delegated to other personnel needs to be revoked before the tasks are delegated to another person. Through a third page 910 (shown in FIG. 54) of the task delegation user interface, the user confirms the task transaction. All the tasks selected for delegation appear on the confirmation page. Upon clicking a Submit button 912, the selected tasks on each transaction registered by the user (person delegating) are delegated to the selected person. Only the person to whom the tasks are delegated can perform those tasks from his/her own electronic Transaction Folder. The person delegating the tasks can view the status of the tasks from his/her own Transaction Folder. The person delegating the tasks can revoke the delegation and take over the responsibility of performing those tasks at any time. When the delegation is revoked, the person to whom the tasks were delegated is informed about the revocation through an email.

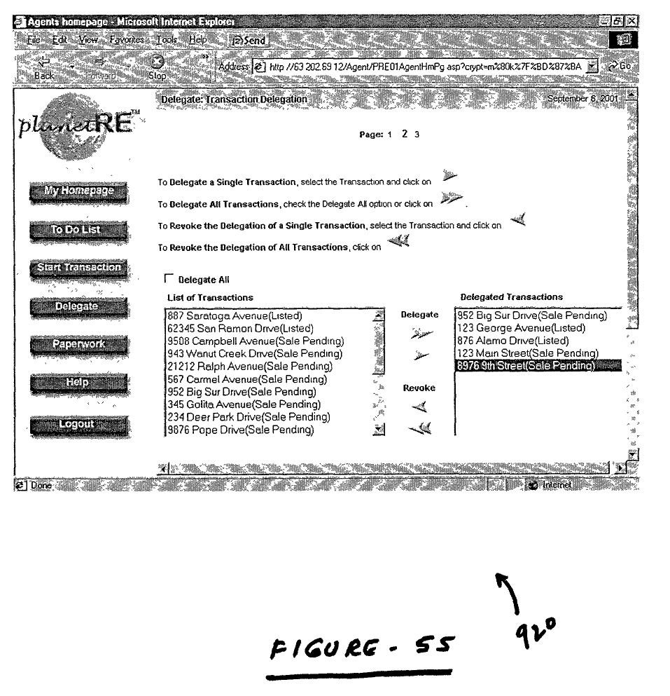

FIG. 55 is an exemplary embodiment of a Transaction Delegation user interface 920. Through user interface 920, the user can delegate the entire transaction(s) to another person. Once the entire transaction is delegated, only the person to whom the transaction is delegated can perform all the tasks that originally belonged to the delegating person. The person delegating the transaction can view the transaction folder and the status of the tasks, but can not perform the tasks. The person delegating the transaction can revoke the delegation and take over the responsibility to perform the tasks at any time. When the delegation is revoked, the person to whom the transaction was delegated is informed about the revocation through an email.

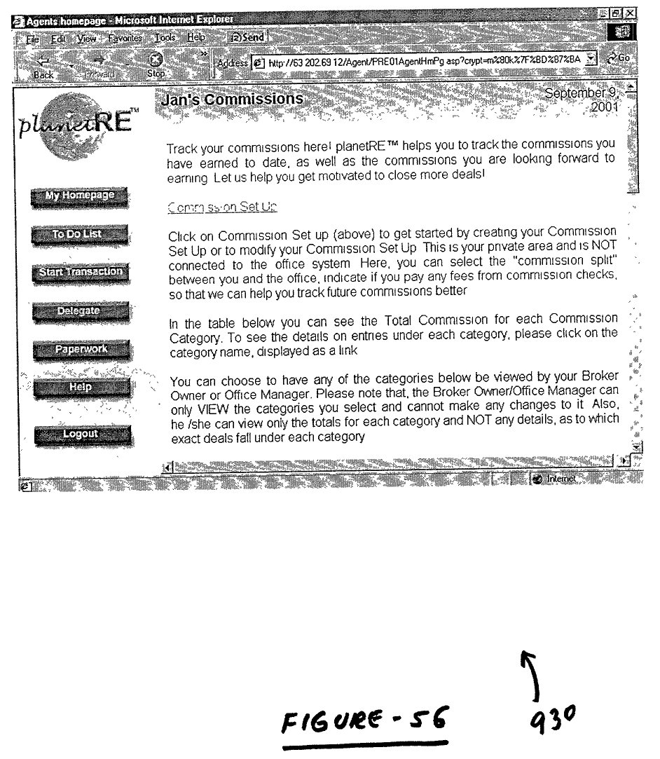

FIG. 56 is an exemplary embodiment of a Commissions user interface 930. Through user interface 930, the user keeps track of his/her own past, present and future commissions. However, in order for FPTS 40 to calculate commissions for the user, the parameters must be set through by the user or the user's superior through a commission set up.

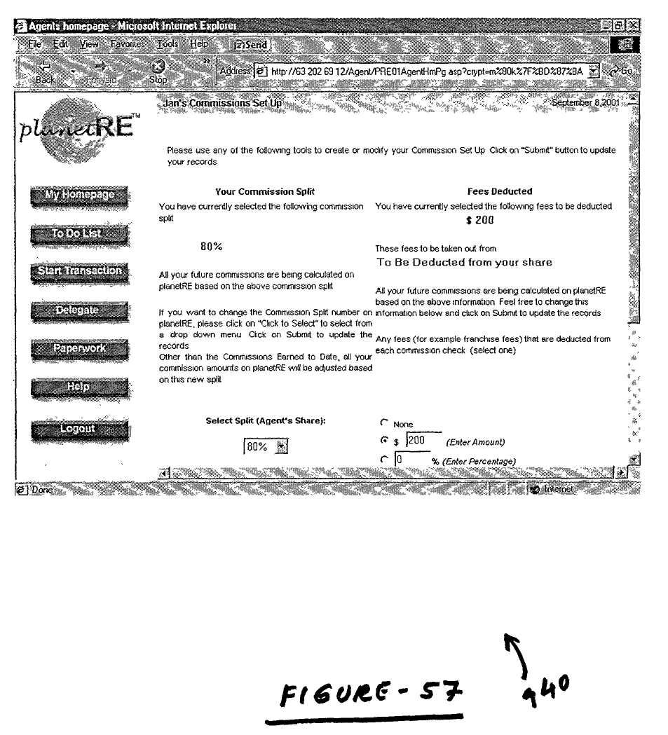

FIG. 57 is an exemplary embodiment of a Commissions Set Up user interface 940. Through user interface 940, the commission is calculated based on the parameters set up on each registered client.

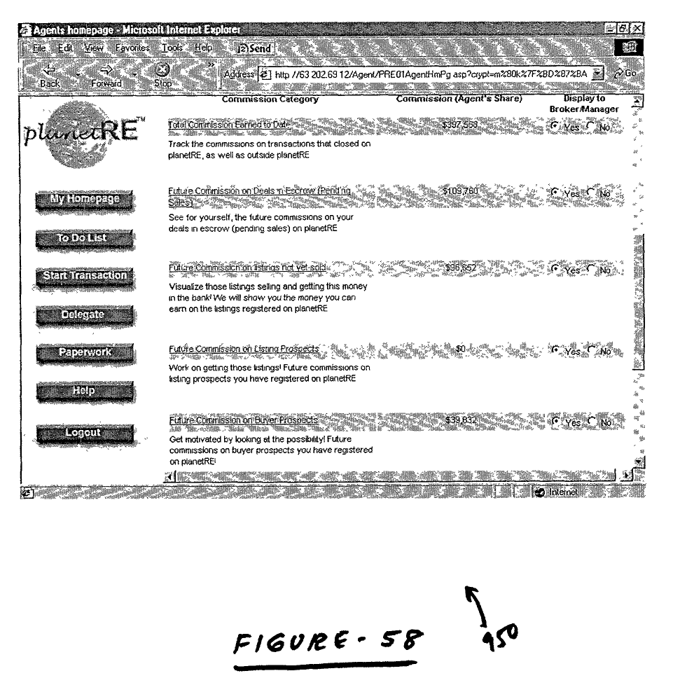

FIG. 58 is an exemplary embodiment of a Commissions Summary user interface 950. User interface 950 displays the commission summary for the current calendar year under 5 separate categories: total commission earned to date, future commission on pending sales, future commission on listings not yet sold, future commission on listing prospects and future commission on buyer prospects. The agent can give privilege to his/her broker owner or office manager to view the cumulative total for each category of the commission.

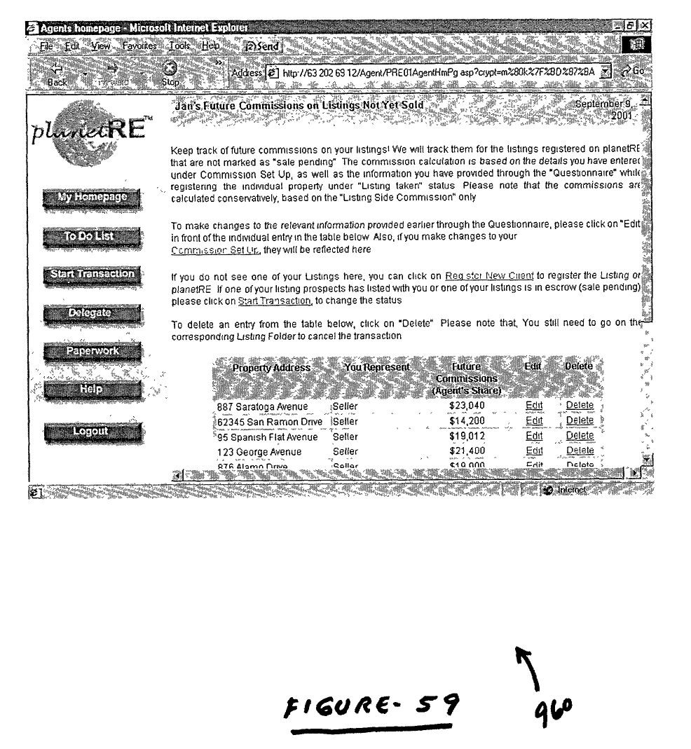

FIG. 59 is an exemplary embodiment of an Individual Category user interface 960. Through user interface 960, the user can select on the individual category appearing as a hyperlink in the commission summary and view the list of transactions comprising the cumulative amount.

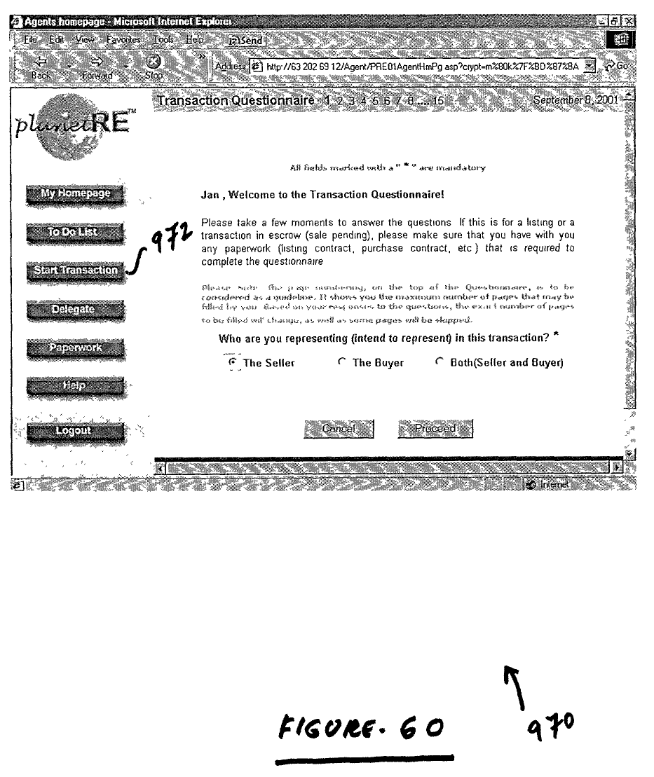

FIG. 60 is an exemplary embodiment of a Transaction Questionnaire user interface 970 downloaded and displayed by the server system when the user has initiated the process to register a new transaction. A new transaction is registered through a hyperlink “Register New Transaction” on user's Homepage or from a “Start Transaction” button 972 accessible from any of the password-protected pages of the user. User interface 970 questionnaire is programmed to minimize the efforts on the user's part. Based on the user input to the questions, the questions on the pages that follow either change or get eliminated. At the end of the questionnaire, the user either uses the entered information to fill the purchase offer form and other related forms and/or submits the information to generate Electronic Transaction Folders for all entities involved in the transaction. As an alternative to filling the questionnaire on the system, the input to the questions could come from other systems through XML interface.

If the various entities involved in the transaction exist on different servers, the entered information is transmitted through XML to the other servers. If the permission for receiving outside information through XML is not granted by the other servers, the user registering the transaction is informed through an email. If the server, where the user registering the transaction exists, grants permission to open an Electronic Transaction Folder for the other entities, appropriate folders are created. If the server, where the user registering the transaction exists, does not grant this permission, the Proxy function for the existing user(s) is invoked. Similarly, if any of the entities involved in the transaction (as introduced by the user registering the transaction) currently do not exist on any of the servers which are part of the transaction exchange, and on the server on which the transaction is created grants the permission, a new identity is created for that entity to participate in the transaction. Once the Electronic Transaction Folder is created for the other entities, these entities are informed through an email.

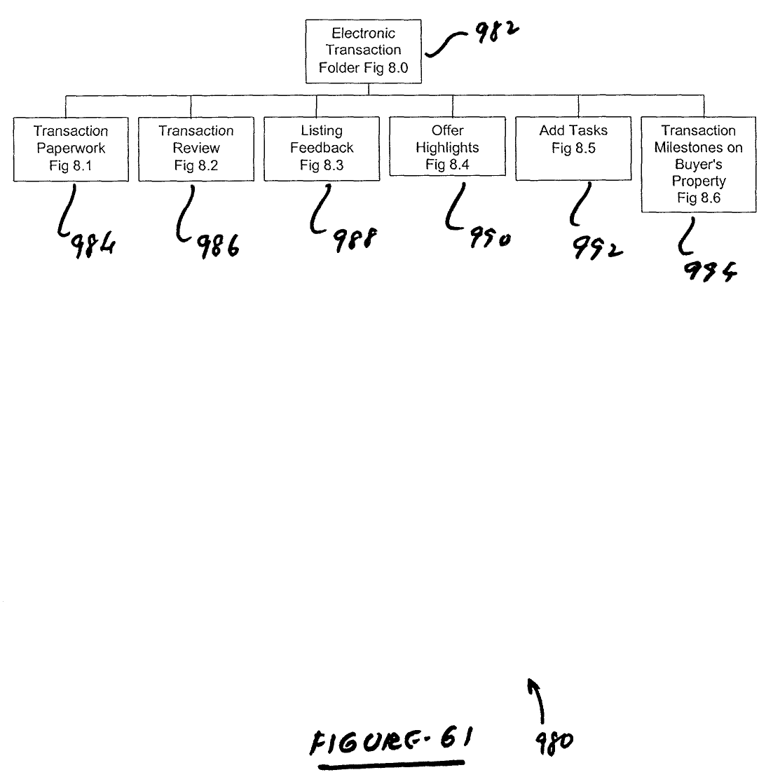

FIG. 61 is an exemplary embodiment of a flow chart depicting the elements/contents 980 of an Electronic Transaction Folder 982. Elements of one electronic transaction folder are displayed through corresponding user interfaces, as described below. Electronic Transaction Folder 982 provides various capabilities including, but not limited to, managing transaction paperwork 984, providing transaction review 986, providing listing feedback 988, displaying offer highlights 990, adding tasks 992 as and when necessary, and tracking and managing transaction milestones 994.

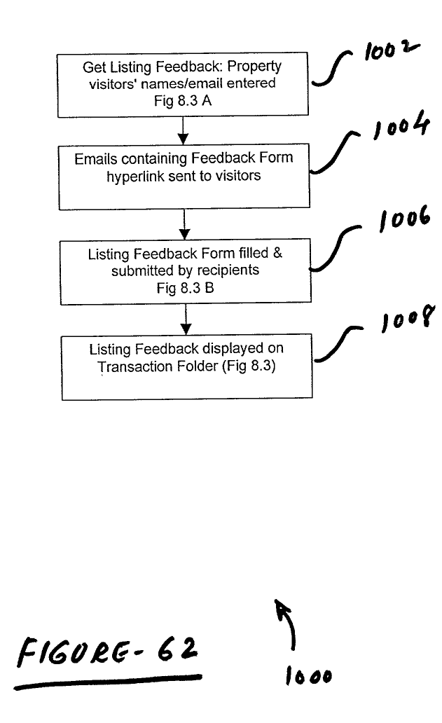

FIG. 62 is an exemplary embodiment of a flow chart describing the process 1000 receiving the listing feedback from the visitors of the property. Process 1000 includes entering 1002 property visitor's names and corresponding e-mails, sending 1004 e-mail containing a feedback form to visitors, visitors completing 1006 out the received listing feedback form from the user, and displaying 1008 received listing form on client system 44 (shown in FIG. 2) by server system 42 (shown in FIG. 2) by FPTS 40 (shown in FIG. 2).

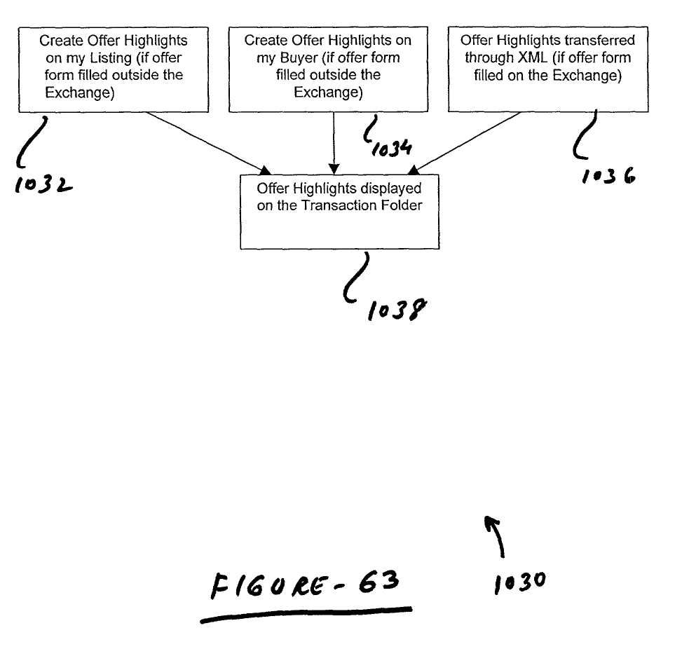

FIG. 63 is an exemplary embodiment of a flow chart describing the process 1030 relating to displaying the offer highlights to the user. In an exemplary embodiment, process 1030 includes creating 1032 offer highlights on listing, creating 1034 offer highlights on the buyer, transferring 1036 offer highlights through XML, and finally displaying 1038 offer highlights to the user.

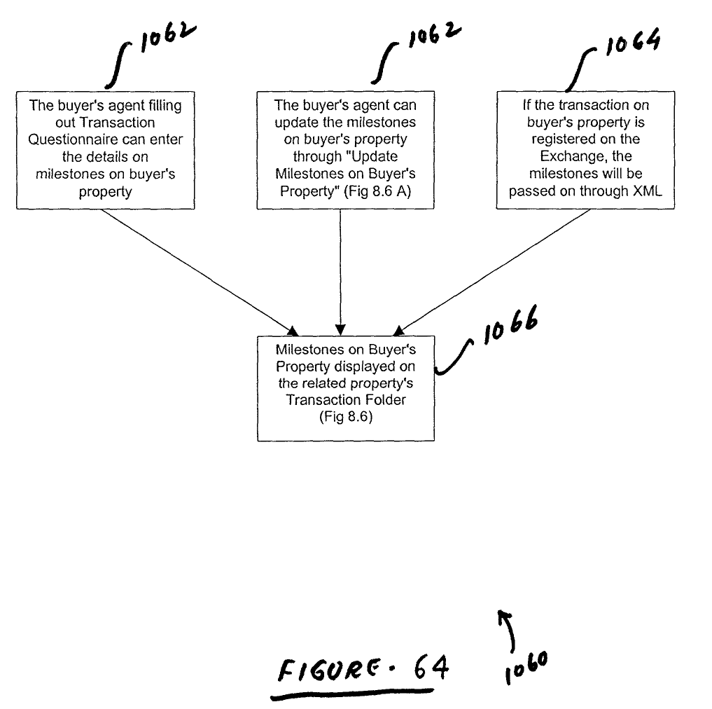

FIG. 64 is an exemplary embodiment of a flow chart depicting the process 1060 pertaining to tracking and displaying milestones on buyer's property on property's Electronic Transaction Folder 982 (shown in FIG. 61). The need to track progress of the transaction on buyer's property (property A) arises when the transaction at hand (property B) is contingent on closing the transaction on buyer's property. System 40 (shown in FIG. 2) is designed to track the progress by tracking the completion of certain tasks on buyer's property (property A) and reporting the milestones on the related Electronic Transaction Folder (property B).

Process 1060 of tracking and displaying milestones on buyer's property is achieved utilizing any one of the three alternatives. One alternative involves the buyer's agent completing the transaction questionnaire 1062, the second alternative involves the buyer's agent updating the milestone's on the buyer's property 1064, and the third one involves milestones being updated through XML 1066. The first two alternatives are manually completed and the third one is automatically accomplished by the system. Once the user has executed any one of these alternatives, the system displays 1068 the milestones on the buyer's property. Based on the status of the transaction on buyer's property (property A), certain tasks are invoked or emails are generated to notify the entities involved in the transaction (property B).

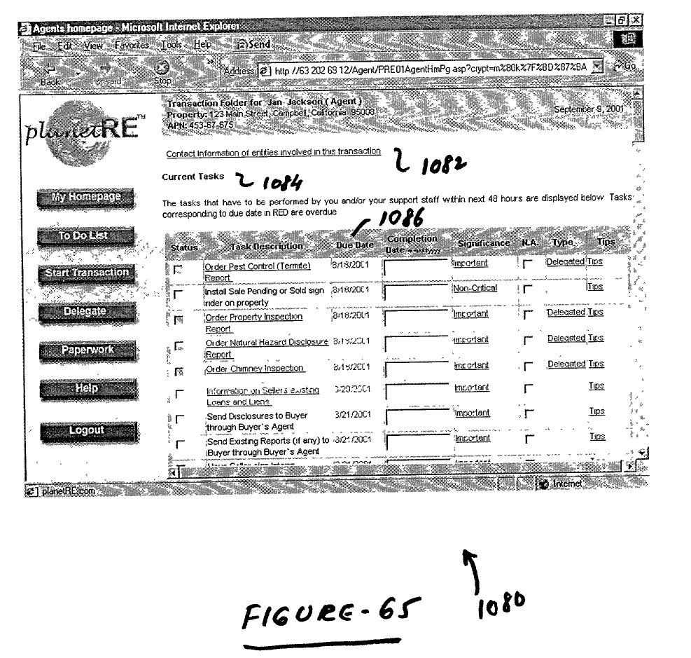

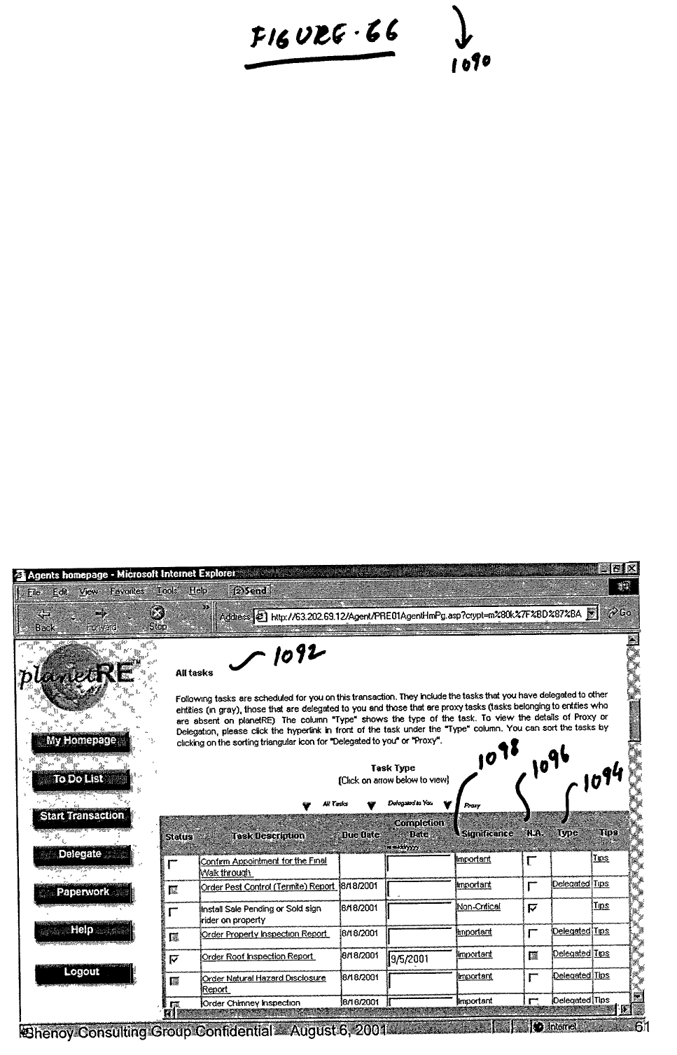

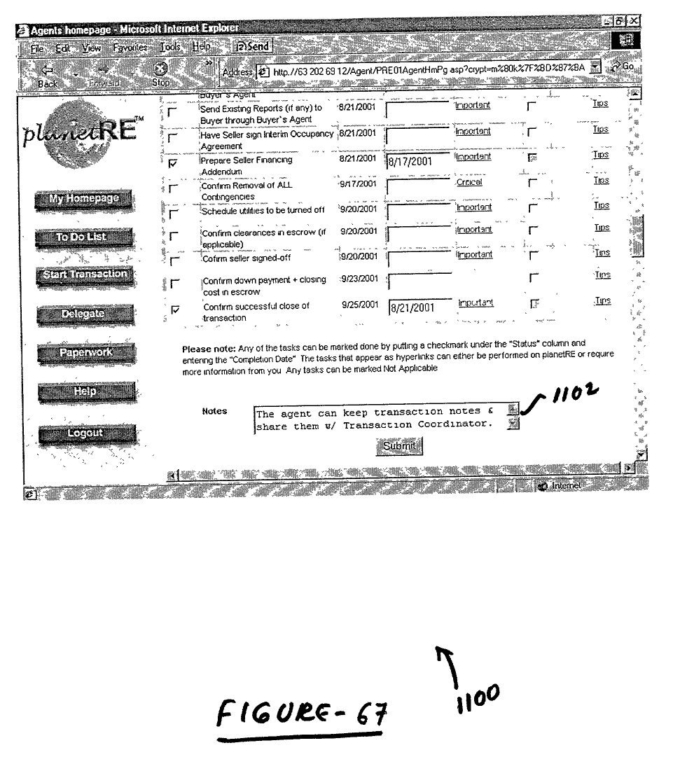

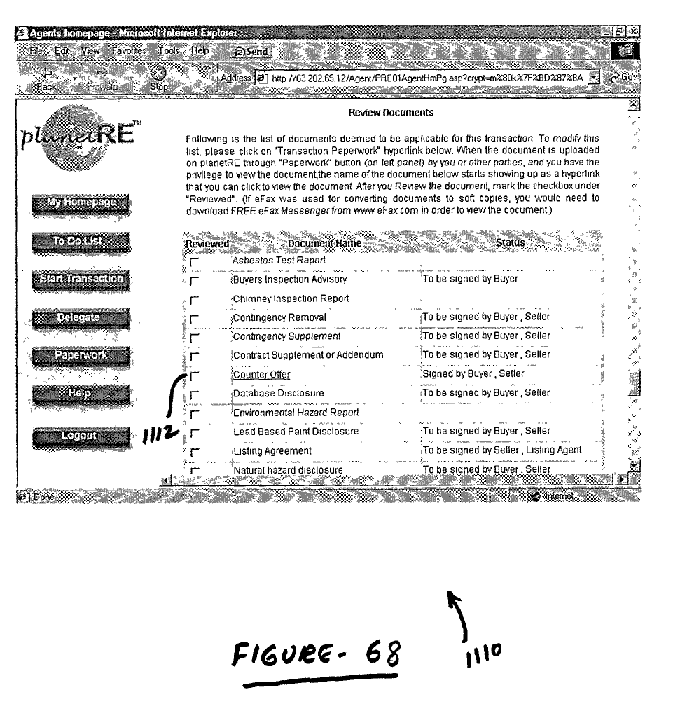

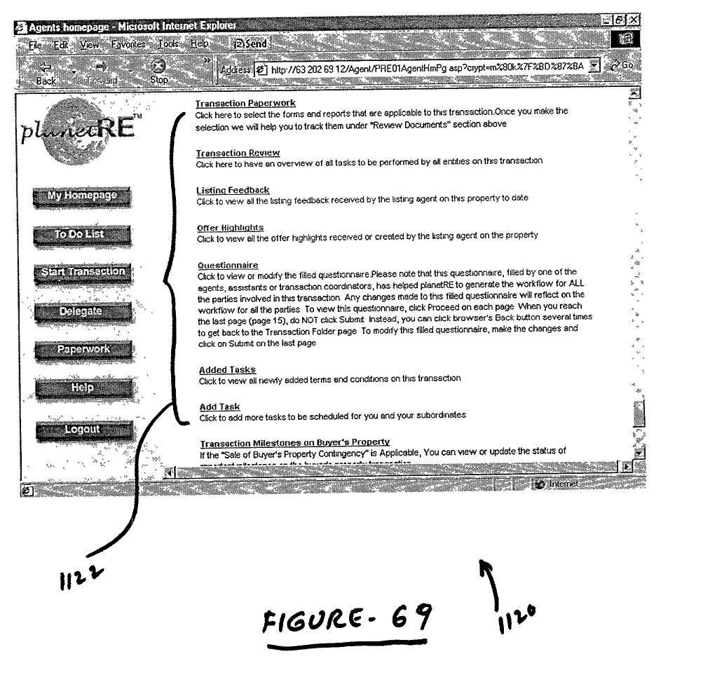

FIGS. 65 through 69 display exemplary embodiments of Electronic Transaction Folder user interfaces. FIG. 65 is an exemplary embodiment of a top part of an Electronic Transaction Folder user interface 1080. FIG. 66 is an exemplary embodiment of a continuation user interface 1090 displaying a first middle portion of Electronic Transaction Folder user interface 1080. FIG. 67 is an exemplary embodiment of a continuation user interface 1100 displaying a second middle portion of Electronic Transaction Folder user interface 1080. FIG. 68 is an exemplary embodiment of a continuation user interface 1110 displaying a third middle portion of Electronic Transaction Folder user interface 1080. FIG. 69 is an exemplary embodiment of a continuation user interface 1120 displaying the bottom portion of Electronic Transaction Folder user interface 1080.

In an exemplary embodiment, FPTS 40 creates an Electronic Transaction Folder, also known as a Transaction Folder, for each entity involved in the transaction. Electronic Transaction Folder enables each entity to perform the tasks that are designated based on the Master Rules Module. Master Rules Module created by the analyst dictates the rules and parameters of the transaction based on the territory.

All the parties involved in the transaction collaborate through their own Transaction Folders. When a task is done or not done by one of the entities, the consequences of that action/inaction is reflected on the Transaction Folder of the same entity, as well as on the Transaction Folders of the other entities involved in the transaction. Based on how the analyst has defined the “Task Attributes,” an action/inaction by one of the entities on a task or a transaction variable changing status may evoke a new task for the responsible entity/other entities and/or generate an email to the responsible entity/other entities.

The due dates for the tasks are generated based on the user input to the transaction questionnaire. If the questionnaire is modified later, the existence of the tasks, as well as their due dates, may change.

The top part of an Electronic Transaction Folder user interface displays a hyperlink, “Contact information of the entities involved in this transaction,” 1082, which opens the names and contact information on all the entities involved in the transaction, that this specific user has the privilege to view. A section entitled “Current Tasks” 1084 displays the tasks to be performed by this user within the next 48 hours. The tasks that are overdue display a Due Date 1086 in red.

Continuation user interface 1090, shown in FIG. 66, displays a section 1092 entitled “All Tasks.” User Interface 1090 displays tasks to be performed by the user to complete the transaction. Section 1092 displays the tasks that the user has delegated to another individual and the tasks that are delegated to the user. The tasks that are delegated by the user displays a hyperlink “Delegated” in a column 1094 entitled “Type.” The selection of the hyperlink opens a sub-window with details pertaining to delegation.

The proxy tasks are also displayed under “All Tasks.” Proxy tasks are the tasks that belong to other entities that are not currently participating in the transaction on the exchange. Proxy function is based on how it is set by the analyst while defining the Master Rules Module for the territory. The proxy tasks appear in the transaction folder of the entity, which is set as the proxy for the entity not participating in the transaction on the exchange.

The user performs only those tasks that the user is directly responsible for performing. Instead of actually performing these tasks on the system, the user can identify the tasks as complete by putting a checkmark in the “Status” checkbox and entering the “Completion Date.” The user may mark the tasks as “Not Applicable” by inserting a checkmark in the checkbox under a column “N.A.” 1096. The proxy tasks can be marked as complete or N.A., but cannot be actually performed by the user. The tasks that the user has delegated to another person cannot be performed or marked complete or marked not applicable by the user. The user can only view the status on these delegated tasks.

The hyperlinks under a column “Significance” 1098 denote the criticality of the task by displaying the task as Critical, Important or Non-Critical. This attribute is set by the analyst while defining the Master Rules Module. The reminder scheme is based on this attribute. For example, if a task is not identified as complete or not applicable by midnight of the due date, an email is sent to the responsible party. Upon selecting the hyperlink “Tips” in front of each task, the system displays the tips related to the task that are entered by the analyst while creating the task.

Continuation user interface 1100, shown in FIG. 67, allows the user to maintain and share notes through a “Notes” section 1102.

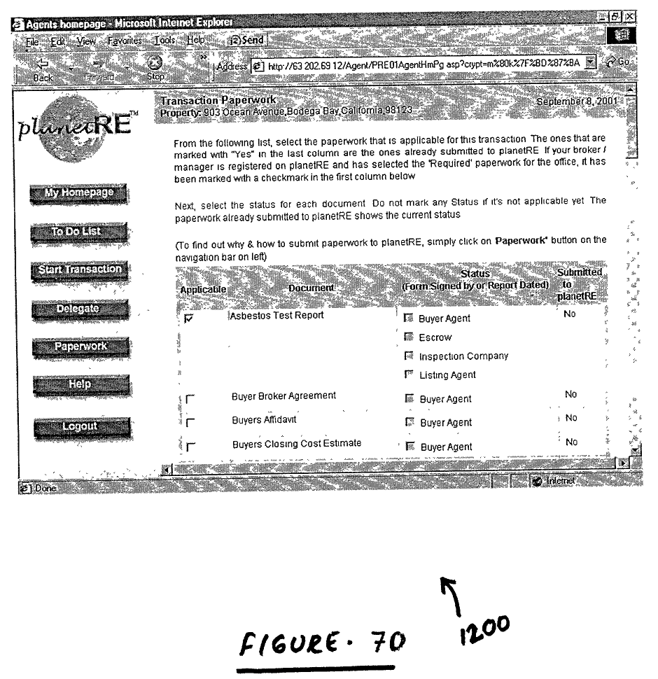

Through continuation user interface 1110, shown in FIG. 68, the user keeps track of the documents that are applicable to the transaction. The document names selected under “Transaction Paperwork” (FIG. 70, below) are displayed in this section of the user interface. When a document is created and uploaded on the system and privileges are set for the user to view the document through “Paperwork” (FIG. 10, above), the name of that document appears as a hyperlink. The selection of the hyperlink opens the document stored on the server. In an exemplary embodiment, the user is selected as one of the entities who has the privilege to view the document entitled “Counter Offer” 1112, when it is uploaded on the system.

Continuation user interface 1120, shown in FIG. 69, displays various tools 1122, directly related to the transaction. Tools 1122 are displayed through various hypertext links. Selection of a hypertext link displays corresponding user interface that is user friendly. Exemplary embodiments of user interfaces displaying tools 1122 are shown in FIGS. 70 through 80.

FIG. 70 is an exemplary embodiment of a Transaction Paperwork user interface 1200. Through user interface 1200, the user selects the documents that are applicable to the transaction. The selected document names appear under the “Review Document” section in the Transaction Folder.

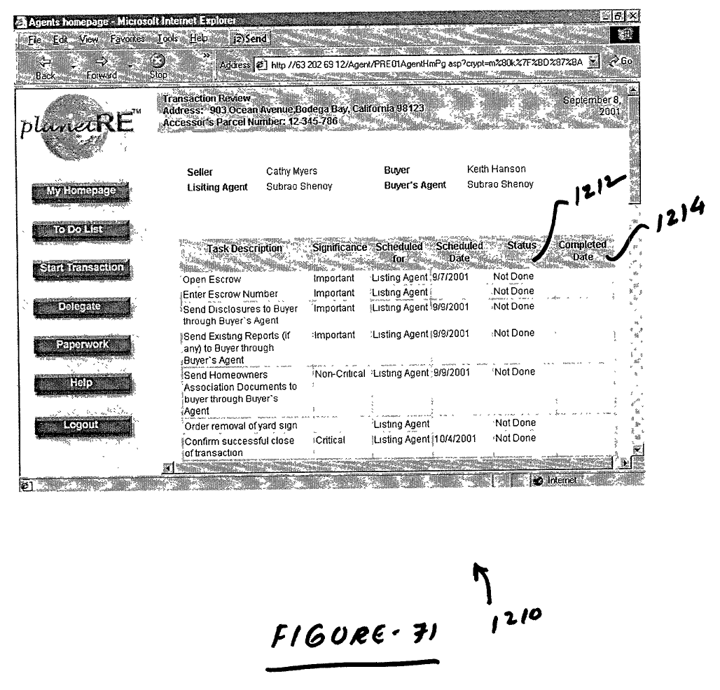

FIG. 71 is an exemplary embodiment of a Transaction Review user interface 1210. Through user interface 1210, the user views the status of all the tasks to be performed by all the entities involved in the transaction. As the tasks are performed, the status reflected in a Status 1212 column changes from “Not Done” to “Done.” A completion date 1214 column displays the date of completion of the task. If the task is marked not applicable, the “Not Applicable” status is reflected as such.

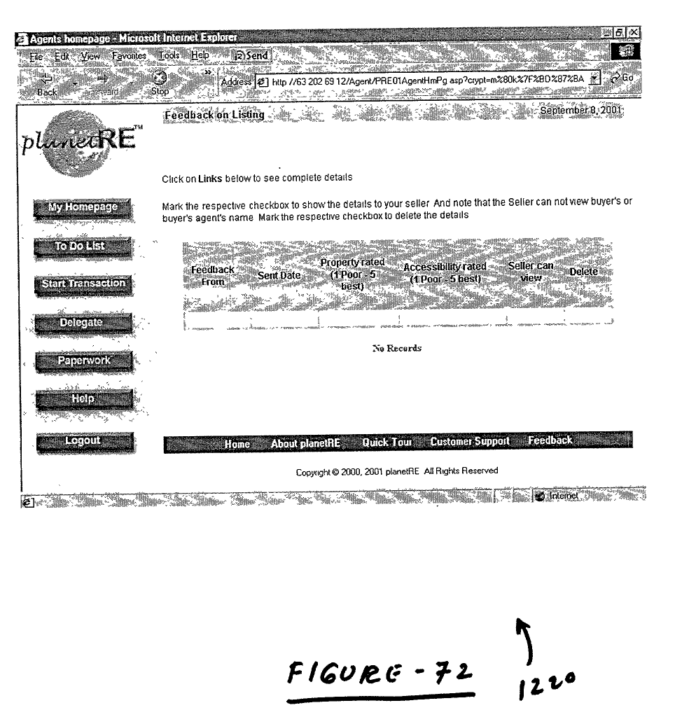

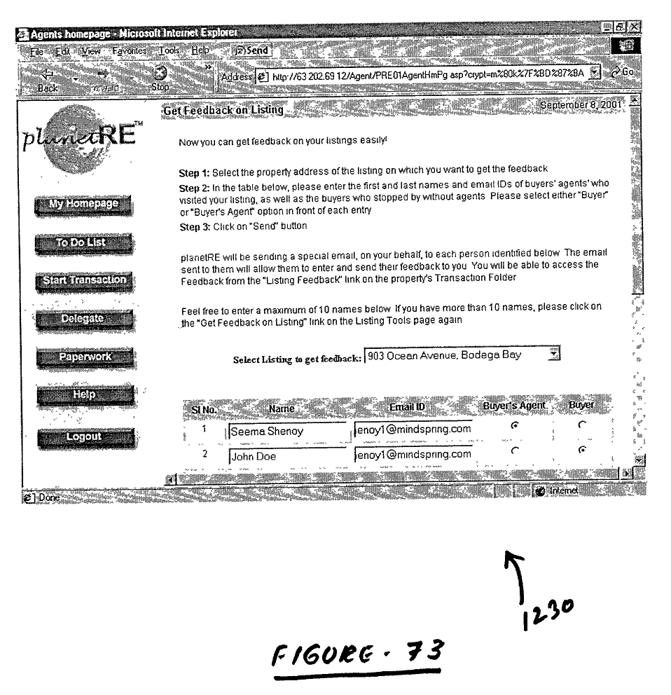

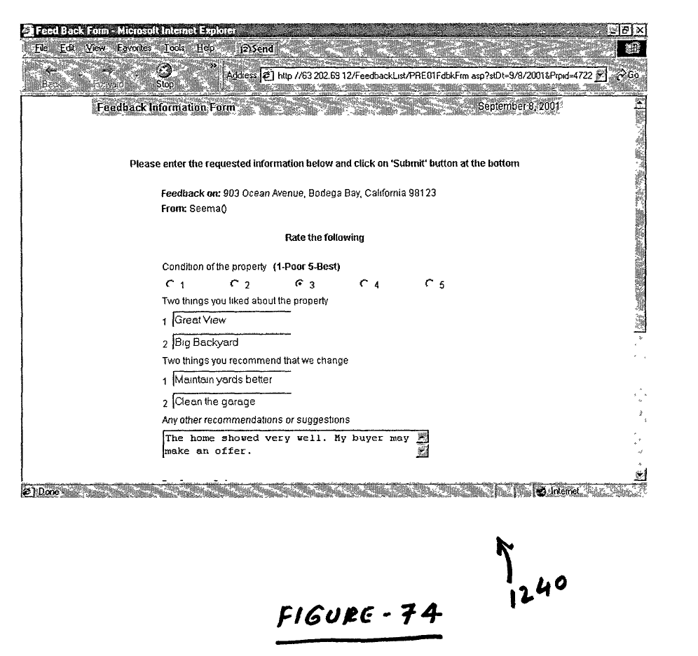

FIG. 72 is an exemplary embodiment of a Listing Feedback user interface 1220. Through user interface 1220, the user views the feedback on the property, provided by various buyers and buyers' agents that visited the property. If this is used by an agent, the agent checkmarks the checkbox under “Seller can view” to make the feedback available to the seller. How to request and obtain the listing feedback is enumerated in FIGS. 73 and 74.

FIG. 73 is an exemplary embodiment of a Get Feedback on Listing user interface 1230. Through user interface 1230, the user selects the property for which the user wants to request feedback and completes the names and email IDs of the individuals who visited the property. The user also identifies if the entry is for a “Buyer” or “Buyer's Agent.” Upon selecting a Send button (not shown), the system sends emails to all the individuals listed by the user.

FIG. 74 is an exemplary embodiment of a Listing Feedback Form user interface 1240. Each email sent by the system to buyers and buyers' agents listed on user interface 1230 (shown in FIG. 73 above) carries a hyperlink. The hyperlink opens a personalized Feedback Information Form, which the recipient of the email fills out. The content of the form changes slightly based on whether the email recipient was identified as a buyer or the buyer's agent. Upon selecting a Submit button (not shown) of the form, the entered information, along with the identity of the sender, is stored on the system and displayed to the feedback requestor through user interface 1220, shown in FIG. 72.

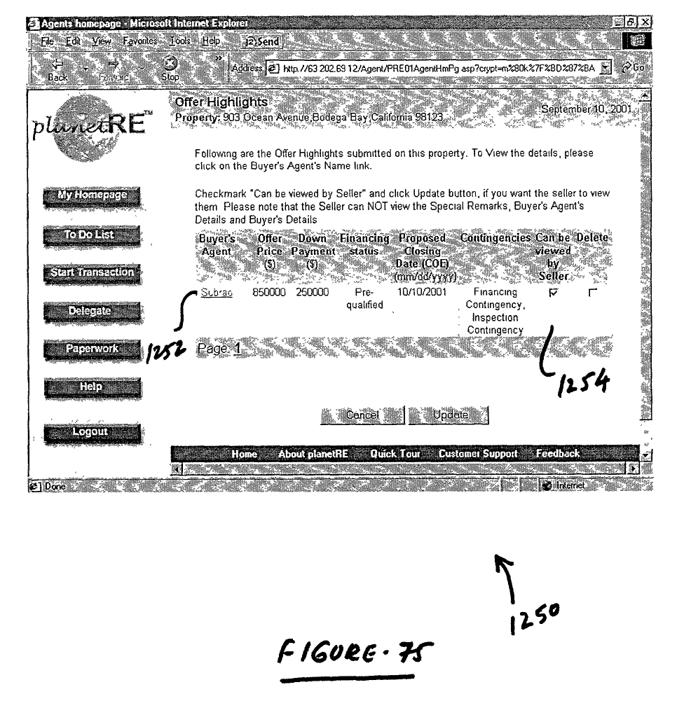

FIG. 75 is an exemplary embodiment of an Offer Highlights user interface 1250. User interface 1250 displays offer highlights and the associated details. Offer highlights are the significant parts of a purchase offer that the reader of the offer may want to know first, before going through the lengthy legal offer forms. When the user selects a specific buyer's agent's name 1252 appearing as a hypertext link, the offer details are displayed. If the user is an agent, the user can provide the information to the seller by placing a checkmark in the checkbox under “Can be viewed by Seller” 1254.

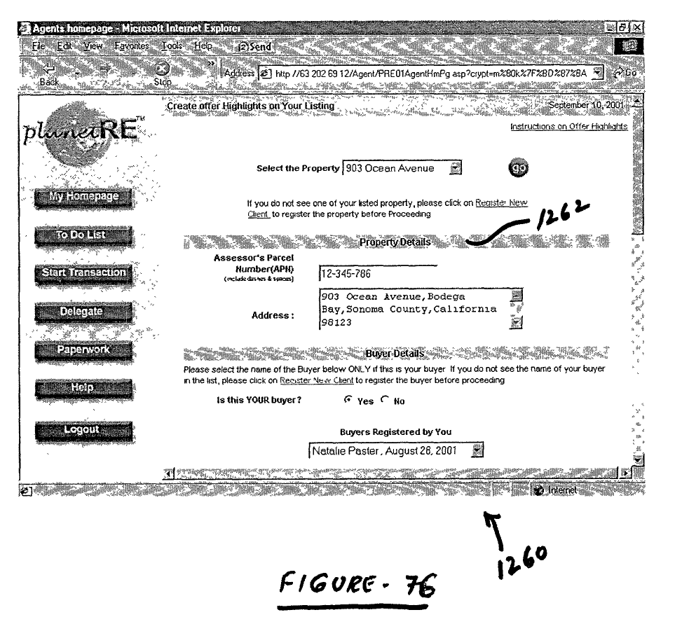

FIG. 76 is an exemplary embodiment of a Create Offer Highlights user interface 1260. User interface 1260 allows the user to enter offer highlights on the user's listing(s). The offer highlights are entered by the listing agent through user interface 1260 or by buyer's agent (through the buyer tool “Create Offer Highlights on your buyer”). If the offer form is filled outside the exchange, the form can be uploaded and sent along with the highlights. If the offer form is filled on the exchange, the offer highlights, along with the filled offer form(s), are delivered through XML interface to the system where the party receiving the offer exists. To create offer highlights on ones' own listing, the user first selects the property on which the offer highlights are to be created. Property Details 1262 are populated accordingly. Next, the user selects a buyer, if the offer is from one of user's own buyers.

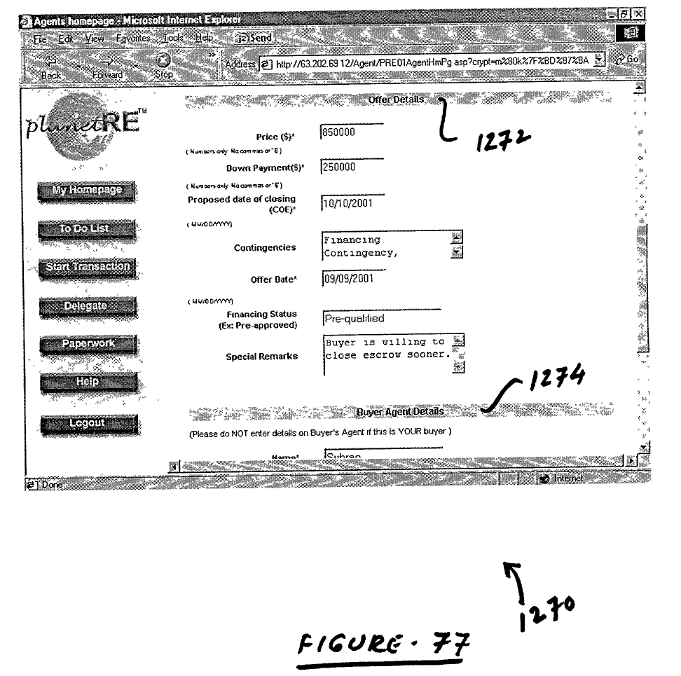

FIG. 77 is an exemplary embodiment of a continuation user interface 1270 of the user interface 1260 (shown in FIG. 76). Through user interface 1270, the user enters the Offer Details 1272 and Buyer's Agent's Details 1274. If the listing agent is the buyer's agent, these details are populated automatically. Upon Submit button (not shown), the entered details are displayed under offer highlights for the selected property through user interface 1250 (shown in FIG. 75).

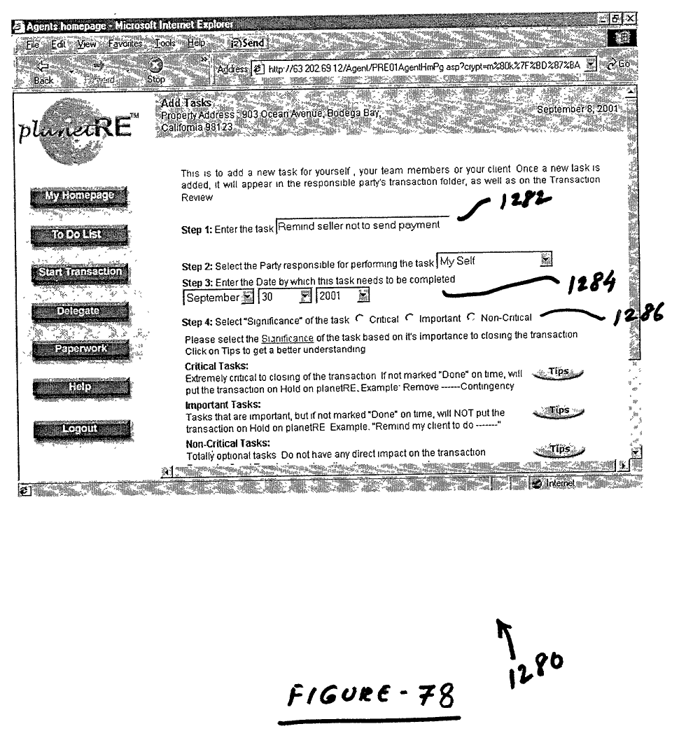

FIG. 78 is an exemplary embodiment of an Add Tasks user interface 1280. On any transaction, the user can add tasks for the user or for any subordinate entity through user interface 1280. The user enters a task text 1282, a due date 1284 for the task and a significance of the task 1286 (Critical or Important or Non-critical). These tasks show up in the transaction folder of the assigned entity, as well as in the “Transaction Review” containing tasks of all entities.

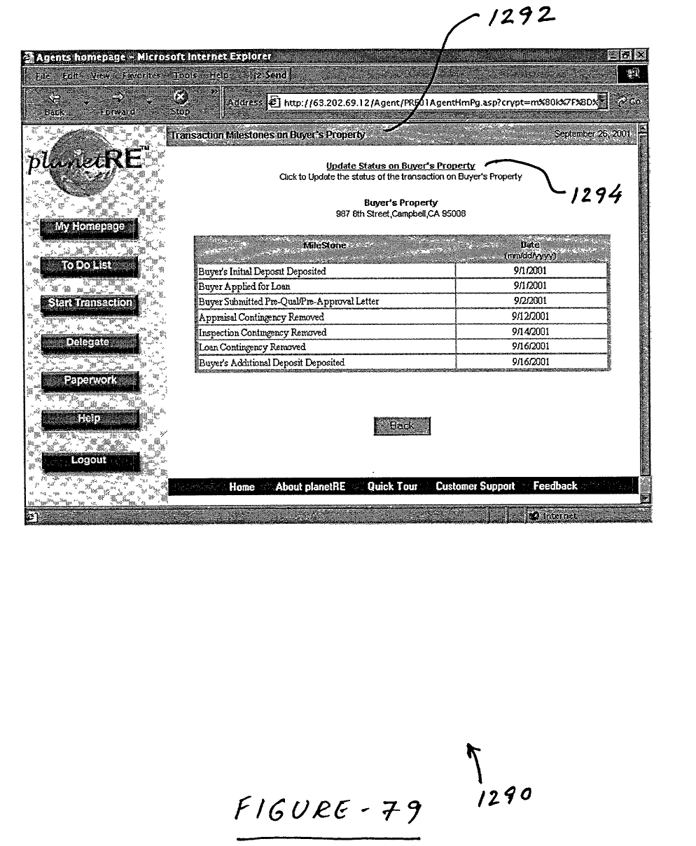

FIG. 79 is an exemplary embodiment of a Transaction Milestones on Buyer's Property user interface 1290. When a transaction is contingent on closing another transaction (Buyer's Property), FPTS 40 activates a hyperlink entitled “Transaction Milestones on Buyer's Property” 1292. Hyperlink 1292 appears on the privileged entities' transaction folder. When selected, user interface 1290 opens up, displaying the milestones achieved on the Buyer's Property Transaction.

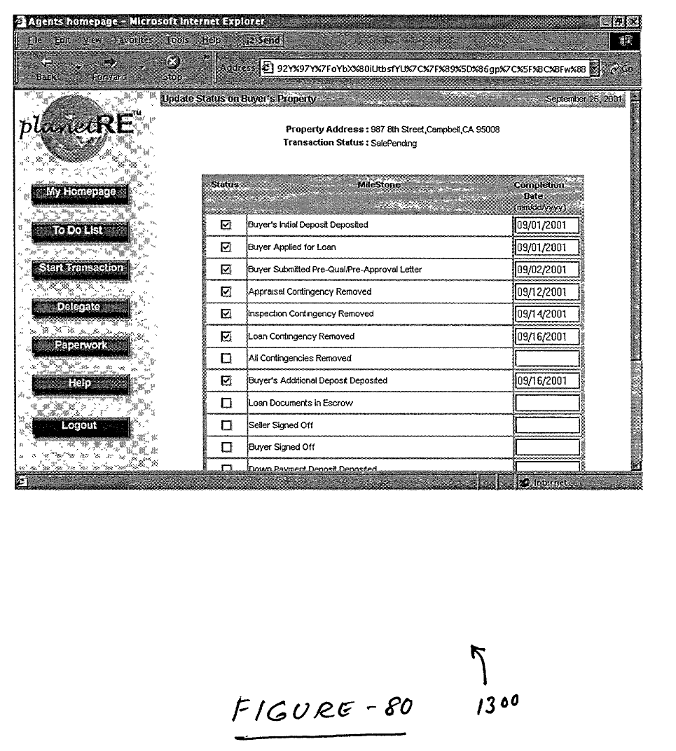

If the Transaction on the Buyer's Property is being conducted on the exchange, the milestones are automatically retrieved and displayed on user interface 1290. If the transaction on Buyer's Property is not being conducted on the exchange, the buyer's agent selects the hyperlink “Update Status on Buyer's Property” 1294 and manually updates the status through a user interface 1300 displayed in FIG. 80.

User interface 1300, displayed in FIG. 80, is an exemplary embodiment of the user interface that allows the user to update milestones on the buyer's transaction. Through user interface 1300, the buyer's agent checkmarks the milestones that have been completed on the transaction on Buyer's Property and enters the completion date. Once submitted to server system through a submit button (not shown), the information is displayed on user interface 1290 (shown in FIG. 79) for all privileged entities.

FPTS 40 also utilizes various other user interfaces to manage the transactions. Additionally, the user interfaces described above are exemplary only. Various other modifications are possible without compromising the functionality of FPTS 40.

FPTS 40, adapted to residential real estate, is described above. In other exemplary embodiments, FPTS 40 is modified for a highly secure, scalable transaction exchange for businesses. Such commercial real estate, timeshares, machinery, equipment and other capital asset exchanges that can adapt to any geography/business practices by changing or altering the business rules. The input to FPTS 40 is the business rules file, created by analyst module 160 (shown in FIG. 5) based on the actual contract for the transaction, and the output of FPTS 40 is the transaction workflow for all entities involved in the transaction.

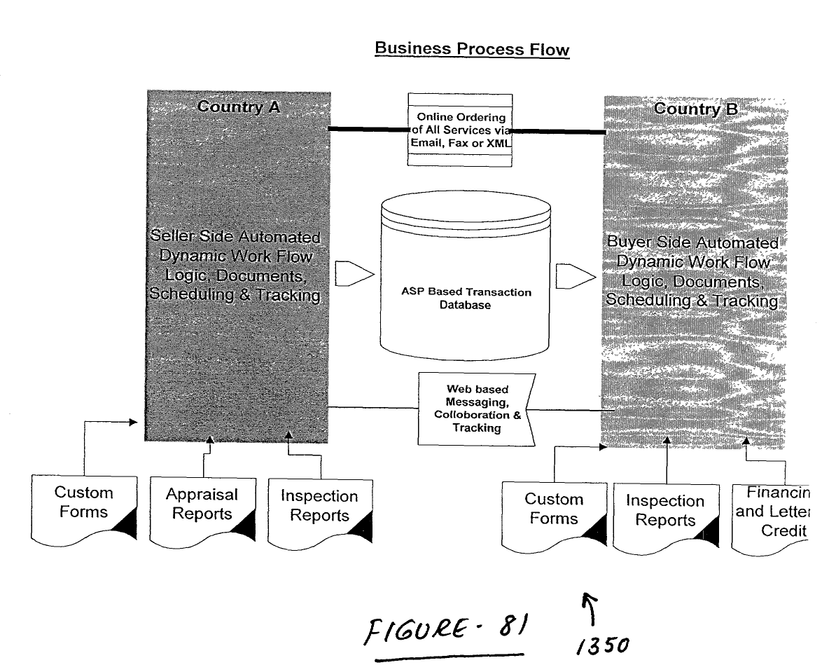

FIG. 81 is an exemplary embodiment of a business process flow 1350 depicting the application relating to Import-Export of Autos, Machinery and other forms of capital assets among multiple business entities in multiple different countries. FPTS 40 allows flexibility through the analyst module to ensure compliance with different rules and regulations that govern such transactions. For example, the forms library contains customs and other compliance forms as defined and entered in analyst module 160. The business logic for each side is also entered via analyst module 160, which defines the roles and interrelationships of all entities. Once the rules and parameters relating to the transaction are defined, the home pages for each entity, security and the privilege scheme are automatically created.

While the invention has been described in terms of various specific embodiments, those skilled in the art will recognize that the invention can be practiced with modification within the spirit and scope of the claims.

What is claimed is:

1. A method of creating and managing a capital asset transaction utilizing a field programmable transaction system including a server system coupled to a centralized database and at least one client system, said method comprising:
identifying business objectives, including a type of the capital asset involved in the capital asset transaction;
creating a business entity and related sub-entities;
defining business rules and logic specific to the business entity and the associated sub-entities to govern the transaction; and
managing the transactions dynamically on a regular basis for the business entity.

2. The method according to claim 1 wherein the capital asset transaction includes at least one of a residential real estate procurement transaction, a commercial real estate procurement transaction, a timeshare procurement transaction, a ship procurement transaction, a boat procurement transaction, an automobile procurement transaction, an aircraft procurement transaction, a factory equipment procurement transaction, and an import-export transaction.

3. The method according to claim 2 wherein the capital asset transaction includes a residential real estate procurement transaction, which farther comprises creating new entities including at least one of a Buyer, a Seller, a Escrow, a Lender, a Broker, an Agent, an Inspection Company, a Repair Company and other service providers.

4. The method according to claim 1 wherein said step of creating a business entity and related sub-entities further comprises the step of creating at least one of forms, disclosures, documents, tasks and sub-tasks.

5. The method according to claim 1 wherein said step of creating a business entity and related sub-entities further comprises the steps of creating appropriate relationships and establishing proper linkages among the business entity and related sub-entities.

6. The method according to claim 1 wherein the client system and the server system are connected via a network to create centralized exchanges and wherein the network is one of a wide area network, a local area network, an intranet and the Internet.

7. The method according to claim 1 wherein the client system and the server system are connected via a network to create distributed exchanges and wherein the network is one of a wide area network, a local area network, an intranet and the Internet.

8. The method according to claim 1 wherein said step of managing the transaction further comprises the steps of:
developing milestones that identify at least one of tasks, completion dates and responsible individuals;
managing interrelationships among various tasks and various individuals responsible for completing tasks; and
reporting progress of the transaction by tracking at least one of tasks, completion dates, and due dates.

9. The method according to claim 7 further comprising:
accessing the centralized database;
searching the centralized database to obtain the transaction information;
retrieving information from the centralized database; and
transmitting the retrieved information to the client system for display utilizing various different user interfaces.

10. A system for managing a capital asset procurement transaction, said system comprising:
a client system comprising a browser;
a data storage for storing information;
at least one server system configured to be coupled via a network to said client system and said data storage device, said server system further configured to:
set up business entities and sub-entities including business rules and parameters relating to the business entities and sub-entities;
create rules of proxy, rules of interaction and delegation;
analyze transaction details based on an executed contract;
execute an automated workflow which incorporates all the tasks for the business entities and sub-entities; and
auto navigate the transaction based on a desired outcome and transaction variables exchanged via the network to complete the transaction.

11. A system according to claim 10 wherein said server system is further configured to capture the fundamental business rules.

12. A system according to claim 10 wherein said server system is further configured to create business entities and sub-entities with the definitions of all privileges, scope of each business entity, sub-entities and their responsible tasks, and logic of business interaction among each business entity and sub-entities.

13. A system according to claim 10 wherein said server system is further configured to create and load documents and forms that are automatically invoked during the processing and execution of the transaction.

14. A system according to claim 10 wherein said server system is further configured to create a field programmable privilege scheme for all entities based on laws, local regulations and business practices.

15. A system according to claim 10 wherein said server system is further configured to manage hierarchical layers of programming with an override scheme.

16. A system according to claim 10 wherein an entire backbone workflow of the transaction that spans across multiple entities and sub-entities is connected by mixing and matching hierarchies.

17. A system according to claim 10 wherein said server system is further configured to create specific entity related homepages for business entity and sub-entities with a privilege scheme and individual working environment.

18. A system according to claim 10 wherein said server system is further configured to generate a rules definition file that is captured using a simple and intuitive graphical user interfaces and wherein the rules definition file contains entity definitions for all business entities in the transaction.

19. A system according to claim 18 wherein said rules definition file defines the basic skeleton of the business entities, business entities' functions and tasks, and business entities' logical relationship.

20. A system according to claim 10 wherein said client system is further configured to display a variety of options to a user; and to send an inquiry to the server system for facilitating the processing and downloading by the server system of the requested information to the client system.

21. A system according to claim 20 wherein said client system is further configured to send information in response to at least one of a click of a mouse button and a voice command.

22. A system according to claim 10 wherein said system is configured to be protected from access by unauthorized individuals and further configured to manage multiple databases to exchange information for various users in a distributed environment.

23. A system according to claim 10 wherein said server system is configured to send automatic e-mail notifications to parties involved.

24. A system according to claim 10 wherein the network is one of a wide area network, a local area network, an intranet and the Internet.

25. A computer to facilitate online processing and closure of capital assets transactions, said computer coupled to a centralized database and programmed to:
set up business entities and receive transaction information into the centralized database against related business entities;
store the transaction information into various subsections of the centralized database and cross reference the transaction information against the business entities;
develop transaction milestones and dynamic workflow based on parties' desired outcome;
receive documentary evidence against transaction milestones and update the centralized database dynamically to reflect a current status of the transaction at any given time; and
close the transaction to achieve the desired outcome of the parties.

26. The computer according to claim 25 further programmed to provide a notification to users via electronic mail regarding final decision.

27. The computer according to claim 19 wherein the transaction milestones are developed based on business rule files and actual contracts relating to the transaction.

28. The computer according to claim 19 wherein the transaction milestones further include transaction workflow for all entities involved in the transaction.

29. The computer according to claim 19 wherein the desired outcome is developed based on actual contracts signed between the parties.

30. A computer program embodied on a computer readable medium for managing transactions in various different types of industries including at least one of a residential real estate industry, a commercial real estate industry, a timeshares industry, a ship industry, an automobile industry, an aircraft industry, and an import/export industry, based on pre-defined business rules guidelines, said computer program further comprises at least one of an analyst code segment, a rules file creation code segment, a dynamic transaction logic code segment, a privilege scheme code segment, an optimization code segment, an automatic file storage and retrieval code segment, and a semantic questionnaire code segment to execute and close transactions based on parties contractual understandings and obligations.

31. The computer program as recited in claim 30 further includes a code segment that prints various management reports in a pre-determined format.

32. The computer program as recited in claim 30 further includes a code segment that downloads and displays various user interfaces including at least one of:
an Identifying the Folder user interface,
a Selecting and Naming the Document user interface,
a Setting the Privileges user interface,
an Analyst's Home page user interface,
a Create/View Entity user interface,
a Create/Modify E-Mail Templates user interface,
a Create/Modify Forms user interface,
a Create/Modify Net Sheet/Closing Costs user interface,
a Create/Modify Document List user interface,
a Create/Modify/View Task user interface,
a Define Entity/Task Relationship user interface,
a Define Master Rules Module user interface,
a Master Rules Module Library user interface,
a Define Module Name and Territory user interface,
a Select Entities user interface,
a Select Tasks user interface,
a Define Task Attributes user interface,
a Select Documents/Reports user interface,
a Select Attributes of Documents user interface,
a Define/Modify Proxy user interface,
a Set Default Values user interface,
a Define Transaction Flow user interface, and
a Notes on Master Rules Module user interface.

33. The computer program as recited in claim 32 further includes a code segment that downloads and displays various user interfaces adopted for the real estate industry, including at least one of:
a Home page user interface,
an Account user interface,
an Add Team Members user interface,
an Account/Support Staff user interface,
a Delegate user interface,
a Task Delegation user interfaces,
a Transaction Delegation user interface,
a Commissions user interface,
a Commissions Set Up user interface,
a Commissions Summary user interface,
an Individual Category user interface,
a Transaction Questionnaire user interface to register a new transaction,
an Electronic Transaction Folder user interface,
a Transaction Paperwork user interface,
a Transaction Review user interface,
a Listing Feedback user interface,
a Get Feedback on Listing user interface,
a Listing Feedback Form user interface,
an Offer Highlights user interface,
a Create Offer Highlights user interface, and
an Add Tasks user interface.

34. The computer program as recited in claim 30 wherein the analyst code segment further comprises a code segment that:
captures fundamental business rules after creating basic and related business entities and sub-entities;
creates definitions of all privileges;
develops the scope of each entity and their responsible tasks;
creates documents, forms and other objects that are automatically invoked during the transaction execution; and
creates interrelationship among business entities, tasks, and privileges.

35. The computer program as recited in claim 34 wherein the analyst code segment further comprises a code segment that handles any new geographic rules by easily creating and modifying rules file based on local regulations and business practices.

36. The computer program as recited in claim 34 wherein the analyst code segment further comprises a code segment that creates hierarchical layers of programming with an override scheme to close the transaction successfully based on the parties' contractual understanding and obligations.

37. The computer program as recited in claim 34 wherein the analyst code segment further comprises a code segment that allows the user to at least one of add, delete, and modify the user's own task and sub-tasks, documents, privileges and delegation schemes.

38. The computer program as recited in claim 30 wherein the rules file creation code segment further comprises a code segment that:
creates a basic rules definition file, wherein the basic rules definition file contains a layer definition of each entity and how each layer interacts or does not interact based on the layer's logical relationship in a business situation; and
captures the logical relationship using a simple and intuitive graphical user interfaces.

39. The computer program as recited in claim 38 wherein the rules file creation code segment further comprises a code segment that contains entity definitions for all entities in the transaction.

40. The computer program as recited in claim 30 wherein the dynamic transaction logic code segment further comprises a code segment that creates and executes a dynamic automated workflow incorporating all the tasks for the defined entities and auto navigates the transaction based on outcomes and transaction variables exchanged via the Internet.

41. The computer program as recited in claim 40 wherein the dynamic transaction logic code segment further comprises a code segment that enables changing the transaction flow at least one of automatically and manually based on direct user inputs and transaction variables.

42. The computer program as recited in claim 40 wherein the dynamic transaction logic code segment further comprises a code segment that:
receives compiled business rules and the information captured from an online contract document by executing at least one of completing contract forms on the exchange, completing a questionnaire on the exchange, and transferring the relevant data via XML interface from the contract source outside the exchange; and
creates an automated workflow to navigate the transaction.

43. The computer program as recited in claim 40 wherein the dynamic transaction logic code segment further comprises a code segment that:
executes a task;
marks it as at least one of complete, incomplete, and not applicable; and
views and edits documents.

44. The computer program as recited in claim 30 wherein the privilege scheme code segment further comprises a code segment that manages a user customizable privilege scheme to execute tasks, view, sign and edit documents to guarantee transaction integrity and privacy.

45. The computer program as recited in claim 30 wherein the optimization code segment further comprises a code segment that stores given characteristics of service providers in a library of components and manages a constrained-based optimization.

46. The computer program as recited in claim 45 wherein the optimization code segment is further comprising a code segment that enforces the privilege function as programmed by an analyst.

47. The computer program as recited in claim 30 wherein the automatic file storage and retrieval code segment further comprises a code segment that manages at least one of contextual file naming, providing privileges to view/sign, storing, and retrieving key documents.

48. The computer program as recited in claim 47 wherein the automatic file storage and retrieval code segment further comprises a code segment that manages at least one of forms, reports, and disclosures used in and related to the transaction.

49. The computer program as recited in claim 48 wherein the automatic file storage and retrieval code segment further comprises a code segment that receives documents.

50. The computer program as recited in claim 49 further includes a code segment to receive documents that are at least one of faxed documents, scanned documents, and emailed documents.

51. The computer program as recited in claim 49 further includes a code segment to receive documents that are sent through XML interfaces.

52. The computer program as recited in claim 49 wherein the automatic file storage and retrieval code segment further comprises a code segment that receives the documents that are created on servers.

53. The computer program as recited in claim 30 further includes a code segment that generates various management reports based on the user's selected criteria in a pre-determined format to track transactions.

54. The computer program as recited in claim 30 wherein the optimization code segment further comprises a code segment that performs feasibility analysis to develop multiple scenarios for a user to provide the user with a flexibility to select an alternative.

55. The computer program as recited in claim 54 wherein the optimization code segment further comprises a code segment that provides comparison of various alternatives to help finalize the contract and initiate the transaction.

56. The computer program as recited in claim 30 wherein the semantic questionnaire code segment further comprises a code segment that captures the data on a business contract from the user and completes forms related to the transaction.

57. The computer program as recited in claim 56 wherein the semantic questionnaire code segment further comprises a code segment that creates feasibility analysis scenarios.

58. The computer program as recited in claim 30 further includes a code segment that creates an entire backbone workflow of the transaction that spans across multiple entities and sub-entities, the workflow is connected by mixing and matching hierarchies.

59. The computer program as recited in claim 58 wherein a hierarchy of a major entity is left intact by interfacing and communicating only via the outer boundary level.

60. The computer program as recited in claim 58 wherein a hierarchy of a major entity is collapsed to view at least one of tasks, sub-tasks, entities, privileges, and communications underneath.

61. The computer program as recited in claim 30 further includes a code segment that manages transactions by managing complex business interrelationships.

62. The computer program as recited in claim 30 further includes a code segment that monitors the security by restricting access to unauthorized individuals.

63. The method according to claim 1 wherein the capital asset transaction is managed by creating the transaction flow automatically.

64. The method according to claim 1 wherein the capital asset transaction is managed by creating the transaction flow manually.
